(19) United States
(12) Patent Application Publication
(10) Pub. No.: US 2008/0063566 A1
(43) Pub. Date: Mar. 13, 2008

(54) Sensor Unit and Reaction Field Cell Unit and Analyzer

(75) Inventors: Kazuhiko Matsumoto, Osaka (JP); Atsuhiko Kojima, Saitama (JP); Satoru Nagao, Ibaraki (JP); Masanori Kato, Kanagawa (JP); Yasuo Ifuku, Kanagawa (JP); Hiroshi Mitani, Kanagawa (JP); Haruyo Saitou, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI CHEMICAL CORPORATION, Tokyo (JP)

(21) Appl. No.: 11/661,853

(22) PCT Filed: Sep. 1, 2005
(86) PCT No.: PCT/JP05/15983

§ 371 Date: Oct. 24, 2007

(30) Foreign Application Priority Data
Sep. 3, 2004 (JP) 2004-257698

(51) Int. Cl. G01N 27/28; B01J 19/00

(52) U.S. Cl. 422/68.1; 204/406; 422/50; 422/83

(57) ABSTRACT

To improve convenience of a sensor unit using a transistor in analysis, a sensing gate for detection 117 of a sensor unit for detecting a detection target comprises a transistor part 103 having a substrate 108, a source electrode 111 and a drain electrode 112 provided on the substrate 108, a channel 113 forming a current path between the source electrode 111 and the drain electrode 112, and the sensing gate for detection 117 is provided with a gate body 115 fixed to the substrate 108 and a sensing part 116 capable of electrically conducting to the gate body 115 and on which a specific substance 123 capable of selectively interacting with the detection target is immobilized.

### FIELD OF THE INVENTION

The present invention relates to a sensor unit using transistors, a reaction field cell unit used therewith, and an analytical apparatus using thereof.

### DESCRIPTION OF THE RELATED ART

A transistor is a device that converts voltage signals input in a gate into current signals output from either a source electrode or a drain electrode. On applying a voltage between the source electrode and the drain electrode, charged particles existing in a channel formed between the source electrode and the drain electrode move along an electric field direction before being output as a current signal from either the source electrode or the drain electrode.

At this point, the strength of the output current signal is proportional to the density of the charged particles. When a voltage is applied on the gate that is placed at upward, sideward or downward position of the channel with an insulator therebetween, the density of the charged particles existing in the channel is changed. With the aid of this property, the current signal can be varied by changing the gate voltage.

The currently known chemicals-sensing elements (sensors) using transistors are those utilizing the above-mentioned principles of transistors. As a specific example of sensor, the one described in Patent Document 1 can be mentioned. Patent Document 1 discloses a sensor with construction that a substance which is capable of selectively reacting with detection targets is immobilized on the gate of the transistor. A change in the surface charge of the gate, induced by the reaction of the detection targets and the substance immobilized on the gate, varies the electric potential of the gate, thereby changing the density of the charged particles existing in the channel. This change leads to the variation in the output signal from either the drain electrode or the source electrode of the transistor. Then the detection of a detection target can be made by reading that variation.

Patent Document 1: Japanese Patent Application Laid-Open No. Hei 10-260156

### DISCLOSURE OF THE INVENTION

### Problem to be Solved by the Invention

However, a conventional sensor as described in Patent Document 1 needs individual remaking of transistors each time the sensor is used in accordance with analysis purposes or types of detection targets, demanding a great deal of time and effort for analysis.

The present invention has been made in view of such a problem and an object thereof is to provide a sensor unit that makes analysis more convenient than conventional ones, a reaction field cell unit used therewith, and an analytical apparatus using thereof.

### Means for Solving the Problem

After careful consideration to solve the above problem, the inventors of the present invention have found that the above problem can be solved by performing one of the following: constructing a sensing gate for detection of a sensor unit to comprise a gate body fixed to a substrate and a sensing part capable of electrically conducting to the gate body and on which a specific substance capable of selectively interacting with detection targets is immobilized; integrating transistor parts of the sensor unit using the transistor parts; and providing a reference electrode to which a voltage is applied to detect existence of detection targets by the change of the characteristic of the transistor part without using any specific substance, and have achieved the present invention.

That is, an aspect of the present invention includes a sensor unit for detecting a detection target, comprising a transistor part having a substrate, a source electrode and a drain electrode provided on the substrate, a channel forming a current path between the source electrode and the drain electrode, and a sensing gate for detection, wherein the sensing gate for detection comprises: a gate body fixed to the substrate; and a sensing part capable of electrically conducting to the gate body and on which a specific substance capable of selectively interacting with the detection target is immobilized (claim 1). With this aspect, it becomes possible to handle the sensing part separately from the gate body, and convenience when performing an analysis can be improved as compared with conventional sensor units.

Another aspect of the present invention includes a sensor unit for detecting a detection target, comprising a transistor part having a substrate, a source electrode and a drain electrode provided on the substrate, a channel forming a current path between the source electrode and the drain electrode, and a sensing gate for detection, wherein the sensing gate for detection comprises: a gate body fixed to the substrate; and a sensing part capable of electrically conducting to the gate body; and the sensor unit comprises a reference electrode to which a voltage is applied so as to detect existence of the detection target by the change of the characteristic of the transistor part. (claim 2). With this aspect, it also becomes possible to handle the sensing part separately from the gate body, and convenience when performing an analysis can be improved as compared with conventional sensor units.

At this point, in the sensor unit, preferably the sensing part is mechanically removable from the gate body and, when mounted on the gate body, is in a conduction state to the gate body (claim 3). With this aspect, it becomes possible to replace a specific substance by replacing the sensing part. That is, the specific substance will be replaceable in accordance with a detection target or a purpose of detection without replacing the whole sensor unit, realizing significant improvement in production costs of the sensor unit and manpower of operations.

The sensor unit preferably has two or more sensing parts (claim 4). With this aspect, it becomes possible to detect a plurality of interactions by a single sensor unit. Thus, various kinds of detection targets will be detectable by one sensor unit, enabling higher functionality of the sensor unit.

Further, in the sensor unit, one gate body is preferably formed to be capable of conducting to two or more sensing parts (claim 5). With this aspect, it becomes possible to reduce the number of sensing gates, eventually leading to at least one of advantages of miniaturization, integration, and lower costs of the transistor and so on.

The sensor unit preferably comprises an electric connection switching part for switching conduction between the gate body and the sensing part (claim 6). This aspect will lead to at least one of advantages of miniaturization of the sensor unit, improvement of reliability of detected data, efficient detection and so on.

Further, in the sensor unit, preferably two or more transistor parts are integrated (claim 7). This aspect will lead to at least one of advantages of miniaturization and lower costs of the sensor unit, speedy detection and improvement of detection sensitivity, simplification of operations and so on.

Still another aspect of the present invention includes a sensor unit for detecting a detection target, comprising a transistor part having a substrate, a source electrode and a drain electrode provided on the substrate, a channel forming a current path between the source electrode and the drain electrode, and a sensing gate for detection on which a sensing site on which a specific substance capable of selectively interacting with the detection target is immobilized is formed, wherein two or more of the transistor parts are integrated. (claim 8). With this aspect, it becomes possible to detect various kinds of detection targets by a single sensor unit and convenience when performing an analysis can be improved as compared with conventional sensor units. Improvement of detection sensitivity can also be expected, in addition to being able to obtain a multifunctional sensor unit at lower prices.

Further, another aspect of the present invention includes a sensor unit for detecting a detection target, comprising a transistor part having a substrate, a source electrode and a drain electrode provided on the substrate, a channel forming a current path between the source electrode and the drain electrode, and a sensing gate for detection, wherein two or more of the transistor parts are integrated and the sensor unit comprises a reference electrode to which a voltage is applied so as to detect existence of the detection target by the change of the characteristic of the transistor part. (claim 9). With this aspect, it also becomes possible to detect various kinds of detection targets by a single sensor unit and convenience when performing an analysis can be increased as compared with conventional sensor units. Improvement of detection sensitivity can also be expected, in addition to being able to obtain a multifunctional sensor unit at lower prices.

Further, still another aspect of the present invention includes a sensor unit for detecting a detection target, comprising a transistor part having a substrate, a source electrode and a drain electrode provided on the substrate, and a channel forming a current path between the source electrode and the drain electrode, wherein a sensing site on which a specific substance capable of selectively interacting with the detection target is immobilized is formed on the channel and two or more of the transistor parts are integrated. (claim 10). With this aspect, it becomes possible to detect various kinds of detection targets by a single sensor unit and convenience when performing an analysis can be increased as compared with conventional sensor units. Improvement of detection sensitivity can also be expected, in addition to being able to obtain a multifunctional sensor unit at lower prices.

Any sensor unit having a sensing part preferably comprises a reaction field cell unit having a flow channel causing a sample to flow therethrough, wherein the sensing part is provided in the flow channel (claim 11). This aspect will lead to at least one of advantages of speedy detection, simplification of operations and so on.

Further, any sensor unit having a sensing site preferably comprises a reaction field cell having a flow channel causing a sample to flow so as to bring the sample into contact with the sensing site (claim 12). This aspect will also lead to at least one of advantages of speedy detection, simplification of operations and so on.

Still another aspect of the present invention includes a sensor unit that comprises: a transistor part having a substrate, a source electrode and a drain electrode provided on the substrate, a channel forming a current path between the source electrode and the drain electrode, and a sensing gate; and a cell unit mounting part for mounting a reaction field cell unit having a sensing part on which a specific substance capable of selectively interacting with a detection target is immobilized, wherein when the reaction field cell unit is mounted in the cell unit mounting part, the sensing part and the sensing gate are brought into conduction. (claim 13). With this aspect, it becomes possible to handle the sensing part separately from the gate body, and convenience when performing an analysis can be improved as compared with conventional sensor units.

Further, still another aspect of the present invention includes a sensor unit that comprises: a transistor part having a substrate, a source electrode and a drain electrode provided on the substrate, a channel forming a current path between the source electrode and the drain electrode, and a sensing gate; and a cell unit mounting part for mounting a reaction field cell unit having a sensing part and a reference electrode to which a voltage is applied so as to detect existence of a detection target by the change of the characteristic of the transistor part, wherein when the reaction field cell unit is mounted in the cell unit mounting part, the sensing part and the sensing gate are brought into conduction. (claim 14). With this aspect, it becomes possible to handle the sensing part separately from the gate body, and convenience when performing an analysis can be increased as compared with conventional sensor units.

The sensor unit preferably comprises an electric connection switching part for switching conduction between the sensing gate and the sensing part when the reaction field cell unit has two or more of the sensing parts (claim 15). This aspect will lead to at least one of advantages of miniaturization of the sensor unit, improvement of reliability of detected data, efficient detection and so on.

Further, in the sensor unit, preferably two or more of the transistor parts are integrated (claim 16). This aspect will lead to at least one of advantages of miniaturization and lower costs of the sensor unit, speedy detection and improvement of detection sensitivity, simplification of operations and so on.

Further, in the sensor unit, the channel is preferably formed with a nano tube structure (claim 17). The nano tube structure is preferably a structure selected from a group consisting of a carbon nano tube, a boron nitride nano tube, and a titania nano tube (claim 18). With these aspects, it becomes possible to dramatically enhance detection sensitivity. Therefore, detection of reactions requiring extremely high sensitivity such as antigen-antibody reaction that was impossible using conventional transistors is now possible at a level of practical use and a series of detection targets including the antigen-antibody reaction requiring extremely high sensitivity can be detected by one sensor unit.

That is, a sensor using conventional transistors has the limited detection sensitivity and detection of a series of target substances that need to be detected could not be detected by such transistors alone. Thus, the scope of application of a sensor unit constructed of transistors was limited. However, since detection sensitivity can be enhanced by a sensor unit according to the present invention, the scope of detection targets can be expanded.

From the above point of view, it is preferable that defects are introduced in the nano tube structure (claim 19). Or, it is preferable that the electric characteristic of the nano tube structure has the property like metals (claim 20). With these aspects, it becomes possible to cause the transistor part to function as a single-electron transistor to further enhance detection sensitivity.

Still another aspect of the present invention includes a sensor unit that comprises: a transistor part having a substrate, a source electrode and a drain electrode provided on the substrate, a channel formed of a carbon nano tube forming a current path between the source electrode and the drain electrode, and a sensing gate for detection fixed to the substrate; and a reference electrode to which a voltage is applied so as to detect existence of a detection target by the change of the characteristic of the transistor part (claim 21). With this aspect, it becomes possible to detect the detection target with high detection sensitivity without using any specific substance, and thus, operations such as replacement of specific substances are made unnecessary and convenience when performing an analysis can be improved as compared with conventional sensor units.

Further, in the sensor unit, preferably two or more of the transistor parts are integrated (claim 22). This aspect will lead to at least one of advantages of miniaturization and lower costs of the sensor unit, speedy detection and improvement of detection sensitivity, simplification of operations and so on.

In the sensor unit, the transistor part preferably comprises a voltage application gate applying a voltage or an electric field to the channel (claim 23). With this aspect, it becomes possible to enhance detection accuracy.

Further, still another aspect of the present invention includes a reaction field cell unit mounted in a cell unit mounting part of a sensor unit comprising a transistor part having a substrate, a source electrode and a drain electrode provided on the substrate, a channel forming a current path between the source electrode and the drain electrode, and a sensing gate, and the cell unit mounting part, the reaction field cell unit comprising: a sensing part on which a specific substance capable of selectively interacting with a detection target is immobilized, wherein when mounted in the cell unit mounting part, the sensing part and the sensing gate are in a conduction state (claim 24). With this aspect, it becomes possible to handle the sensing part separately from the gate body, and convenience when performing an analysis can be improved as compared with conventional sensor units.

Moreover, still another aspect of the present invention includes a reaction field cell unit mounted in a cell unit mounting part of a sensor unit comprising a transistor part having a substrate, a source electrode and a drain electrode provided on the substrate, a channel forming a current path between the source electrode and the drain electrode, and a sensing gate, and the cell unit mounting part, the reaction field cell unit comprising: a sensing part and a reference electrode to which a voltage is applied so as to detect existence of a detection target by the change of the characteristic of the transistor part, wherein when mounted in the cell unit mounting part, the sensing part and the sensing gate are in a conduction state (claim 25). With this aspect, it becomes possible to handle the sensing part separately from the gate body, and convenience when performing an analysis can be improved as compared with conventional sensor units.

At this point, the reaction field cell unit preferably has two or more of the sensing parts (claim 26). With this aspect, it becomes possible to detect a plurality of interactions by a single sensor unit. Thus, various kinds of detection targets will be detectable by one sensor unit, enabling higher functionality of the sensor unit.

In the reaction field cell unit, preferably two or more sensing parts are formed to be capable of conducting to the one sensing gate (claim 27). With this aspect, it becomes possible to reduce the number of sensing gates, eventually leading to at least one of advantages of miniaturization, integration, and lower costs of the transistor and so on.

Further, the reaction field cell unit preferably comprises a flow channel that can cause a sample to flow, wherein the sensing part is provided in the flow channel (claim 28). This aspect will lead to at least one of advantages of speedy detection, simplification of operations and so on.

Still another aspect of the present invention includes an analytical apparatus that comprises one of the sensor units described above (claim 29).

At this point, it is preferable that the analytical apparatus can analyze chemical reaction and immunological reaction by the sensor unit (claim 30).

It is preferable that the analytical apparatus can analyze measurements of at least one measurement group selected from measurement groups consisting of an electrolytic concentration measurement group, a biochemical item measurement group, a blood gases concentration measurement group, a blood cell count measurement group, a blood coagulation ability measurement group, an immunological reaction measurement group, a nucleic acid-nucleic acid hybridization reaction measurement group, a nucleic acid-protein interaction measurement group, and a receptor-ligand interaction measurement group by the sensor unit (claim 31).

Further, it is preferable that the analytical apparatus can analyze detection of two or more detection targets selected from a group consisting of at least one detection target selected from the electrolytic concentration measurement group, at least one detection target selected from the biochemical item measurement group, at least one detection target selected from the blood gases concentration measurement group, at least one detection target selected from the blood cell count measurement group, at least one detection target selected from the blood coagulation ability measurement group, at least one detection target selected from the nucleic acid-nucleic acid hybridization reaction measurement group, at least one detection target selected from the nucleic acid-protein interaction measurement group, at least one detection target selected from the receptor-ligand interaction measurement group, and at least one detection target selected from the immunological reaction measurement group by the sensor unit (claim 32).

It is also preferable that the analytical apparatus can analyze measurements of at least one measurement group selected from groups consisting of the electrolytic concentration measurement group, biochemical item measurement group, blood gases concentration measurement group, blood cell count measurement group, and blood coagulation ability measurement group, and at least one measurement group selected from groups consisting of the nucleic acid-nucleic acid hybridization reaction measurement group, nucleic acid-protein interaction measurement group, receptor-ligand interaction measurement group, and immunological reaction measurement group by the sensor unit (claim 33).

Further, it is preferable that the analytical apparatus can detect two or more detection targets selected for determining a specific disease or function (claim 34).

Still another aspect of the present invention includes an analytical apparatus that comprises a sensor unit comprising a substrate; a first transistor part having a first source electrode and a first drain electrode provided on the substrate, and a first channel formed of a carbon nano tube forming a current path between the first source electrode and the first drain electrode; and a second transistor part having a second source electrode and a second drain electrode provided on the substrate, and a second channel forming a current path between the second source electrode and the second drain electrode, wherein at least one detection target selected from at least one measurement group selected from groups consisting of a nucleic acid-nucleic acid hybridization reaction measurement group, a nucleic acid-protein interaction measurement group, a receptor-ligand interaction measurement group, and an immunological reaction measurement group is detected as the change of the characteristic of the first transistor part and at least one detection target selected from at least one measurement group selected from groups consisting of an electrolytic concentration measurement group, a biochemical item measurement group, a blood gases concentration measurement group, a blood cell count measurement group, and a blood coagulation ability measurement group is detected as the change of the characteristic of the second transistor part (claim 35).

In the analytical apparatus, a specific substance capable of selectively interacting with the detection target is preferably immobilized on the carbon nano tube. That is, a sensing site on which a specific substance capable of selectively interacting with the detection targets is immobilized is preferably formed in the first channel (claim 36).

### ADVANTAGEOUS EFFECTS OF THE INVENTION

According to the sensor unit of the present invention, the reaction field cell unit used therewith, and the analytical apparatus using thereof, convenience when performing an analysis can be improved as compared with conventional sensor units.

### BRIEF DESCRIPTION OF THE DRAWINGS

FIG. 1 (a) to FIG. 1 (d) are figures illustrating first to sixth embodiments of the present invention and each of FIG. 1 (a) to FIG. 1 (d) is a figure for illustrating an operation in each process of a production method of a channel using a carbon nano tube.

FIG. 2 is a schematic view illustrating an example of the production method of a channel using a carbon nano tube to illustrate the first to sixth embodiments of the present invention.

FIG. 3 is a schematic view illustrating an example of the production method of a channel using a carbon nano tube to illustrate the first to sixth embodiments of the present invention.

FIG. 4 (a) to FIG. 4 (f) are figures illustrating the first to sixth embodiments of the present invention and each of FIG. 4 (a) to FIG. 4 (f) is a plan view of a reaction field cell unit in which flow channels are forms.

FIG. 5 is a figure schematically showing a configuration of main components of an example of the analytical apparatus using the sensor unit to illustrate the first, second, and fourth embodiments of the present invention.

FIG. 6 is an exploded perspective view schematically showing the configuration of main components of an example of the sensor unit to illustrate the first, second, and fourth embodiments of the present invention.

FIG. 7 (a) and FIG. 7 (b) are figures schematically showing the configuration of main components of a detection device part (a transistor part in the fourth embodiment) of an example of the sensor unit to illustrate the first, second, and fourth to sixth embodiments of the present invention, and FIG. 7 (a) is a perspective view and FIG. 7 (b) is a side view.

FIG. 8 is a sectional view schematically showing main components of an example of the sensor unit to illustrate the first, second, and fourth embodiments of the present invention.

FIG. 9 is a figure schematically showing the configuration of main components of an example of the analytical apparatus using the sensor unit to illustrate the second, third, and seventh embodiments of the present invention.

FIG. 10 is an exploded perspective view schematically showing the configuration of main components of an example of the sensor unit to illustrate the second and third embodiments of the present invention.

FIG. 11 (a) and FIG. 11 (b) are figures schematically showing the configuration of main components of the detection device part (transistor part) of an example of the sensor unit to illustrate the second embodiment of the present invention, and FIG. 11 (a) is a perspective view and FIG. 11 (b) is a side view.

FIG. 12 (a) and FIG. 12 (b) are figures schematically showing the configuration of main components of the detection device part of an example of the sensor unit to illustrate the third embodiment of the present invention, and FIG. 12 (a) is a perspective view and FIG. 12 (b) is a side view.

FIG. 13 is a sectional view schematically showing the configuration of main components of an example of a sensor unit used for measurement of a blood coagulation time to illustrate the fifth to seventh embodiments of the present invention.

FIG. 14 is a figure showing an example of a measuring circuit of the analytical apparatus having the sensor unit to illustrate the fifth to seventh embodiments of the present invention.

FIG. 15 is a figure illustrating a change of a certain time constant, which is an example of specific changes of transistors, to illustrate the fifth to seventh embodiments of the present invention.

FIG. 16 is a sectional view schematically showing the configuration of main components of an example of the sensor unit used for measurement of whole blood cell count to illustrate the fifth to seventh embodiments of the present invention.

FIG. 17 is a figure schematically showing the configuration of main components of an example of the analytical apparatus using the sensor unit to illustrate the fifth to seventh embodiments of the present invention.

FIG. 18 is an exploded perspective view schematically showing the configuration of main components of an example of the sensor unit to illustrate the fifth to seventh embodiments of the present invention.

FIG. 19 is a sectional view schematically showing the main components of an example of the sensor unit to illustrate the fifth to seventh embodiments of the present invention.

FIG. 20 is an exploded perspective view schematically showing the configuration of main components of an example of the sensor unit to illustrate the seventh embodiment of the present invention.

FIG. 21 (a) to FIG. 21 (c) are intended for illustrating the first example of the present invention and each of FIG. 21 (a) to FIG. 21 (c) is a schematic sectional view illustrating a formation method of a channel.

FIG. 22 is intended for illustrating the first example of the present invention and is a figure illustrating the process of forming a carbon nano tube.

FIG. 23 (a) to FIG. 23 (c) are intended for illustrating the first example of the present invention and each of FIG. 23 (a) to FIG. 23 (c) is a schematic sectional view illustrating the formation method of the detection device part (transistor part).

FIG. 24 is intended for illustrating the first example of the present invention and is a schematic sectional view illustrating a substrate on which a back gate is formed.

FIG. 25 is intended for illustrating the first example of the present invention and is a schematic sectional view showing a produced carbon nano tube field-effect transistor.

FIG. 26 is intended for illustrating the first example of the present invention and is a schematic view showing the produced carbon nano tube field-effect transistor.

FIG. 27 is intended for illustrating the first example of the present invention and is a figure schematically showing an outline of a carbon nano tube field-effect transistor in which an IgG is immobilized in a characteristic measurement example 1.

FIG. 28 is intended for illustrating the first example of the present invention and is a graph showing measurement results of electric characteristic evaluation of the carbon nano tube field-effect transistor in the characteristic measurement example 1.

FIG. 29 is intended for illustrating the first example of the present invention and is a schematic view showing the configuration of a measuring system used for a characteristic measurement example 2.

FIG. 30 is intended for illustrating the first example of the present invention and is a graph showing changes in source/drain voltage-current characteristic before and after instillation of anti-mouse IgG in the characteristic measurement example 2.

FIG. 31 is intended for illustrating the first example of the present invention and is a graph showing changes in transfer characteristic before and after instillation of anti-mouse IgG anti body in the characteristic measurement example 2.

FIG. 32 is intended for illustrating the second example of the present invention and is a schematic view showing a produced carbon nano tube field-effect transistor.

FIG. 33 is intended for illustrating the second example of the present invention and is a schematic view showing an immobilization method of anti-porcin serum albumin (PSA).

FIG. 34 is intended for illustrating the second example of the present invention and is a schematic diagram showing the configuration of a measuring system used.

FIG. 35 is intended for illustrating the second example of the present invention and is a graph showing changes over time of magnitudes of measured source-drain current.

FIG. 36 is intended for illustrating an example of the present invention and is a schematic perspective view illustrating a formation method of a flow channel.

FIG. 37 is intended for illustrating an example of the present invention and is a schematic exploded perspective view of a formed reaction field cell unit.

FIG. 38 (a) to FIG. 38 (c) are intended for illustrating the fourth example of the present invention and each of FIG. 38 (a) to FIG. 38 (c) is a schematic sectional view illustrating a formation method of a channel in the present example.

FIG. 39 is intended for illustrating the fourth example of the present invention and is a figure showing the configuration of main components of an apparatus used for forming a silicon nitride insulation layer.

FIG. 40 is intended for illustrating the fourth example of the present invention and is a schematic sectional view of a sapphire substrate on which the silicon nitride insulation layer is formed.

FIG. 41 is intended for illustrating the fourth and fifth examples of the present invention and is a schematic top view of a top-gate type CNT-FET sensor having the silicon nitride gate insulation layer.

FIG. 42 is intended for illustrating the fourth example of the present invention and is a schematic sectional view obtained after cutting the top-gate type CNT-FET sensor by a A-A′ surface in FIG. 41.

FIG. 43 is intended for illustrating the fourth example of the present invention and is a schematic diagram showing the configuration of main components of a measuring system (analytical apparatus) used for characteristic measurement.

FIG. 44 is intended for illustrating the fourth example of the present invention and is a graph showing changes over time of a current (I_{DS}) flowing between the source electrode and drain electrode when PSA is instilled.

FIG. 45 is intended for illustrating the fifth example of the present invention and each of FIG. 45 (a) and FIG. 45 (b) is a schematic sectional view illustrating how an electrode is formed in the present example.

FIG. 46 is intended for illustrating the fifth example of the present invention and is a schematic sectional view of a substrate on which a silicon nitride insulation layer is formed.

FIG. 47 is intended for illustrating the fifth example of the present invention and is a schematic sectional view obtained after cutting the top-gate type CNT-FET sensor by the A-A′ surface in FIG. 41.

FIG. 48 is intended for illustrating the fifth example of the present invention and is a schematic diagram showing the configuration of main components of a measuring system (analytical apparatus) used for characteristic measurement.

FIG. 49 is intended for illustrating the fifth example of the present invention and is a graph showing changes over time of the current (I_{DS}) flowing between the source electrode and drain electrode.

### EXPLANATION OF REFERENCES

1 a substrate
2 a photo resist
3 a catalyst
4 a CVD furnace
5 a carbon nano tube (channel)
6 a spacer layer
7 a flow channel
8 a sensing part
9 an injection part
10 a discharge part
11 a partition
12 a substrate
13, 18 an insulation layer
14 a source electrode a drain electrode
16 a SET channel
17 a sensing gate (gate body)
19, 30 a sensing part
20 a sensing gate for detection
21 a reaction field
22 a reference electrode
23 a voltage application gate
24, 32, 33, 36 a transistor part
25, 34, 37 a reaction field cell unit
26, 27 a tabular frame
28 a spacer
29 a flow channel
31 an electrode section
35, 38 a cell unit mounting part
100, 200, 300, 400, 500, 600, 700 an analytical apparatus
101, 201, 301, 402, 501, 602, 701 a sensor unit
102, 202, 302, 502, 702 a measuring circuit
103, 203, 303, 401, 503, 601, 703 a transistor part
104, 204, 304, 504, 704 an integrated detection device
105, 505 a connector socket
105A a mounting part
105B a mounting part (cell unit mounting part)
106, 506 a separate type integrated electrode
107, 507 a reaction field cell
108, 206, 306, 508, 706 a substrate
109, 509 a detection device part
110, 207, 307, 510, 707 a low-permittivity layer
111, 208, 308, 511, 708 a source electrode
112, 209, 309, 512, 709 a drain electrode
113, 210, 310, 513, 710 a channel
114, 211, 514, 711 an insulation layer
115, 515 a sensing gate (gate body)
116, 516 an electrode section (sensing part)
117, 517 a sensing gate for detection
118, 215, 314, 518, 713 a voltage application gate
119, 218, 316, 519, 716 a flow channel
120, 216, 313, 520, 714 an insulator layer
121, 124, 521, 524 a wiring
122, 522 a substrate
123, 214, 311 a specific substance
125, 217, 315, 525, 715 a base
126, 403, 526, 603 a reaction field cell unit
205, 305, 705 a reaction field cell
212, 712 a sensing gate for detection
213, 312 a sensing site
404, 604 a reaction field mounting part
527, 717 a reference electrode

### BEST MODE FOR CARRYING OUT THE INVENTION

Embodiments of the present invention will be described in detail below. The present invention is not limited to the following embodiments or examples and any modification can be made without departing from the scope of the present invention.

### First Embodiment

A sensor unit according to a first embodiment of the present invention (hereinafter called “first sensor unit” as appropriate) comprises a transistor part having a substrate, a source electrode and a drain electrode provided on the substrate, a channel forming a current path between the source electrode and the drain electrode, and a sensing gate for detection. The transistor part is a part that functions as a transistor and the sensor unit in the present embodiment can detect detection targets by detecting a change of output characteristic of the transistor. The transistor part can also be distinguished between the field-effect transistor and single-electron transistor based on a concrete configuration of a channel thereof and any type may be used for the first sensor unit. The transistor part is called in descriptions below simply a “transistor” as appropriate and, in that case, whether the transistor functions as a field-effect transistor or a single-electron transistor is not distinguished, if not otherwise mentioned.

The first sensor unit may also have other members than the transistor such as an electric connection switching part and a reaction field cell unit as appropriate.

Components of the first sensor unit will be described below.

[I. Transistor Part]

(1. Substrate)

A substrate formed of any material can be used as long as the substrate has insulation properties, but an insulating substrate or an insulated semiconductor substrate is usually used. In the present specification, insulation properties refer to electric insulation properties if not otherwise mentioned, and an insulator refers to an electric insulator if not otherwise mentioned. If the substrate is used for a sensor, preferably an insulating substrate or a semiconductor substrate insulated by coating a surface of the semiconductor substrate with a material constituting an insulating substrate (that is, an insulator) is used to enhance sensitivity. If such an insulating substrate or a semiconductor substrate coated with an insulator is used, stray capacitance can be reduced due to low permittivity when compared with a semiconductor substrate insulated by any other method and thus, if, for example, aback gate (a gate provided on a side opposite to a channel with respect to the substrate) is used as a sensing gate for detection, detection sensitivity of interaction can be enhanced.

The insulating substrate is a substrate formed of an insulator. Concrete examples of insulator forming an insulating substrate include such as silicon oxide, silicon nitride, aluminum oxide, titanium oxide, calcium fluoride, acrylic resin, polyimide, and Teflon (registered trademark). A single insulator may be used alone, or two or more insulators may be used in any kinds of combination with any percentage each.

The semiconductor substrate is a substrate formed of a semiconductor. Concrete examples of semiconductor forming an semiconductor substrate include such as silicon, gallium arsenide, gallium nitride, zinc oxide, indium phosphide, and silicon carbide. A single semiconductor may be used alone, or two or more semiconductors may be used in any kinds of combination with any percentage each.

Further, any insulating method of semiconductor substrate may be used, but it is usually desirable to insulate the semiconductor substrate by providing coating of an insulator as described above. When a semiconductor substrate is insulated by forming an insulation layer on the semiconductor substrate, concrete examples of insulator used for coating include those insulators forming the insulating substrates described above.

If an insulated semiconductor substrate is used, the semiconductor substrate can also be made to work as a gate described later {that is, as a sensing gate (gate body), voltage application gate and the like}. However, if an insulated semiconductor substrate is used for a gate, the substrate desirably has low electric resistance and, for example, a semiconductor substrate using a semiconductor having low resistivity and metallic conductivity by adding high-concentration donors or acceptors is desirable.

Further, a substrate of any shape can be used, but usually a tabular shape substrate is adopted. No restrictions are imposed on dimensions thereof, but a substrate preferably has a size of 100 μm or larger to maintain mechanical strength of the substrate.

(2. Source Electrode/Drain Electrode)

There is no restriction on the source electrode as long as the electrode can supply carriers of the transistor. There is also no restriction on the drain electrode as long as the electrode can receive carriers of the transistor and any known electrodes can be used in any form. However, the source electrode and drain electrode are usually provided on the same substrate.

The source electrode and drain electrode can each be formed of any conductor and concrete examples of conductor include gold, platinum, titanium, titanium carbide, tungsten, aluminum, molybdenum, chrome tungsten silicide, tungsten nitride, and polysilicon. A single conductor may be used alone, or two or more conductors may be used in any kinds of combination with any percentage each to form the source electrode or drain electrode.

Further, the source electrode and drain electrode may have any dimensions and shape.

(3. Channel)

(3-1 Channel configuration)

The channel forms a current path between the source electrode and drain electrode and any known channel may be used as appropriate.

A channel of any dimensions and shapes can be used. However, the channel is preferably bridged between the source electrode and the drain electrode in a state where the channel is separated from the substrate. This can reduce the permittivity between the sensing gate and the channel and the electric capacity of the sensing gate, and sensitivity of the sensor unit can be enhanced.

Also, the channel is preferably provided between the source electrode and the drain electrode in a state where the channel is sagging at room temperature. This makes damage of the channel due to temperature change less likely.

Further, the number of channels is arbitrary, and one channel or two or more channels may be used.

The transistor is distinguished between the field-effect transistor and single-electron transistor based on the configuration of channel as described above. A difference between the two transistors is whether the channel has a quantum dot structure or not. A channel without quantum dot structure becomes a field-effect transistor and a channel having quantum dot structures becomes a single-electron transistor.

Therefore, the channel is preferably formed of appropriate materials in accordance with purposes of the sensor unit and whether the transistor should be a field-effect transistor or a single-electron transistor.

The channel of a field-effect transistor (hereinafter called “FET channel” as appropriate) and that of a single-electron transistor (hereinafter called “SET channel” as appropriate) will be described below. When the FET channel and the SET channel should not be distinguished, simply the word “channel” is used. Since the field-effect transistor and the single-electron transistor can be distinguished by the channel as described above, a transistor having a FET channel should be recognized as a field-effect transistor and a transistor having a SET channel should be recognized as a single-electron transistor.

The FET channel can form a current path and any known channels can be used as appropriate. A transistor channel is generally formed of semiconductors exemplified as materials of semiconductor substrate and such semiconductors can also be used to form the FET channel.

However, the FET channel is preferably fine-structured to enhance sensitivity of the sensor unit. Limitations of detection sensitivity of a sensor using transistors are generally related to the electric capacity of a gate of transistor (hereinafter called “gate capacitance” as appropriate). With a lower gate capacitance, it becomes possible to recognize a change of surface charges of the gate as a larger change of gate voltage, improving detection sensitivity of the sensor. Since the gate capacitance is proportional to the product L×W of the channel length L and the channel width W, the finer channel is effective for reduction of the gate capacitance. A finer channel can preferably be formed by using, for example, a nano tube structure.

The nano tube structure is a tubular structure whose cross section perpendicular to a longitudinal direction has a diameter between 0.4 to 50 nanometers. Here, a tubular structure refers to a shape whose ratio of a length in the longitudinal direction of the structure to a length in a direction perpendicular to the longitudinal direction where the length is longest is between 10 and 10000 and includes various shapes such as a rod shape (almost circular in its cross section) and a ribbon shape (flat and almost square in its cross section).

The nano tube structure can be used as a charge transporter and has a one-dimensional quantum wire structure whose diameter is several nanometer, and if the nano tube structure is used for a transistor channel, the gate capacitance of the transistor dramatically decreases in comparison with a field-effect transistor used in a conventional sensor. Therefore, a change of the gate voltage occurred by interactions between a specific substance and detection targets becomes extremely large and a change of the density of charged particles existing in the channel becomes markedly large. This dramatically improves detection sensitivity.

Concrete examples of the nano tube structure include a carbon nano tube (CNT), a boron nitride nano tube, and a titania nano tube. It was difficult for a conventional technique to form a channel on the order of 10 nanometer even if a semiconductor microfabrication technique was used and thereby detection sensitivity of the sensor was limited. By using the nano tube structure, finer channels can be formed.

The nano tube structure demonstrates both electric properties like semiconductors and those like metals in accordance with chirality thereof. When using the nano tube structure for a FET channel like semiconductors, the nano tube structure preferably has properties like semiconductors as electric properties thereof.

Like the FET channel, an SET channel also forms a current path and any known channels can be used as appropriate. Therefore, the SET channel can be formed of semiconductor, but usually the size thereof is preferably fine-structured and, like the FET channel, it is preferable that the SET channel is formed of a nano tube structure. Also like the FET channel, concrete examples of nano tube structure include a carbon nano tube (CNT), a boron nitride nano tube, and a titania nano tube.

However, unlike the FET channel, the SET channel has a quantum dot structure, as described above. Thus, the SET channel will be formed of material having quantum dot structures and even if semiconductor material is used, a semiconductor having quantum dot structures will be used as material therefor. This also applies when a nano tube structure is used for the SET channel and the SET channel will be formed of, among nano tube structures, a nano tube structure having quantum dot structures. As a concrete example, a carbon nano tube into which defects are introduced can be used for the SET channel. More specifically, a carbon nano tube having a quantum dot structure usually between 0.5 and 50 nanometers between defects can be used for the SET channel.

Any production method of a carbon nano tube having the quantum dot structures described above may be used and a carbon nano tube having the quantum dot structures can be produced, for example, by heating a carbon nano tube having no defects in an atmospheric gas such as hydrogen, oxygen, and argon or providing chemical treatment such as boiling in an acid solution or the like to introduce defects.

By introducing defects into a nano tube structure, a quantum dot structure on the order of several nanometers is formed between defects inside the nano tube structure and further the gate capacitance decreases. Since a Coulomb blockage phenomenon in which inflow of electrons into the quantum dot structures is restricted occurs in a nano tube structure having the quantum dot structures, a single-electron transistor can be realized by using such a nano tube structure.

Concrete examples will be mentioned for description. For example, the gate capacitance of a silicon MOSFET (metal oxide semiconductor field-effect transistor) is on the order of 10⁻¹⁵ F (farad) and that of a single-electron transistor using a nano tube structure into which the above defects are introduced is on the order of 10⁻¹⁹ F to 10⁻²⁰ F. Thus, the gate capacitance of a single-electron transistor decreases by a factor of 10,000 to 100,000 in comparison with a conventional silicon MOSFET.

As a result, by forming a single-electron transistor using a channel of such a nano tube structure, detection sensitivity of detection targets can significantly be improved.

Another difference of the SET channel from the FET channel is that when a nano tube structure is used for the SET channel, the nano tube structure preferably has properties like metals as electric characteristic thereof. Examples of techniques to verify whether a nano tube structure is like metals or semiconductors include a technique based on determination of chirality of the carbon nano tube by a Raman spectroscopic method and a technique based on measurement of an electronic state density of the carbon nano tube using a scanning tunneling microscope (STM) spectroscopic method.

Further, the channel is desirably coated with an insulating member for passivation or protection. Since this can make a current flowing in the transistor to reliably flow to the channel, detection targets can be detected with stability.

Any member can be used as an insulating member as long as the member has insulation properties, and concrete examples that can be used include polymeric materials such as photo resist (photosensitive resin), acrylic resin, epoxy resin, polyimide, and Teflon (registered trademark), self-organizing layers such as aminopropyl ethoxysilane, lubricants such as PER-fluoropolyether and Fomblin (product name), fullerene compounds, or inorganic substances such as silicon oxide, fluosilicate glass, HSQ (Hydrogen Silsesquioxane), MLQ (Methyl Lisesquioxane), porous silica, silicon nitride, aluminum oxide, titanium oxide, calcium fluoride, and diamond thin films. These members may be used in any combination and proportions.

A layer of material with insulation properties and low permittivity (low-permittivity layer) is preferably provided between the sensing gate (gate body of the sensing gate for detection) and channel. Further, the whole area between the sensing gate and channel (that is, all layers existing between the sensing gate and channel) preferably has properties of low permittivity.

There is no restriction on materials constituting the low-permittivity layer as long as they have insulation properties as described above and any known material may be used. Concrete examples thereof include inorganic materials such as silicon dioxide, fluosilicate glass, HSQ (Hydrogen Silsesquioxane), MLQ (Methyl Lisesquioxane), porous silica, and diamond thin films, and organic materials such as polyimide, Parylene-N, Parylene-F, and polyimide fluoride. A single material with low permittivity may be used alone, or two or more materials may be arbitrarily combined with any percentage each.

That is, since layer from the channel to the sensing gate have insulation properties and low permittivity, a change of surface charges occurring on the sensing gate is efficiently transmitted as a change of the charge density in the channel. Since the interaction is thereby sensed as a large change of output characteristic of a transistor, sensitivity of a sensor can be improved if the transistor is used for the sensor.

Particularly when the channel is used as a SET channel, the permittivity of an insulation layer provided between the channel and sensing gate and that between the channel and voltage application gate are preferably selected as appropriate so that electrostatic energy generated by an electron being trapped by a quantum dot is sufficiently larger than thermal energy at operating temperature. An example in which two junctions, the sensing gate, and the voltage application gate are joined to a quantum dot will be mentioned. If the sum of capacity of two junctions is C_{T}, the capacity of a capacitor formed between the channel and sensing gate by providing an insulation layer between the channel and sensing gate is C_{G1}, and the capacity of a capacitor formed between the channel and voltage application gate by providing an insulation layer between the channel and the voltage application gate is C_{G2}, the permittivity of the insulation layers is preferably selected as appropriate so that kT<<e²/{2(C_{T}+C_{G1}+C_{G2})} holds. Here, the left-hand side represents thermal energy and the right-hand side represents electrostatic energy generated by an electron being trapped. Also, k is the Boltzmann's constant, T is an operating temperature, and e is an elementary charge.

If a voltage application gate is provided in the transistor, a layer of material with insulation properties and high permittivity (high-permittivity layer) is preferably provided between the voltage application gate which applies gate voltage to the transistor and channel. Further, the whole area between the voltage application gate and channel (that is, all layers existing between the voltage application gate and channel) preferably has properties of high permittivity.

There is no restriction on materials constituting the high permittivity layer as long as they have insulation properties and high permittivity as described above and any known material may be used. Concrete examples thereof include inorganic substances such as silicon nitride, aluminum oxide, tantalum oxide, hafnium oxide, titanium oxide, and zirconium oxide, and polymeric materials having high permittivity characteristic. A single material with high permittivity may be used alone, or two or more materials may be arbitrarily combined with any percentage each.

That is, since high-permittivity layer having insulation properties and high permittivity are formed from the voltage application gate to the channel, transfer characteristic of the transistor can efficiently be modulated when a voltage is applied from the voltage application gate. If the transistor is used for a sensor, sensitivity of the sensor is thereby improved.

There is no restriction on the formation method of an insulation layer, low-permittivity layer and high-permittivity layer, and any known method may be used. If an insulation layer is to be formed using silicon oxide, for example, after forming a film composed of silicon oxide all over a substrate, an insulation layer can be formed by performing patterning by photolithography and removing silicon oxide to be removed by selective wet etching.

(3-2 Production Method of a Channel)

Any production method of a channel that can make a channel described above may be used to make a channel.

Here, a production method of a channel will be described by giving an example of a production method of a channel when a carbon nano tube is used as a channel.

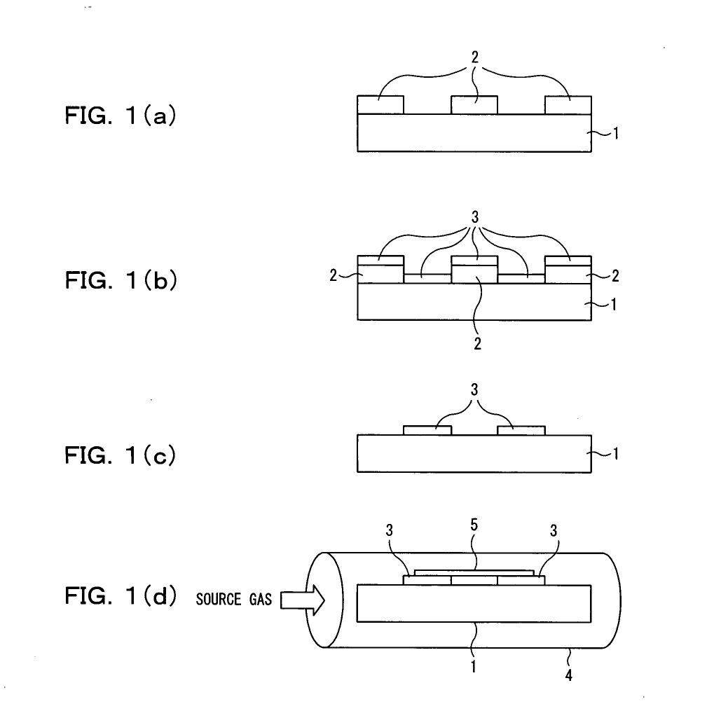

FIG. 1 (a) to FIG. 1 (d) are figures for illustrating an operation in each process of a production method of a channel using a carbon nano tube.

A carbon nano tube used for a channel is usually formed by controlling the position and direction thereof. Thus, the channel is usually made by controlling the position and direction of growth of the carbon nano tube using a catalyst with patterning by photolithography or the like. More specifically, for example, processes (1) to (4) shown below are performed to form the channel made of a carbon nano tubes.

Process (1): Create photo resist patterns on a substrate. {FIG. 1 (a)}

Process (2): Evaporate a metallic catalyst onto the substrate. {FIG. 1 (b)}

Process (3): Form a pattern of catalyst by lift-off. {FIG. 1 (c)}

Process (4): Form a carbon nano tube by flowing a material gas. {FIG. 1 (d)}

Each process will be described below.

First, in Process (1), determine a pattern to be formed in accordance with the position and direction in which a carbon nano tube should be formed, as shown in FIG. 1 (a), and then, adjusting to the pattern, create photo resist patterns 2 on a substrate 1.

Next, in Process (2), evaporate a metal to serve as a catalyst 3 onto a surface of the substrate 1 on which the patterning has been created, as shown in FIG. 1 (b). Examples of metal to serve as the catalyst 3 include transition metals such as iron, nickel and cobalt, and alloys thereof.

Subsequently, in Process (3), after evaporation of the catalyst 3, perform lift-off, as shown in FIG. 1 (c). Since the photo resist 2 is removed from the substrate 1 by lift-off, the catalyst 3 evaporated onto the surface of the photo resist 2 is also removed from the substrate 1. A pattern of the catalyst 3 is thereby formed in accordance with the pattern formed in Process (1).

Lastly, in Process (4), flow a source gas such as a methane gas and alcohol gas in a CVD (chemical vapor deposition) furnace 4 at a high temperature to form a carbon nano tube 5 between the catalysts 3, as shown in FIG. 1 (d). The metallic catalyst 3 is in a state of particulates of several nanometer in diameter at a high temperature and a carbon nano tube grows using such particulates as cores thereof. Here, the high temperature refers to a temperature between 300° C. and 1200° C.

The carbon nano tube 5 can be formed by Process (1) to Process (4) as described above.

After that, usually a source electrode and a drain electrode are formed at both ends of the carbon nano tube 5 using an ohmic electrode or the like. At this point, the source electrode and drain electrode may be attached to tips of the carbon nano tube 5 or flanks thereof. When forming electrodes of the source electrode and drain electrode, heat treatment in the range of 300° C. and 1000° C. may be provided to achieve a better electric connection. Further, a transistor is made by providing a sensing gate, a voltage application gate, an insulating member, a low-permittivity layer, and a high-permittivity layer at appropriate positions.

According to the production method described above, a field-effect transistor can be made by forming an FET channel.

Further, an SET channel can be made by providing chemical treatment such as heating in an atmospheric gas such as hydrogen, oxygen, and argon and boiling in an acid solution or the like to the carbon nano tube 5 as an FET channel made in by Process (1) to Process (4) and introducing defects to form quantum dot structures.

Also when integrating a plurality of transistors on a substrate, for example, for integration of the transistors, an array of the transistors can similarly be made by creating patterning of catalyst for a plurality of source electrodes and drain electrodes on the same substrate usually by photolithography and growing carbon nano tubes.

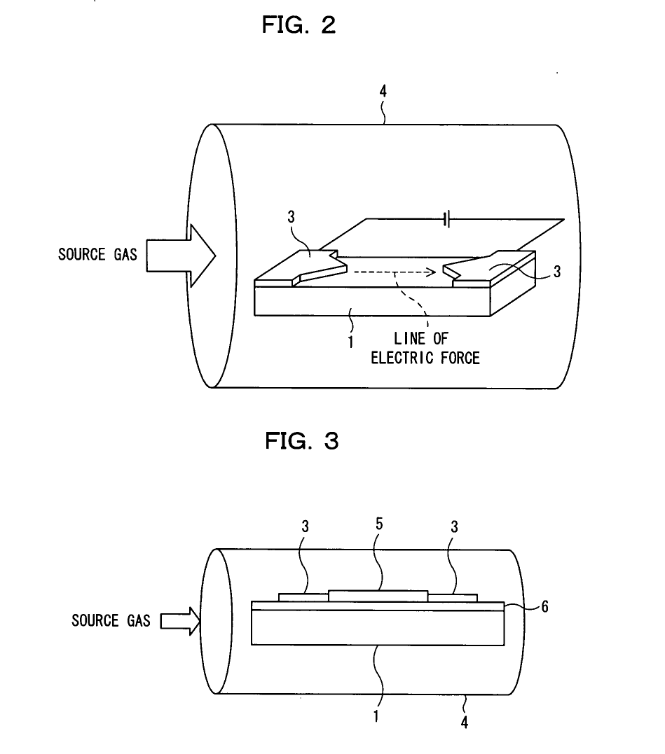

Using the production method of a channel composed of a carbon nano tube exemplified here, a transistor can be made by forming a carbon nano tube controlling the position and direction thereof. For the purpose of controlling the growth direction of the carbon nano tube or a similar purpose, as shown in FIG. 2, the catalyst 3 may have a steep shape at its tip to apply a voltage (electric field) between two catalysts while growing the carbon nano tube 5. This causes the carbon nano tube 5 to grow along a line of electric force between the steep-shaped catalysts to be able to increase controllability while making a channel. FIG. 2 is a schematic view illustrating an example of the production method of a channel using a carbon nano tube and the same numerals as those in FIG. 1 denote the same components.

The reason why the carbon nano tube 5 grows along the line of electric force by applying a voltage between the catalysts 3, as described above, is not clear, and two conjectures are possible. One conjecture is that the carbon nano tube 5 grows in a direction along an electric field because the carbon nano tube 5 that starts growing from electrodes (here the catalysts 3) has a large polarization moment. A second conjecture is that carbon ions isolated at a high temperature form the carbon nano tube 5 along the line of electric force.

A factor blocking the growth of the carbon nano tube 5 considered in the second conjecture is considered to be that the direction control becomes difficult because the carbon nano tube 5 closely adheres to the substrate 1 under the influence of a large van der Waals force working between the substrate 1 and the carbon nano tube 5. Thus, in order to reduce the influence of the van der Waals force, a spacer layer 6 formed of silicon oxide or the like is provided between the catalyst 3 and the substrate 1, as shown in FIG. 3, in the production method of a transistor described above so that the carbon nano tube 5 is preferably grown by isolating the carbon nano tube 5 from the substrate 1. FIG. 3 is a schematic view illustrating an example of the production method of a channel using a carbon nano tube, and the same numerals as those in FIG. 1 and FIG. 2 denote the same components.

(4. Sensing Gate for Detection)

The sensing gate for detection is comprised of a sensing gate, which is a gate body, and a sensing part (interaction sensing part). If, in a first sensor unit, an interaction occurs in the sensing part of the sensing gate for detection, the gate voltage of the sensing gate will change and, by detecting a change in transistor characteristic caused by the change of the gate voltage of the sensing gate, detection targets will be detected.

(4-1 Sensing Gate)

The sensing gate (that is, the gate body) is a gate fixed on a substrate on which the corresponding source electrode and the drain electrode are fixed. Any sensing gate that can apply a gate voltage to control the density of charged particles in the channel of a transistor can be used. The sensing gate is usually constructed with a conductor insulated from the channel, source electrode and drain electrode and is generally constructed of conductors and insulators.

Any conductor may be used to constitute a sensing gate and concrete examples thereof include such as gold, platinum, titanium, titanium carbide, tungsten, tungsten silicide, tungsten nitride, aluminum, molybdenum, chrome, and polysilicon. A single conductor, which is a material of the sensing gate, may be used alone, or two or more materials may be arbitrarily combined with any percentage each.

Any insulator may be used for insulating the conductors described above and concrete examples thereof include those insulators exemplified as materials of substrate. Further, a single insulator used for insulating the sensing gate may be used alone, or two or more insulators may be arbitrarily combined with any percentage each.

Meanwhile, a semiconductor may be used instead of a conductor of the sensing gate or in combination with the conductor. In that case, any semiconductor may be used, and a single semiconductor may be used alone or in any combination of two or more arbitrary semiconductors with any percentage each.

Also, the sensing gate may have any dimensions and shape.

Further, any position from which the gate voltage can be applied to a channel can be used as a sensing gate position and, for example, the sensing gate may be disposed at upward position of the substrate to act as a top gate, on a surface on the same side as a channel of the substrate to act as a side gate, or on an underside of the substrate (a surface opposite to the channel) to act as a back gate. This simplifies operations during detection. Meanwhile, if the sensing gate is formed as a top gate, sensitivity of the sensor unit can be enhanced because the distance between the channel and top gate is generally shorter than that between the channel and gates disposed at other positions.

Further, if the sensing gate is formed as a top gate or a side gate, the gate may be formed on the surface of the channel via an insulation layer. Any layer having insulation properties may be used in any way as the insulation layer here and usually a layer formed of an insulating material is used. Any insulating material having insulation property can be used for the insulation layer and concrete examples include inorganic materials such as silicon oxide, silicon nitride, aluminum oxide, titanium oxide, and calcium fluoride, and polymeric materials such as acrylic resin, epoxy resin, polyimide, and Teflon (registered trademark).

A voltage may be applied to the sensing gate while in use or the sensing gate may be in a floating state without applying a voltage.

Further, the number of sensing gates is arbitrary and only one sensing gate may be provided in a transistor, or two or more sensing gates may be provided.

(4-2 Sensing Part)

The sensing part in the present embodiment is a member on which a specific substance capable of interacting with detection targets is immobilized and formed in isolation from the substrate, and if an interaction between the specific substance and any detection target occurs, the sensing part can transmit the interaction as an electric signal (a change of charges) to the sensing gate. Here, detection targets are substances to be detected using the first sensor unit and the specific substance is a substance that selectively generates some interaction with the detection targets. One specific substance may be immobilized on one sensing part alone, or two or more specific substances may be immobilized in any kinds of combination with any percentage each, but usually one specific substance is immobilized on one sensing part alone. Interactions between the detection targets and specific substances will be described in detail later.

Any material can be used to construct the sensing part if a specific substance can be immobilized on the sensing part and the sensing gate can extract an interaction generated there as an electric signal. For example, the sensing part can be formed of a conductor or a semiconductor, but the sensing part is preferably formed of a conductor to enhance sensitivity. As concrete examples of conductors and semiconductors to form a sensing part, those exemplified as materials of the sensing gate can be used. These examples may be used alone or in any kinds of combination with any percentage each.

In addition to metals, a thin insulation layer may be used as a sensing part. Concrete examples of the thin insulation layer include inorganic materials such as silicon oxide, silicon nitride, aluminum oxide, titanium oxide, and calcium fluoride, and polymeric materials such as acrylic resin, epoxy resin, polyimide, and Teflon (registered trademark). These examples may be used alone or in any kinds of combination with any percentage each. However, it is desirable to reduce the distance between the sensing gate and the insulation layer and to make the insulation layer sufficiently thin so that the sensing gate can extract an interaction as an electric signal.

Further, the sensing part is constructed to be capable of electrically conducting to the sensing gate at least during detection (in use) in order to transmit an electric signal resulting from an interaction as described above. How to make electrically conductible to the sensing gate is arbitrary and, for example, a conductive member such as a conducting wire and a connector may be electrically connected for conduction or the sensing part and the sensing gate may be directly connected for conduction.

Also, the sensing part is preferably constructed to be directly or indirectly mechanically removable from the sensing gate. That is, the sensing gate is desirably constructed to be electrically conducting to the sensing gate when the sensing part is mounted (connected) to the sensing gate directly or mechanically using a conductive member or the line, and to be electrically non-conducting to the sensing gate when the sensing part is mechanically removed from the sensing gate. Thereby the specific substance can be replaced by replacing the sensing part. That is, it becomes possible to replace the specific substance in accordance with detection targets or detection purposes instead of replacing the whole sensor unit, realizing significant improvement in production costs of the sensor unit and manpower of operations.

Further, a single sensing part may be provided, or two or more sensing parts may be provided. If two or more sensing parts are provided, the same specific substance or different specific substances may be immobilized on each sensing part. It becomes possible to detect a plurality of interactions by one sensor unit by providing two or more sensing parts, as described above, and thereby to detect still more detection targets by one sensor unit. However, it is usually desirable to make sensing parts electrically non-conducting to each other to be able to reliably sense an interaction in each sensing part.

If two or more sensing parts are provided, it is preferable to provide two or more sensing parts that correspond to one sensing gate. That is, it is preferable that one sensing gate is formed to be capable of conducting to two or more sensing parts. By transmitting electric signals resulting from interactions occurring in two or more sensing parts to one sensing gate and detecting them as any change in transistor characteristic, as described above, the number of sensing gates can be reduced and it eventually becomes possible to miniaturize and integrate transistors.

Further, the sensing part may have any shape and dimensions, and the shape and dimensions can arbitrarily be set in accordance with uses or purposes thereof.

(5. Voltage Application Gate)

The first sensor unit detects detection targets by detecting any change in the transistor characteristic caused by interactions between detection targets and the specific substance. For such a change in transistor characteristic to occur, usually a current is flown in the channel and, for that purpose, an electric field must be caused to arise. Therefore, a voltage is applied to the gate and the gate voltage in turn generates an electric field in the channel.

To apply a gate voltage, a voltage may be applied to the sensing gate to apply the voltage to the channel as a gate voltage. If a voltage is generated by the interaction, the sensing gate may be put into a floating state to use a voltage generated by the interaction as a gate voltage. However, in order to enhance detection accuracy, it is desirable to provide a voltage application gate to which a voltage for detecting the interaction as a specific change of the transistor is applied, in addition to the sensing gate, to cause the voltage application gate to generate an electric field for the channel.

The voltage application gate may be formed outside the substrate, but is usually provided as a gate fixed to the substrate. The voltage application gate is usually constructed with a conductor insulated from the channel, source electrode, and drain electrode, and is generally constructed of conductors and insulators.

Any conductor may be used to construct a voltage application gate and concrete examples include those conductors used for the sensing gate. These conductors may be used alone or in any kinds of combination with any percentage each.

Further, any insulator may be used for insulating the conductor and concrete examples include those insulators exemplified as materials for the sensing gate. Also, these insulators may be used alone or in any kinds of combination with any percentage each.

Meanwhile, a semiconductor may be used instead of a conductor of the voltage application gate or in combination with the conductor. In that case, any semiconductor may be used, and a single semiconductor may be used alone or in any combination of two or more arbitrary semiconductors with any percentage each.

The voltage application gate may have any shape and dimensions.

Further, any position from which the gate voltage can be applied to a channel can be used as a voltage application gate position and, for example, the voltage application gate may be disposed at upward position of the substrate to act as a top gate, on a surface on the same side as a channel of the substrate to act as a side gate, or on the underside of the substrate to act as a back gate. This makes detection easier to perform.

Further, if the voltage application gate is formed as a top gate or a side gate, the gate may be formed on the surface of a channel via an insulation layer. The insulation layer here is the same one as that used for the sensing gate.

Further, if the voltage application gate is provided as a back gate and the transistor part should be integrated, it is preferable to provide a back gate that is electrically isolated for the each transistor. This is because, if not electrically isolated, detection sensitivity may decrease under the influence of an electric field by the voltage application gates of adjacent transistor parts when the transistor part is integrated. Also in this case, it is preferable to adopt a method of making islands by highly doping the substrate, perform electric insulation by SOI (Silicon on Insulator), and electrically insulating and isolating devices by STI (Shallow Trench Isolation) widely adopted as a known technique.

Further, when applying a voltage to the voltage application gate, any application method of voltage may be used. For example, a voltage may be applied by wiring or a voltage may be applied through some fluid including a sample fluid.

A voltage for detecting an interaction as a change in transistor characteristic is applied to the voltage application gate. If an interaction occurs, the value of the current (channel current) flowing between the source electrode and drain electrode, threshold voltage, inclination of the drain voltage with respect to the gate voltage, and the following are characteristic specific to a single-electron transistor, and variations of characteristic values of transistor such as the Coulomb oscillation threshold, Coulomb oscillation period, Coulomb diamond threshold, and Coulomb diamond period occur resulting from interactions thereof. The magnitude of voltage to be applied is usually set such that the variations can be maximized.

(6. Integration)

The transistors described above are preferably integrated. That is, it is preferable that two or more source electrodes, drain electrodes, channels, sensing gates for detection, and as appropriate, voltage application gates are provided on a single substrate, and further, it is more preferable to miniaturize them as much as possible. Among the components of the sensing gate for detection, however, the sensing part is usually formed separately from the substrate and thus it is sufficient that at least the sensing gates (gate bodies) are integrated on the substrate. Also, as appropriate, component members of each transistor may be provided in such a way that they are shared by other transistors and, for example, the sensing part of the sensing gate for detection and the voltage application gate may be shared by two or more of integrated transistors. Further, one type of transistors may be integrated, or two or more types of transistors may be integrated in any kinds of combination with any percentage each.

Integrating transistors as described above will lead to at least one of advantages of miniaturization and lower costs of the sensor unit, speedy detection and improvement of detection sensitivity, simplification of operations and so on. That is, since many sensing gates for detection can be provided at a time due to integration, for example, a multifunctional sensor unit that can detect many detection targets by one sensor unit can be provided at lower costs. Also, if integration is performed in such a way that many source electrodes and drain electrodes are connected in parallel, for example, detection sensitivity can be enhanced. Further, since the need for separately providing electrodes for comparison to be used for examination of analysis results and the like can be eliminated, for example, it becomes possible to compare results of a transistor with those of another transistor on the same sensor unit.

When integrating transistors, any arrangement of transistors and any kind of specific substance to be immobilized thereon can be used. For example, one transistor may be used to detect one detection target or a plurality of transistors may be used to detect one detection target by electrically connecting the source electrodes and drain electrodes in parallel using an array of the plurality of transistors and detecting the same detection target by each sensing gate for detection.

There is no restriction on the concrete method of integration and any known method may be used, but usually a production method generally used for producing integrated circuits can be used. Recently, a method for incorporating mechanical elements into metals (conductors) and semiconductors called MEMS (Micro Electro Mechanical System) has been developed and the technique can also be used.

Further, when transistors are integrated, any wiring method may be used and it is usually preferable to devise arrangements and the like to reduce the influence of parasitic capacitance and parasitic resistance as much as possible. More specifically, it is preferable to use, for example, the air bridge technique or wire bonding technique to connect source electrodes and/or drain electrodes or to connect the sensing gates and sensing parts.

[II. Electric Connection Switching Part]

If, in the first sensor unit, the transistor part is integrated or a plurality of sensing parts are provided, that is, two units or more of one or both of the sensing gate and the sensing part are provided, the first sensor unit preferably has an electric connection switching part for switching conduction between the sensing gate and sensing part. Thereby, miniaturization of the sensor unit, improvement of reliability of detected data, efficient detection and so on will be achieved. If transistors are integrated, the conduction may be switched not only within the same transistor, but also between transistors.

If, for example, two or more sensing parts that correspond to one sensing gate are provided, the electric connection switching part can be constructed to be capable of selectively switching which of two or more sensing parts to be brought into conduction with the sensing gate. This makes it possible to extract electric signals resulting from interactions occurring in two or more sensing parts by one sensing gate and to reduce the number of sensing gates and eventually that of transistors, leading to miniaturization of the sensor unit.

If, for example, one sensing part is provided for two or more sensing gates, the electric connection switching part can be constructed to be capable of selectively switching which of two or more sensing gates to be brought into conduction with the sensing part. This makes it possible to detect one interaction using two or more sensing gates and, by using detected data using each sensing gate, reliability of detected data can be increased.

Further, if two or more sensing gates and two or more sensing parts are provided, above advantages can be obtained, in addition to being able to detect interactions efficiently by combining the sensing gates and sensing parts.

An electric connection switching part that can switch conduction between the sensing gate and sensing part may have any concrete configuration and it is usually preferable to construct the electric connection switching part as a conductive member to cause the sensing gate and sensing part to conduct. If, for example, a connector has wiring connecting the sensing gate and sensing part, the connector can be used as an electric connection switching part by providing a switch for switching the wiring appropriately. Or, the switch itself may be considered to be an electric connection switching part.

[III. Reaction Field Cell Unit]

The reaction field cell unit in the present embodiment is a member to bring a sample into contact the sensing part. The sample is a target to be detected using the sensor unit and if any detection target is contained in the sample, the detection target and a specific substance will interact.

Any concrete configuration allowing a reaction field cell unit to bring a sample into contact with the sensing part and, if the sample contains any detection target, to cause the above-mentioned interaction can be used. The reaction field cell unit can be constructed, for example, as a container holding a sample so that the sample comes into contact with the sensing part. If the sample is fluid, however, it is desirable to construct the reaction field cell unit as a member having a flow channel to cause the fluid to flow. By detecting an interaction by causing a sample to flow, advantages of speedy detection, simplification of operations and so on can be obtained.

The sensing part described above may be formed in the reaction field cell unit. That is, the sensing gate for detection may be constructed of the sensing gate on the substrate and the sensing part in the reaction field cell unit. Thereby, the sensing part can be attached and detached together with the reaction field cell unit to simplify the operations.

Further, if a flow channel is formed in the reaction field cell unit, the sensing part preferably immobilizes a specific substance facing the flow channel. When a sample is caused to flow, the interaction described above can thereby be caused reliably if any detection target is contained in the sample.

Here, the flow channel will be described.

Though the flow channel may have any shape and dimensions, and as many flow channels as desired may be provided, it is desirable to form a flow channel in accordance with detection purposes thereof. If, for example, two or more interactions should be sensed, in order to prevent a reagent used for sensing an interaction or a reaction product from inhibiting sensing of other interactions, the flow channel can be provided so that a sample should not be mixed between individual sensing parts by, for example, setting up a wall for partitioning each sensing part. Also, if different detection targets should be analyzed at a time or reagents necessary for sensing interactions are separately introduced in individual sensing parts, for example, samples can be flown in separate flow channels beforehand.

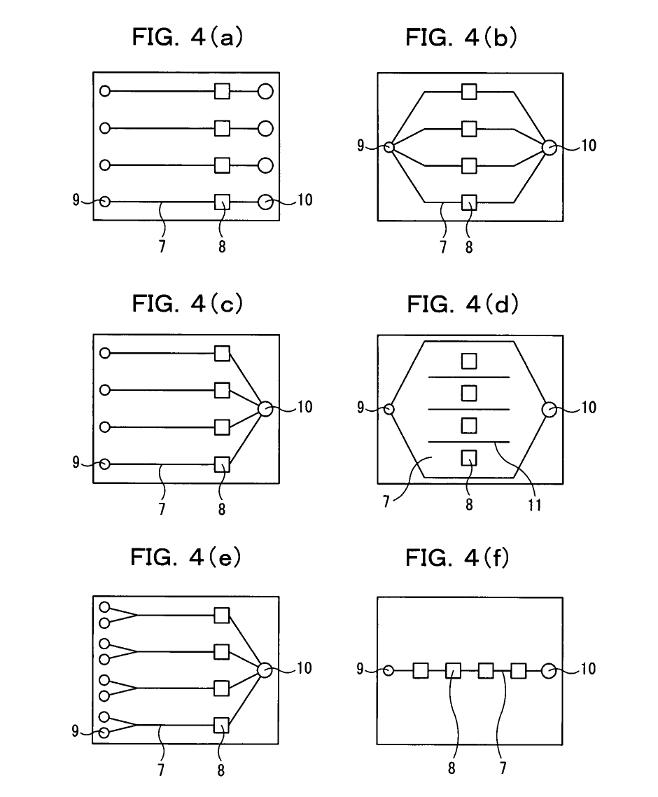

Various kinds of concrete shapes of flow channel can be considered and those shown below can be mentioned as examples. FIG. 4 (a) to FIG. 4 (f) are each plan views of the reaction field cell units in which flow channels are formed.

As shown in FIG. 4 (a), for example, a plurality of flow channels 7 may be formed in parallel, each flow channel 7 having a sensing part 8, an injection part 9 for injecting a fluid into the flow channel 7, and a discharge part 10 for discharging the fluid from the flow channel 7. If the flow channels 7 are formed into this shape, different samples flow from each injection part 9 to each sensing part 8 via the flow channel 7 and, if any detection target is contained in the sample, an interaction occurs there before each sample is discharged from each of the discharge parts 10. Thus, if different samples are injected into each of the injection parts 9 to cause each flow channel 7 to flow the samples, different samples can be analyzed by each flow channel 7 and, even if the same sample is injected into each of the injection parts 9 to cause each flow channel 7 to flow the sample, different interactions can be detected by each sensing part 8 if different specific substances are immobilized on each sensing part 8.

As shown in FIG. 4 (b), for example, the sensing part 8 may be provided for each of the flow channels 7 provided in parallel, with the common injection part 9 and the discharge part 10 for each flow channel 7. If the flow channels 7 are formed into this shape, a sample injected into one injection part 9 is divided to flow to each sensing part 8 and, if any detection target is contained in the sample, an interaction occurs there before the sample is discharged from one discharge part 10. Thus, different interactions of one sample can be sensed by each sensing part 8.

Further, as shown in FIG. 4 (c), for example, the sensing part 8 and the common injection part 9 may be provided for each of the flow channels 7 provided in parallel, with the common discharge part 10 for each flow channel 7. If the flow channels 7 are formed into this shape, different samples flow from each injection part 9 to each sensing part 8 via the flow channel 7 and, if any detection target is contained in the sample, an interaction occurs there before the samples are discharged from one discharge part. Thus, if different samples are injected into each of the injection parts 9 to cause each flow channel 7 to flow the samples, different samples can be analyzed by each flow channel 7 and, even if the same sample is injected into each of the injection parts 9 to cause each flow channel 7 to flow the sample, different interactions can be detected by each sensing part 8 if different specific substances are immobilized on each sensing part 8.

As shown in FIG. 4 (d), for example, a plurality of sensing parts 8 may be provided in the broadly formed flow channel 7 with partitions 11 between sensing parts 8 provided so that mixing that could inhibit detection should not occur between sensing parts 8. If the flow channel 7 is formed into this shape, a sample injected into one injection part 9 is divided by the partitions 11 set up in the flow channel 7 to flow to each sensing part 8 and, if any detection target is contained in the sample, an interaction occurs there before the sample is discharged from one discharge part 10. Thus, different interactions of one sample can be sensed by each sensing part 8 and an accurate analysis can be performed by inhibiting mixing between sensing parts 8.

Further, as shown in FIG. 4 (e), for example, two or more injection parts 9 may be provided to each flow channel 7 in the shape shown in FIG. 4 (c). If the flow channels 7 are formed into this shape, while a sample injected into one injection part 9 among corresponding injection parts 9 flows between the injection part 9 of the flow channel 7 and the sensing part 8, fluids (usually reagents used for detection) injected from other injection parts 9 are mixed and a mixed sample flows to the sensing part 8, and if any detection target is contained in the sample, an interaction occurs there before the sample is discharged from one discharge part 10. Thus, in addition to the advantages obtained by the flow channel shown in FIG. 4 (c), sample analysis can be performed more efficiently and easily because reagents can be mixed using the flow in the flow channel 7.

Examples of forming the flow channels 7 in parallel have been shown here, but the flow channel 7 may also be formed in series. As shown in FIG. 4 (f), for example, the sensing parts 8 may be provided along the flow of the flow channel 7.

Any material may be used for members (frames and so on) forming these flow channels and any kind of material including organic materials such as resins and inorganic materials such as ceramics, glass, and metals may be used. However, it is usually preferable to insulate each sensing part 8 from other sensing parts 8. Further, if interactions between detection targets and specific substances should be detected using the above-mentioned transistor and also optically measured using fluorescence, light emission, coloring, phosphorescence and the like, an optical observation part (a part that makes an optical observation) of the reaction field cell unit is preferably formed of a member through which a light of the observation wavelengths can transmit. If, for example, visible light should be observed, the optical observation part is preferably formed of a transparent member. Concrete examples of the transparent member include resins such as acrylic resin, polycarbonate, polystyrene, polydimethylsiloxane, and polyolefine, and glasses such as Pyrex (registered trademark; borosilicate glass) and quartz glass. However, if measurement can be made by dismantling the reaction field cell unit, transparency is not needed.

Any production method of the flow channel may be used and a formation method of crevices and slit-shaped grooves, for example, can be selected from machining, transfer technique exemplified by injection molding and compression molding, dry etching (RIE, IE, IBE, plasma etching, laser etching, laser abrasion, blasting, electric discharge machining, LIGA, electron beam etching, and FAB), wet etching (chemical erosion), integral molding such as optical lithography and ceramic covering, Surface Micro-machining in which a microstructure is formed by partial removal after layered coating, vapor deposition, sputtering, deposition of various materials, a formation method in which a flow channel material is instilled by an inkjet or dispenser (that is, crevices and a flow direction intermediate part are integrally formed as crevices and then the flow channel material is instilled onto the intermediate part along the flow direction to form a partition), optical lithography, printing such as screen printing and inkjet, and coating as appropriate for use.

[IV. Detection Targets, Specific Substances and Interactions]

(1. Detection Targets and Specific Substances)

A detection target is a substance to be detected by the sensor unit in the present embodiment. No restriction is imposed on the detection target and any substance may be selected as a detection target. A Substance that is not pure may also be used as detection target.

Any specific substance, which is necessary for detection of detection target, may be used if the specific substance can selectively interact with the detection target.

Concrete examples of the detection targets and specific substances include proteins (such as enzyme, antigen/antibody, and lectin), peptides, lipid, hormones (nitrogen-containing hormones composed of amines, amino acid derivatives, peptides, proteins and the like, and steroid hormones), nucleic acids, saccharide, oligosaccharide, sugar chains of polysaccharide and the like, pigments, low molecular compounds, organic substances, inorganic substances, pH, ions (Na⁺, K⁺, Cl⁻ and so on), or united substances thereof, or molecules constituting a virus or cell, or blood cell.

These detection targets are detected as components contained in almost all fluid samples including blood (whole blood, plasma, and serum), lymph, saliva, urine, stool, sweat, mucus, tears, cerebrospinal fluid, nasal secretion, cervical or vaginal secretion, semen, pleural fluid, amniotic fluid, ascites, tympanic fluid, joint fluid, gastric aspirate, and bio fluids such as extracts and fragmentation fluid of tissues, cells and the like.

A full length protein or partial peptides containing avidity sites may be used as a protein. Proteins whose amino acid sequence and functions thereof are known and that whose amino acid sequence and functions thereof are unknown may be used. Synthesized peptide chains, proteins purified from a living body, or proteins obtained by purification after translating a cDNA library or the like using an appropriate translation system may be used as target molecules. Glycopeptides obtained by binding synthesized peptide chains and sugar chains may also be used. Among these proteins, preferably purified proteins whose amino acid sequence is known or those obtained by appropriate methods of translation and purification from a cDNA library or the like can be used.

Any lipid may be used. For example, lipid, complexes of proteins and lipid, and those of saccharide and lipid may be used, and concrete examples include total cholesterol, LDL-cholesterol, HDL-cholesterol, lipoproteins, apolipoproteins, and triglycerides.

Any nucleic acid may be used, and DNA or RNA may be used. Nucleic acids whose base sequence or functions are known and those whose base sequence or functions are unknown may be used. Preferably, nucleic acids whose function of binding capacity to proteins as a nucleic acid and base sequence are known or those obtained by cutting and isolating from a genome library or the like using a restriction enzyme can be used.

Further, sugar chains whose sugar sequence or functions are known and those whose sugar sequence or functions are unknown may be used. Preferably, sugar chains already isolated and analyzed whose sugar sequence or functions are known are used.

Any low molecular compound capable of interactions may be used. Those low molecular compounds whose function is unknown, but whose capabilities of binding to or reacting with proteins are known can be used.

(2. Interaction)

As described above, many kinds of specific substances can be immobilized on the sensing part and, by using the sensing part on which a specific substance is immobilized, a sensor unit in the present embodiment can suitably be used, for example, as a bio sensor capable of detecting substances (detection targets) that interact with the specific substance. At this point, there is no restriction on interactions occurring between the detection target and specific substance and examples include, in addition to reactions occurring between the detection targets and specific substance, changes of an external environment such as pH, ions, temperature, pressure, permittivity, resistance, and viscosity. These are perceptible, for example, as a response in which a specific substance such as a functional material immobilized on the sensing part is involved or a response of the gate itself on which no functional material is immobilized. By using these changes, for example, blood coagulation ability measurement and blood cell count measurement can be made.

Also, detection targets can be labeled by a substance (marker substance) that further interacts with a substance that has interacted with a specific substance in order to amplify or identify a detected signal (change of the characteristic of the transistor part caused by an interaction). Examples of the marker include enzymes (for example, enzymes that generate and/or consume electrically active species such as H₂O₂), substances having an electrochemical reaction or luminous reaction, enzymes that can generate and/or consume these substances, and polymers or particles having charges. A single marker may be used alone or in any combination of two or more arbitrary markers with any percentage each. The method of marking detection targets is a method widely used as a labeling measuring method in a field of immunoassay and DNA analysis using, for example, intercalator (reference: Kazuhiro Imai, Bioluminescence and chemiluminescence, 1989, Hirokawa Shoten; P. TIJSSEN, Enzyme immunoassay Laboratory Techniques in biochemistry procedure 11, Tokyo Kagaku Dozin; Takenaka, Anal. Biochem., 218, 436 (1994) and many others).

As already described, an “interaction” between a specific substance and detection targets is not specifically restricted and usually indicates an action by a force working between molecules resulting from at least one of the covalent bond, hydrophobic bond, hydrogen bond, van der Waals bond, and bond by electrostatic force. However, the term “interaction” in the present specification should be interpreted more broadly and must not be interpreted restrictively in any sense. The covalent bond includes the coordinate bond and dipole bond. The bond by electrostatic force includes, in addition to the electrostatic bond, an electric repulsion. The interaction also includes binding reactions, synthetic reactions, and decomposition reactions as a result of the above-mentioned actions.

Concrete examples of the interaction include binding and dissociation between antigen and antibody, binding and dissociation between protein receptor and ligand, binding and dissociation between an adhesion molecule and counter part molecule, binding and dissociation between an enzyme and substrate, binding and dissociation between an apoenzyme and coenzyme, binding and dissociation between a nucleic acid and a protein bound to the nucleic acid, binding and dissociation between nucleic acids, binding and dissociation between proteins in an information transmission system, binding and dissociation between a glycoprotein and protein, binding and dissociation between a sugar chain and protein, binding and dissociation between cells and body tissues, and protein, binding and dissociation between cells and body tissues, and low molecular compound, and interactions between ions and ion-sensitive material, but the interaction is not limited to the above-mentioned scope. For example, immunoglobulin and derivatives thereof, F(ab′)₂, Fab′, and Fab; receptors and enzymes and derivatives thereof; nucleic acids, natural or artificial peptides, artificial polymers, saccharide, lipid, inorganic substances, organic ligands, viruses, cells, and drugs can be mentioned.

Also, as the “interaction” between a specific substance immobilized on the sensing gate for detection and other substances, in addition to substances, a response in which a functional material immobilized on the gate is involved and a response of the gate itself on which no functional material is immobilized to changes of an external environment such as pH, ions, temperature, pressure, permittivity, resistance, and viscosity can be mentioned, and concrete examples thereof include, as described above, blood coagulation ability measurement and blood cell count measurement.

(3. Immobilization Method of a Specific Substance on the Sensing Part)

Any immobilization method that can immobilize a specific substance on the sensing part can be used. The sensing part can be caused, for example, to directly bind a specific substance by physical adsorption, but may cause the sensing part to bind the specific substance via a flexible spacer having an anchor part on the sensing part in advance.

If metal such as gold is used in the sensing part, the flexible spacer desirably contains alkylene with a structural formula (CH₂)ₙ (n denotes a natural number between 1 and 30, desirably between 2 and 30, and more desirably between 2 and 15). One end of the spacer molecule uses a thiol group or disulfide group as an anchor part appropriate for adsorption to metal such as gold and the other end, which is directed in the opposite direction of the sensing gate for detection of the spacer molecule, contains one or a plurality of binding parts that can bind a specific substance to be immobilized. As such a binding part, reactive functional groups such as the amino group, carboxyl group, hydroxyl group, and succimide group, biotin and biotin derivatives, digoxin, digoxigenin, fluorescein and derivatives thereof, hapten such as theophylline, and chelate may be used.

Also, a conductive polymer, a hydrophilic polymer, an LB membrane, a matrix or the like may be caused to bind to the sensing part directly or via the spacer to cause the conductive polymer, hydrophilic polymer, LB membrane, matrix or the like to bind or contain/hold one or a plurality of specific substances to be immobilized. Further, the conductive polymer, hydrophilic polymer, or matrix may be caused to bind to the sensing part after causing the conductive polymer, hydrophilic polymer, or matrix to bind or contain/hold one or a plurality of specific substances to be immobilized in advance.

In this case, polypyrrole, polythiophene, polyaniline or the like is used as a conductive polymer, and as a hydrophilic polymer, polymers without charges such as dextran and polyethylene oxide, or polymers with charges such as polyacrylic acid and carboxymethyl dextran may be used. Particularly if a polymer with charges is used, by using a polymer with charges opposite to those of a substance to be immobilized, a charge concentration effect can be used to cause the polymer to bind or hold the specific substance (refer to Japanese Patent No. 2814639).

Particularly when a specific ion is to be detected, an ion-sensitive membrane corresponding to the specific ion can be caused to form on the sensing part. Further, by causing to form an enzyme immobilized membrane instead of the ion-sensitive membrane or together with the ion-sensitive membrane, detection targets can also be detected by sensing generation of any product generated as a result of action of an enzyme on the detection targets as a catalyst.

Further, when enzyme activity is to be measured, enzyme activity can also be measured by capturing an enzyme by a membrane surface on which an anti-enzyme antibody is immobilized, mixing an enzyme reaction fluid containing a substrate corresponding to the enzyme, and detecting a generated enzyme reaction product by the same method described above (refer to Japanese Patent Application Laid-Open No. 2001-299386).

Also, after immobilizing a specific substance to be immobilized, the following operations may be performed: surface treatment by bovine serum albumin, polyethylene oxide, or any other inactive molecules, covering an immobilized layer of the specific substance with a coating layer in order to inhibit nonspecific reaction and select or control of substances that can be penetrated.

Further, if a thin insulation layer is used as the sensing part and ions such as H⁺ and Na⁺ should be measured, an ion-sensitive membrane corresponding to the ions to be measured can also be caused to form on the insulation layer respectively, if necessary. Further, by causing to form an enzyme immobilized membrane instead of the ion-sensitive membrane or together with the ion-sensitive membrane, detection targets can also be detected by measuring any product generated as a result of action of an enzyme on the detection targets as a catalyst (reference: Shuichi Suzuki, Biosensor Kodansha (1984); Karube et al., Development and practical use of sensors, Vol. 30, No. 1, Bessatsu Kagaku Kogyo, 1986).

(4. Concrete Detection Examples)

Some concrete examples of the detection methods of detection targets using the sensor unit in the present embodiment will be described below.

Using the sensor unit in the present embodiment, for example, an antigen such as a protein can be detected as a detection target. In this case, for example, a change in electric signals can be measured by causing an antigen-antibody reaction to occur in the sensing part on which an antibody corresponding to the antigen is immobilized. Also, the concentration of the antigen is measured by, after causing an antigen-antibody reaction to occur on the surface of the sensing part on which an antibody corresponding to the antigen is immobilized, detecting electrically active species such as H₂O₂ generated and/or consumed when the antigen specific antibody (second labeled antibody) appropriately labeled by an enzyme or the like is introduced and lastly the substrate corresponding to the second labeled antibody is introduced as detection targets. At this point, common sundries and excessive components not involved in reactions in each reaction process may be removed by washing. Further, an electron transfer substance (mediator) may be present to mediate electron transfer between enzyme reaction and an electrode, and analytical methods such as the sandwich method, competitive method, and inhibitive method widely known in the immunological analytical methods using an antigen-antibody reaction may be used.

The above examples are applied, in addition to interactions between antigens and antibodies, also to various kinds of interactions between biomolecules. Such interactions exist between a large number of complementary ligands/ligand receptors such as the antigen/antibody, biotin/avidin, immunoglobulin G/protein A, enzyme/enzyme receptor, hormone/hormone receptor, DNA (or RNA)/complementary polynucleotide sequence, and drug/drug receptor. Thus, analysis can be performed by using one component in the complexes described above as a measurement target and the other as a specific substance immobilized on the sensing part. Further, for the DNA (or RNA)/complementary polynucleotide sequence, an intercalator can be used if necessary.

Also, by using the sensor unit in the present embodiment, for example, blood electrolytes can be detected as a detection targets. In this case, the liquid membrane ion-selective electrode method is usually adopted.

Further, by using the sensor unit in the present embodiment, for example, pH measurement can be made. In the pH measurement, hydrogen ion is detected as a detection target and pH is measured based on the hydrogen ion. The hydrogen ion-selective electrode method is usually adopted.

Also, by using the sensor unit in the present embodiment, for example, dissolved gases such as blood gases can be detected as detection targets. The electrode method can be used for this measurement. Further, known electrodes can be widely adopted such as the Clark electrode for detection of PO₂ as blood gases and the Severinghaus electrode for detection of PCO₂ as blood gases. When PO₂ is to be detected as blood gases, zirconia is usually used as an insulation layer.

Further, by using the sensor unit in the present embodiment, for example, substrates (for example, blood glucose) measurement as a biochemical item measurement using a chemical reaction such as an enzyme reaction can also be made. When glucose is used as a substrate to measure the glucose concentration, the GOD enzyme electrode method can usually be adopted. That is, a reaction “glucose+O₂+H₂O→+H₂O₂+gluconic acid” is caused to occur on the surface of the sensing part on which GOD is immobilized and then H₂O₂, which is a generated electrically active species, or the like is detected as a detection target to measure the glucose concentration. Urease/blood urea nitrogen (BUN), uricase/uric acid, cholesterol oxidase/cholesterol, and bilirubin oxidase/bilirubin are well-known as relationships of the enzyme/substrate to generate or consume the electrically active species (reference: Nippon Rinsho Vol. 53, Suppl 1995, Comprehensive Manual for Biochemical and Immunological Aspects of Clinical Pathology).

Also, by using the sensor unit in the present embodiment, for example, enzyme measurement as a biochemical item measurement can also be made. If, for example, the concentration of ALT (alanine aminotransferase, also called GPT (glutamic-pyruvic transaminase)), which is a type of enzyme is measured, the method described in Japanese Patent Application Laid-Open No. 2001-299386 is used to capture the enzyme by the sensing part on which an anti-ALT antibody and pyruvate oxidase as specific substances are immobilized, to cause reactions
α-ketoglutaric acid+alanine→glutamic acid+pyruvic acid (enzyme: ALT)
pyruvic acid+H₃PO₄+O₂→acetyl phosphate+acetic acid+CO₂+H₂O₂ (enzyme: pyruvate oxidase)
to occur, and detect H₂O₂, which is a generated electrically active species, or the like as a detection target to measure the concentration of ALT. The concentration of ALT may also be measured by directly detecting ALT immunologically as a detection target. Further, the above reactions may be caused to occur in a solution in advance without using any anti-ALT antibody before detecting any generated enzyme reaction product as a detection target.

If a carbon nano tube is used for the channel in the sensor unit in the present embodiment, extremely sensitive detection can be realized. Thus, a diagnosis can be performed at a time by functionality or disease by measuring immune items requiring high detection sensitivity and other items such as electrolytes at a time based on the same principle, realizing POCT.

[V. Examples of Analytical Apparatus]

The configuration of an example of the first sensor unit and an analytical apparatus using the first sensor unit is shown below, but the present invention is not limited to the example shown below and, as mentioned in a description of each component, the configuration may be modified arbitrarily without departing from the scope of the present invention.

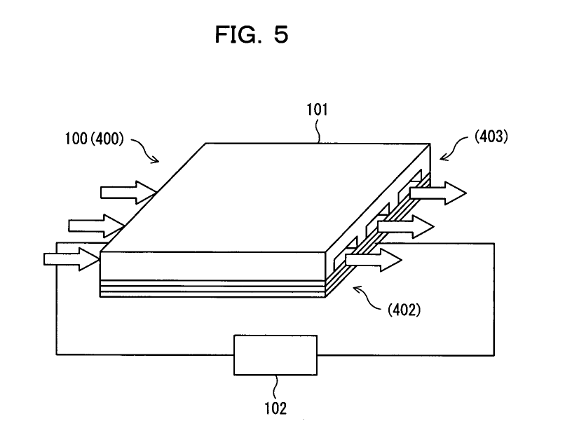

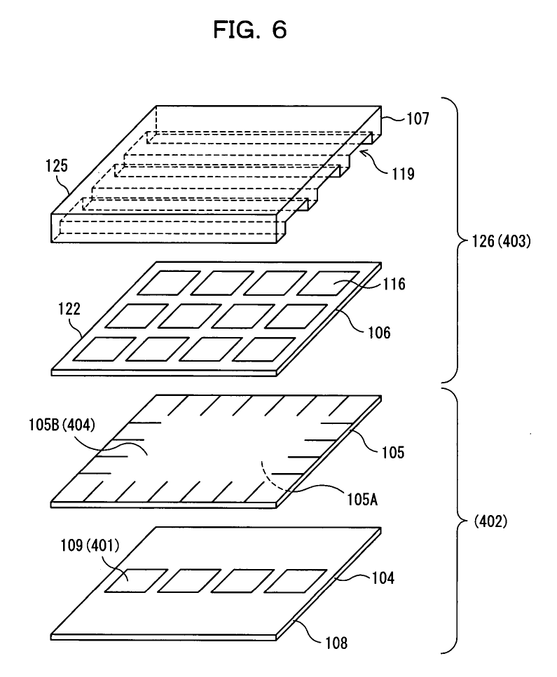

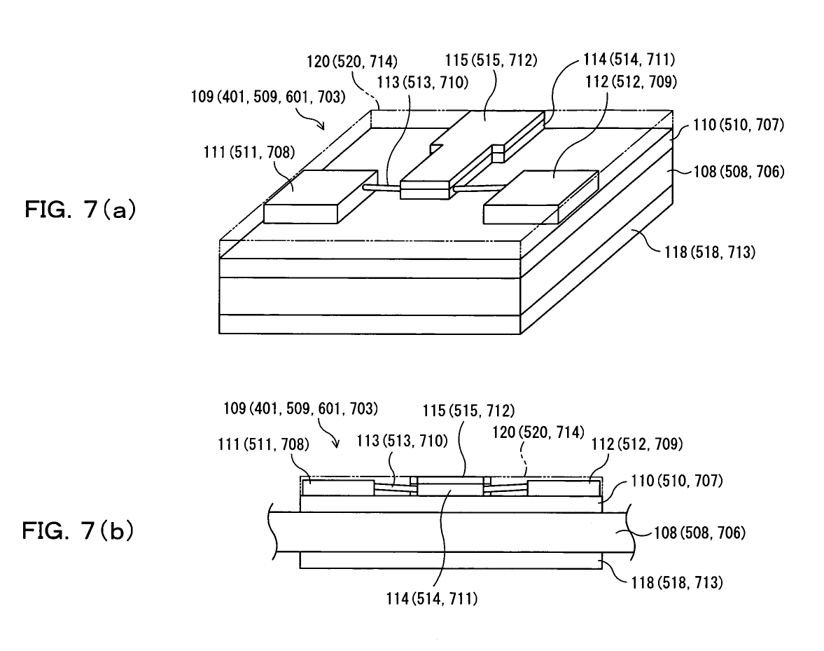

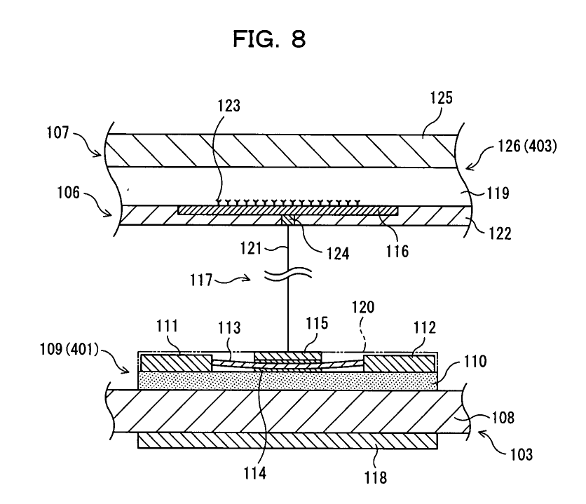

FIG. 5 is a figure schematically showing the configuration of main components of an analytical apparatus 100 using the first sensor unit and FIG. 6 is an exploded perspective view schematically showing the configuration of main components of the first sensor unit. FIG. 7 (a) and FIG. 7 (b) are figures schematically showing the configuration of main components of a detection device part 109, and FIG. 7 (a) is a perspective view thereof and FIG. 7 (b) is a side view. Further, FIG. 8 is a sectional view schematically showing an electrode section 116 and a periphery thereof after mounting a connector socket 105, a separate type integrated electrode 106, and a reaction field cell 107 in an integrated detection device 104. In FIG. 8, however, the connector socket 105 is shown only as internal wiring 121 thereof for a description. In FIGS. 5 to 8, components denoted by the same numerals represent the same components.

As shown in FIG. 5, the analytical apparatus 100 comprises a sensor unit 101 and a measuring circuit 102, and is constructed to be able to flow a sample by a pump (not shown) as shown by arrows. Here, the measuring circuit 102 is a circuit (transistor characteristic detection part) for detecting any change of the characteristic of the transistor part (See a transistor part 103 in FIG. 8) inside the sensor unit 101 and is constructed of a circuit using known electronic components including any resistor, capacitor, ammeter, voltmeter, normally available integrated circuit elements (so-called IC such as an operational amplifier), coil (inductor), photodiode, and LED (light emitting diode) in accordance with a purpose.

As shown in FIG. 6, the sensor unit 101 comprises the integrated detection device 104, connector socket 105, separate type integrated electrode 106, and reaction field cell 107. Of these components, the integrated detection device 104 is fixed to the analytical apparatus 100. The connector socket 105, separate type integrated electrode 106, and reaction field cell 107, on the other hand, are mechanically removable from the integrated detection device 104.

As shown in FIG. 6, the integrated detection device 104 is constructed by integrating a plurality (here 4 units) of similarly constructed detection device parts 109 on a substrate 108.

As shown in FIG. 7 (a) and FIG. 7 (b), the detection device part 109 integrated on the substrate 108 has a low-permittivity layer 110 formed of an insulating and low-permittivity material on the substrate 108 formed of an insulating material and thereupon, a source electrode 111 and a drain electrode 112 formed of a conductor (for example, gold). Wiring (not shown) connected to the measuring circuit 102 is connected to the source electrode 111 and the drain electrode 112 respectively and a current flowing in a channel 113 described later is measured by the measuring circuit 102 through this wiring. Further, the channel 113 formed of a carbon nano tube is bridged between the source electrode 111 and the drain electrode 112.

On the surface of the low-permittivity layer 110, a layer (insulation layer) 114 of silicon oxide, which is an insulation material of low permittivity, is formed extending from an intermediate part of the channel 113 to a back end of FIG. 7 (a) and the channel 113 passes through the insulation layer 114 crosswise. In other words, the intermediate part of the channel 113 is covered with the insulation layer 114. The channel 113 is bridged in a state in which the intermediate part thereof sags, thereby preventing damage to the channel 113 by thermal expansion when temperature changes.

Further, a sensing gate (gate body) 115 formed of a conductor (for example, gold) is formed on an upper surface of the insulation layer 114 as a top gate. That is, the sensing gate 115 is formed on the low-permittivity layer 110 via the insulation layer 114. By mounting the separate type integrated electrode 106 and reaction field cell 107 to the integrated detection device 104 via the connector socket 105, the sensing gate 115 constitutes a sensing gate for detection 117 (See FIG. 8) together with the corresponding electrode section 116 of the separate type integrated electrode 106.

On the underside of the substrate 108 (that is, a surface opposite to the channel 113), a voltage application gate 118 formed of a conductor (for example, gold) is provided as a back gate. A voltage is applied to the voltage application gate 118 via a power source (not shown) provided in the analytical apparatus 100. The voltage applied to the voltage application gate 118 is measured by the measuring circuit 102. It is also possible to have the back gate carry out other functions than the voltage application gate.

An insulator layer 120 is formed all over a surface of the low-permittivity layer 110 where not covered with the source electrode 111, the drain electrode 112, or the insulation layer 114. The insulator layer 120 is formed to cover all over a part of the channel 113 where not covered with the insulation layer 114, sides of the source electrode 111, drain electrode 112, insulation layer 114, and sensing gate 115, upper surface of the source electrode 111 and drain electrode 112, but the upper surface of the sensing gate 115 is not covered. Then, the upper surface of the sensing gate 115 that is not covered with the insulator layer 120 is connected to the electrode section 116 of the separate type integrated electrode 106 via the socket connector 105. In FIG. 7 (a) and FIG. 7 (b), the insulator layer 120 is denoted by chain double-dashed lines.

The connector socket 105 is a connector located between the integrated detection device 104 and separate type integrated electrode 106 to connect the integrated detection device 104 and separate type integrated electrode 106. On the lower part (undersurface) of the connector socket 105, a mounting part 105A formed by fitting to the shape of the top surface of the integrated detection device 104 to mount the connector socket 105 to the integrated detection device 104 is provided. On the upper part (top surface) of the connector socket 105, a mounting part 105B formed by fitting to the shape of the undersurface of the separate type integrated electrode 106 to mount the separate type integrated electrode 106 to the connector socket 105 is provided. The separate type integrated electrode 106 is thereby mounted to the integrated detection device 104 via the connector socket 105. As described above, the connector socket 105 itself is removable from the integrated detection device 104.

Wiring (see the wiring 121 in FIG. 8) composed of a conductor is provided inside the connector socket 105 so that, when assembling the sensor unit 101, the sensing gate 115 in the detection device part 109 of the integrated detection device 104 and the electrode section 116 of the separate type integrated electrode 106 can be brought into electric conduction. More specifically, the first, second, third, and fourth detection device parts 109 from the left in the figure of the integrated detection device 104 and the first, second, third, and fourth columns of separate type integrated electrode 106 from the left, each column containing three electrode sections 116, correspond respectively and the sensing gate 115 of the corresponding detection device part 109 and the electrode section 116 can be brought into electric conduction through the wiring inside the connector socket 105. Therefore, the connector socket 105 functions as a conductive member.

Further, the connector socket 105 has internally a switch (not shown) for switching the wiring and, by changing the switch, a selection can be made with which of the corresponding electrode sections 116 the sensing gate 115 of the detection device part 109 should be brought into electric conduction. Therefore, the connector socket 105 functions as an electric connection switching part.

The separate type integrated electrode 106 is provided by arranging a plurality of electrode sections (sensing parts) 116 in an array on a substrate 122 formed of an insulator. In the sensor unit 101 of the present example, it is assumed that a total of 12 electrode sections 116, in four columns with three electrode sections 116 in each column, are formed.

As shown in FIG. 8, the electrode section (sensing part) 116 is formed on the surface of the substrate 122 by a conductor. The electrode section 116 can be formed, for example, by using the laminated printed board technique.

A specific substance 123 is immobilized on the surface of the electrode section 116. Though the specific substance 123 is depicted visually large in FIG. 8 for a description, the specific substance 123 is usually minuscule and a specific shape thereof is in most cases not visually recognizable.

Further, a through hole is formed on the back side of the electrode section 116 of the substrate 122 and wiring 124 is formed by filling the through hole with a conductive paste material. Thus, when the separate type integrated electrode 106 is mounted to the integrated detection device 104 via the connector socket 105, the electrode section 116 can be brought into electric conduction with the sensing gate 115 of the corresponding detection device part 109 through the wiring 124 and the wiring 121 of the connector socket 105. The sensing gate for detection 117 is constructed of the sensing gate (gate body) 115 and the electrode section (sensing part) 116.

A package is preferably produced on the underside of the separate type integrated electrode 106 so that the separate type integrated electrode 106 can be simply mounted to the mounting part 105B on the upper part of the connector socket 105. More specifically, a package is preferably produced by patterning the wiring 124, forming bumps, and then bonding them to the substrate 122 using TAB (Tape Automated Bonding) or flip chip bonding so that the separate type integrated electrode 106 can be connected to the connector socket 105 below. The separate type integrated electrode 106 is removable from the connector socket 105, but a fixing means for mounting is arbitrary and, for example, a connector in a general IC package can be used. However, when a sample flows in a flow channel 119, measures should be taken to retain the sample within the flow channel 119 so that the sample should not penetrate into a space between the separate type integrated electrode 106 and connector socket 105.

The reaction field cell 107 is constructed by forming the flow channel 119 fitting to the electrode section 116 on a base 125. More specifically, the flow channel 119 is formed in such a way that a sample flowing in the flow channel 119 can come into contact with each electrode section 116. The flow channel 119 is provided in such a way that the flow channel 119 passes one of three electrode sections 116 corresponding to each detection device part 109 each from left to right in the figure.

The reaction field cell 107 is formed integrally with the separate type integrated electrode 106 to constitute a reaction field cell unit 126. Thus, there action field cell unit 126 is mounted to the integrated detection device 104 via the connector socket 105 to use the analytical apparatus 100. The reaction field cell unit 126 is usually assumed to be used up (disposable). The reaction field cell 107 may also be formed separately from the separate type integrated electrode 106.

The analytical apparatus 100 and the sensor unit 101 in the present example are constructed as described above. Thus, to use the analytical apparatus 100, first the connector socket 105 and the reaction field cell unit 126 (that is, the separate type integrated electrode 106 and the reaction field cell 107) are mounted to the integrated detection device 104 to prepare the sensor unit 101. Then, an appropriate voltage is applied to the voltage application gate 118 so that the transfer characteristic of the transistor part 103 (that is, the substrate 108, low-permittivity layer 110, source electrode 111, drain electrode 112, channel 113, insulation layer 114, sensing gate for detection 117, and voltage application gate 118) can be maximized to feed a current through the channel 113. In this state, a sample is caused to flow in the flow channel 119 while measuring characteristic of the transistor part 103 using the measuring circuit 102.

The sample flows in the flow channel 119 and comes into contact with the electrode section 116. If, at this point, the sample contains any detection target that interacts with a specific substance immobilized on the electrode section 116, an interaction occurs. The interaction is detected as the change of the characteristic of the transistor part 103. That is, a change in surface charges of the electrode section 116 occurs due to the interaction and this change is transmitted as an electric signal from the electrode section 116 to the sensing gate 115 via the wiring 124 and 121. The gate voltage changes due to the electric signal in the sensing gate 115 and thus characteristic of the transistor part 103 changes.

Therefore, the detection target can be detected by measuring the change of the characteristic of the transistor part 103 using the measuring circuit 102. Particularly, since a carbon nano tube is used for the channel 113 in the present example, detection with extremely high sensitivity becomes possible and thus detection targets that have conventionally been difficult to be detected can now be detected. Therefore, the analytical apparatus in the present example can be used for analysis of a wider range of detection targets than that of a conventional analytical apparatus.

A top gate is used in the present example as the sensing gate 115 and thus the distance between the sensing gate 115 and channel 113 can be made very small, enabling extremely sensitive detection.

Further, the low-permittivity insulation layer 114 is formed between the channel 113 and sensing gate 115, thereby transmitting a change in surface charges due to an interaction in the sensing gate 115 to the channel 113 more efficiently to further improve detection sensitivity.

Since the channel 113 is covered with the insulator layer 120, it is possible to prevent charged particles inside the channel 113 from leaking out of the channel 113 and those charged particles outside the channel 113 excluding the source electrode 111 and drain electrode 112 from penetrating into the channel 113, thereby enabling detection of interactions between a specific substance and a detection target with stability.

Further, with integration of the transistor part 103, advantages of miniaturization of the sensor unit 101, speedy detection, simplification of operations and so on can be obtained.

Also, since detection tests using a flow can be performed with the use of the flow channel 119, advantages of simpler operations can be obtained.

By immobilizing different specific substances on each of a plurality of electrode sections 116 or flowing different types of samples in each of the flow channels 119, two or more detection targets can be detected in one measurement (that is, two or more interactions are detected) so that sample analysis can be performed more easily and swiftly. Particularly with integration of the electrode section 116, interactions that occur at the same time can be detected in one measurement to analyze various items on the sample. Conversely, if the same specific substance 123 is immobilized on each electrode section 116, a lot of data can be obtained in one measurement to produce more analysis results of the sample so that reliability of results can be improved.

Further, since the connector socket 105, which acts as an electric connection switching part, is constructed to be capable of selecting which of the corresponding electrode sections 116 to be brought into electric conduction with the sensing gate 115 of the detection device part 109, interactions in two more electrode sections 116 can be detected using one detection device part 109. Thus, it becomes possible to detect a detection target by fewer sensing gates 115 using more electrode sections 116, leading to miniaturization of the sensor unit 101 and the analytical apparatus 100.

By using the analytical apparatus 100 using the sensor unit 101 as in the present example, real-time measurement becomes possible and monitoring of an interaction between substances also becomes possible.

Further, since the sensing gate for detection 117 is separated into a plurality of members of the sensing gate 115 and the electrode section 116, the reaction field cell above the electrode section (sensing part) 116 can be used as a disposable type like flow cells, thereby enabling miniaturization of the sensor unit 101 and the analytical apparatus 100 to improve usability for users.

Also, the electrode section 116 is constructed to be mechanically removable, the electrode section 116 can be constructed to be disengageable and replaceable. Thus, the sensor unit 101 and the analytical apparatus 100 can be made to be available at reasonable prices and further expendable, and samples can be prevented from being biologically contaminated.

However, the analytical apparatus 100 and the sensor unit 101 exemplified here are only an example of the sensor unit in the first embodiment and the above configuration can be arbitrarily modified without departing from the scope of the present invention. Each component of the sensor unit in the present embodiment can be modified as described above, but among others, modifications can be made as described below.

It is preferable, for example, to determine the shape of the connector socket 105 in accordance with the shapes and dimensions of the integrated detection device 104 and the separate type integrated electrode 106. An area of a part like the integrated detection device 104 having the detection device part 109 is usually easier to be miniaturized than that like the separate type integrated electrode 106 having a sensing part. Thus, a difference in size arises between the two and providing a transit connection terminal block like the connector socket 105 between them has a significant meaning. The significance includes promises of lower yields and lower costs of devices by increasing and relaxation of dimensional constraints and placement constraints of the sensing part to allow free designs by increasing integration degree of the detection device part 109 as integration degree of the transistor part 103.

When, for example, integrating a plurality of transistor parts 103, as described above, one transistor part 103 may be used to detect interactions of one detection target or a plurality of transistor parts 103 may be used to detect interactions of one detection target by using an array of the plurality of transistor parts 103, electrically connecting the source electrode 111 and the drain electrode 112 in parallel, and detecting the interaction of the same detection target in each sensing gate for detection 117.

Further, the voltage application gate 118 is provided in the sensor unit 101 in the present example, for example, the gate voltage may be applied to the channel 113 by other means. For example, the voltage may be applied to the sensing gate 115 from an electrode (reference electrode) provided outside the detection device part 109. Also, the voltage of the sensing gate 115 itself may be controlled from outside without providing the voltage application gate 118. Further, how to apply the voltage to the sensing gate 115 is arbitrary, and the voltage may be applied via a fluid (including a buffer solution and the like) such as a sample inside the flow channel 119 of the reaction field cell 107 or the voltage may be directly applied from a part that is not in contact with a fluid such as a sample. Also, the sensing gate 115 may be floating or the electric potential of the sensing gate 115 may be kept constant. Further, if the sensing gate 115 is floating, the sensing gate 115 may be enclosed with a ground electrode. An influence from outside electric fields and mutual influence between a plurality of sensing gates 115 can thereby be expected to be reduced. For example, if the source electrode 111 is grounded, it is better to enclose the sensing gate 115 with the source electrode 111. Naturally, the same applies to the case when the drain electrode 112 is grounded.

If, for example, a reaction that occurs slowly on the order of several minutes to several tens of minutes like an antigen-antibody reaction is detected as an interaction, a current flowing between the source electrode 111 and the drain electrode 112 may be passed through a low-pass filter after amplifying the current by an amplifier. Thereby, signal quality cab be expected to improve remarkably.

### Second Embodiment

A sensor unit according to a second embodiment of the present invention (hereinafter called “second sensor unit” as appropriate) comprises a transistor part having a substrate, a source electrode and a drain electrode provided on the substrate, a channel forming a current path between the source electrode and the drain electrode, and a sensing gate for detection on which a sensing site (interaction sensing site) on which a specific substance capable of selectively interacting with a detection target is immobilized is formed and is a sensor unit for detecting the detection target. In the second sensor unit, two or more transistor parts are integrated.

Like the first sensor unit, the transistor part in the second sensor unit is also a part functioning as a transistor and, by detecting a change in output characteristic of the transistor, the sensor unit in the present embodiment detects the detection target. The transistor part can be distinguished between a transistor part functioning as a field-effect transistor and that functioning as a single-electron transistor based on a concrete configuration of a channel thereof, and either type of the transistors may be used in the second sensor unit. In descriptions that follow, the transistor part is simply called “transistor” as appropriate and, in that case, whether the transistor functions as a field-effect transistor or a single-electron transistor is not distinguished if not specifically mentioned.

[I. Transistor Part]

(1. Substrate)

The substrate in the second sensor unit is the same as that described in the first embodiment.

(2. Source Electrode/Drain Electrode)

The source electrode and drain electrode in the second sensor unit are the same as those described in the first embodiment.

(3. Channel)

The channel in the second sensor unit is the same as that described in the first embodiment. Thus, a channel having the same configuration as that described in the first embodiment can be used and also the same production method as that described in the first embodiment can be used.

(4. Sensing Gate for Detection)

In the second sensor unit, a sensing site (interaction sensing site) on which a specific substance capable of selectively interacting with a detection target is immobilized is formed on the sensing gate for detection. The sensing site is a site where a specific substance on the surface of the sensing gate for detection is immobilized.

When an interaction between a specific substance and a detection target occurs at a sensing site of the sensing gate for detection in the second sensor unit, the electric potential of the sensing gate for detection changes and, by detecting the change of the characteristic of the transistor caused by the gate voltage of the sensing gate for detection, the detection target can be detected.

The sensing gate for detection in the second sensor unit can be constructed like the first sensor unit. In this case, a site on the surface of the sensing part where a specific substance is immobilized becomes a sensing site.

Also, the second sensor unit may be constructed like the sensing gate of the first sensor unit to immobilize a specific substance on the surface of the sensing gate thereof. In this case, a site on the surface of the sensing gate where a specific substance is immobilized becomes a sensing site.

(5. Voltage Application Gate)

Like the first sensor unit, the transistor part in the second sensor unit may have a voltage application gate. The voltage application gate provided in the transistor part of the second sensor unit is the same as that provided in the transistor part of the first sensor unit.

(6. Integration)

In the second sensor unit, the transistor part is integrated. That is, two or more source electrodes, drain electrodes, channels, sensing gates for detection, and as appropriate, voltage application gates are provided on a single substrate, and further, it is preferable to miniaturize them as much as possible. Component members of each transistor may be provided in such a way that they are shared by other transistors as appropriate and, for example, the sensing part of the sensing gate for detection and the voltage application gate may be shared by two or more of integrated transistors. Further, one type of transistors may be integrated, or two or more types of transistors may be integrated in any kinds of combination with any percentage each.

By integrating transistors as described above, various kinds of detection targets can be detected by one sensor unit, increasing convenience when performing an analysis as compared with conventional sensor units. Also, at least one of advantages of miniaturization and lower costs of the sensor unit, speedy detection and improvement of detection sensitivity, simplification of operations and so on can be obtained. That is, since many sensing gates for detection can be provided at a time due to integration, for example, a multifunctional sensor unit that can detect many detection targets by one sensor unit can be provided at lower costs. Also, if integration is performed in such a way that many source electrodes and drain electrodes are connected in parallel, for example, detection sensitivity can be enhanced. Further, since the need for separately providing electrodes for comparison to be used for examination of analysis results and the like can be eliminated, for example, it becomes possible to compare results of a transistor with those of another transistor on the same sensor unit.

When integrating transistors, any arrangement of transistors and any kind of specific substance to be immobilized thereon can be used. For example, one transistor may be used to detect one detection target or a plurality of transistors may be used to detect one detection target by electrically connecting the source electrodes and drain electrodes in parallel using an array of the plurality of transistors and detecting the same detection target by each sensing gate for detection.

There is no restriction on the concrete method of integration and any known method may be used, but usually a production method generally used for producing integrated circuits can be used. Recently, a method for incorporating mechanical elements into metals (conductors) and semiconductors called MEMS has been developed and the technique can also be used.

Further, when transistors are integrated, any wiring method may be used and it is usually preferable to devise arrangements and the like to reduce the influence of parasitic capacitance and parasitic resistance as much as possible. More specifically, it is preferable to use, for example, the air bridge technique or wire bonding technique to connect source electrodes and/or drain electrodes or to connect the sensing gates and sensing parts.

[II. Electric Connection Switching Part]

If the sensing gate for detection of the second sensor unit is constructed like that of the first sensor unit, an electric connection switching part can be provided in the second sensor unit like the first sensor unit. In this case, the electric connection switching part provided in the second sensor unit is the same as that described in the first embodiment.

[III. Reaction Field Cell]

The second sensor unit may have a reaction field cell. The reaction field cell is a member that brings a sample into contact with a sensing site. The sample is a target to be detected using a sensor unit and, if any detection target is contained in the sample, the detection target and a specific substance interact.

Any concrete configuration allowing a reaction field cell to bring a sample into contact with the sensing site and, if the sample contains any detection target, to cause the above-mentioned interaction can be used. The reaction field cell can be constructed, for example, as a container holding a sample so as to keep the sample in contact with the sensing site. If the sample is fluid, however, it is desirable to construct the reaction field cell as a member having a flow channel to cause the fluid to flow in such a way that the sample comes into contact with the sensing site. By detecting an interaction by causing a sample to flow, advantages of speedy detection, simplification of operations and so on can be obtained.

If the reaction field cell has a flow channel, there is no restriction on its shape, dimensions, number of flow channels, material of members forming the flow channel, production method of the flow channel and so on, and usually the same flow channel as that described in the first embodiment is adopted.

[IV. Detection Targets, Specific Substances and Interactions]

A detection target, a specific substance, and an interaction in the second sensor unit are the same as those described in the first embodiment.

A method for immobilizing a specific substance for the sensing site similar to the method for immobilizing a specific substance on the sensing part described in the first embodiment can be used. However, in this case, a specific substance is assumed to be immobilized on the sensing site instead of the sensing part in the description of the immobilization method in the first embodiment.

Further, concrete detection examples similar to those in the first embodiment can be mentioned.

If a carbon nano tube is used for the channel in the sensor unit in the present embodiment, extremely sensitive detection can be realized. Thus, a diagnosis can be performed at a time by functionality or disease by measuring immune items requiring high detection sensitivity and other items such as electrolytes at a time based on the same principle, realizing POCT. In addition, operations and effects similar to those of the first embodiment can be obtained.

[V. Examples of Analytical Apparatus]

The configuration of an example of the second sensor unit and an analytical apparatus using the second sensor unit is shown below, but the present invention is not limited to the example shown below and, as mentioned in a description of each component, the configuration may be modified arbitrarily without departing from the scope of the present invention.

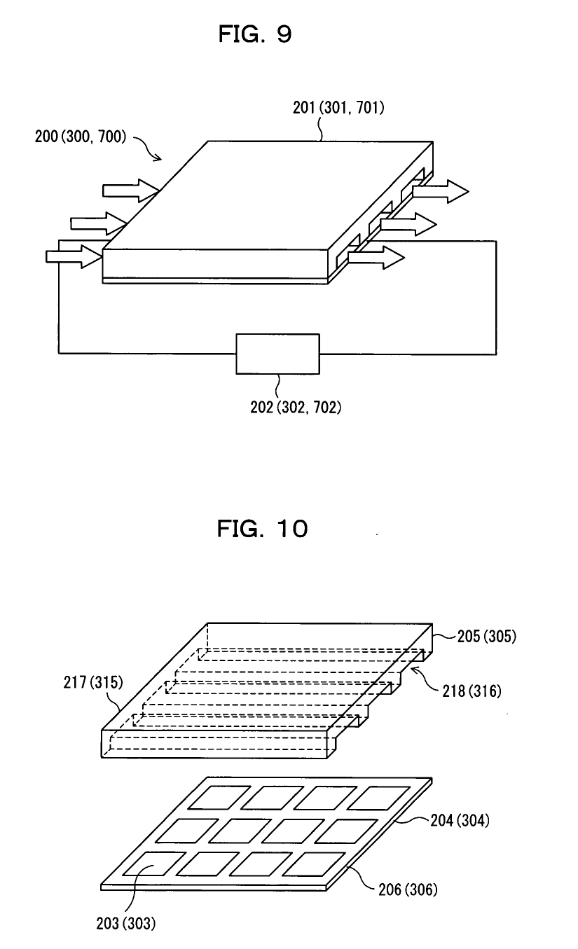

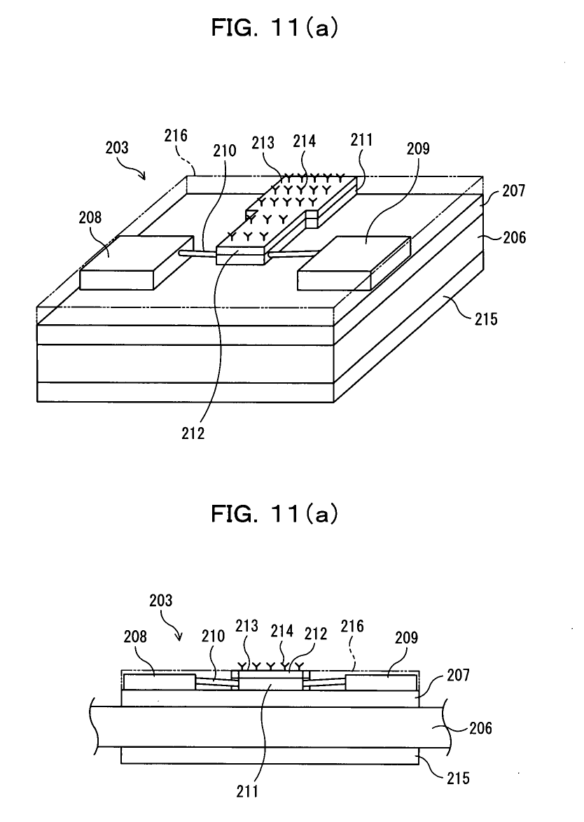

FIG. 9 is a figure schematically showing the configuration of main components of an analytical apparatus 200 using the second sensor unit and FIG. 10 is an exploded perspective view schematically showing the configuration of main components of the second sensor unit. FIG. 11 (a) and FIG. 11 (b) are figures schematically showing main components of a detection device part, and FIG. 11 (a) is a perspective view thereof and FIG. 11 (b) is a side view. In FIGS. 9 to 11 (b), components denoted by the same numerals represent the same components.

As shown in FIG. 9, the analytical apparatus 200 comprises a sensor unit 201, instead of the sensor unit 101 in the analytical apparatus 100 described in the first embodiment. That is, the analytical apparatus 200 comprises the sensor unit 201 and a measuring circuit 202, and is constructed to be able to flow a sample by a pump (not shown) as shown by arrows. Here, the measuring circuit 202 is a circuit (transistor characteristic detection part) for detecting any change of the characteristic of the transistor part (See a transistor part 203 in FIG. 10) inside the sensor unit 201 and is constructed, like the measuring circuit 102 in the first embodiment, of any resistor, capacitor, ammeter, voltmeter and the like in accordance with a purpose.

As shown in FIG. 10, the sensor unit 201 comprises an integrated detection device 204 and a reaction field cell 205. Of these components, the integrated detection device 204 is fixed to the analytical apparatus 200. The reaction field cell 205, on the other hand, is mechanically removable from the integrated detection device 204.

The integrated detection device 204 is constructed by integrating a plurality (here 4 units) of the similarly constructed transistor parts 203 in an array on a substrate 206. In the sensor unit 201 in the present example, it is assumed that a total of 12 transistor parts 203, in four columns with three transistor parts 203 in each column, are formed.

As shown in FIG. 11 (a) and FIG. 11 (b), the transistor part 203 integrated on the substrate 206 has a low-permittivity layer 207, a source electrode 208, a drain electrode 209, a channel 210, and an insulation layer 211 formed on the substrate 206 formed of insulating material. These low-permittivity layer 207, source electrode 208, drain electrode 209, channel 210, and insulation layer 211 are formed in the same manner as the low-permittivity layer 110, source electrode 111, drain electrode 112, channel 113, and insulation layer 114 described in the first embodiment respectively.

Further, a sensing gate for detection 212 formed of a conductor (for example, gold) is formed on the upper surface of the insulation layer 211 as a top gate. That is, the sensing gate for detection 212 is formed on the low-permittivity layer 207 via the insulation layer 211.

A specific substance 214 is immobilized all overt the upper surface of the sensing gate for detection 212. Thus, the surface of the sensing gate for detection 212 functions as a sensing site 213. Though the specific substance 214 is depicted visually large in FIG. 11 (a) and FIG. 11 (b) for a description, the specific substance 214 is usually minuscule and a specific shape thereof is in most cases not visually recognizable.

On the underside of the substrate 206 (that is, a surface opposite to the channel 210), a voltage application gate 215 formed of a conductor (for example, gold) is provided as a back gate. Further, an insulator layer 216 is formed on the surface of the low-permittivity layer 207. The voltage application gate 215 and the insulator layer 216 are formed in the same manner as the voltage application gate 118 and the insulation layer 120 described in the first embodiment respectively. Thus, the sensing site 213, which is a surface of the sensing gate for detection 212, is open to the outside, instead of being covered with the insulator layer 216, so that a sample can come into contact with the sensing site 213. The insulator layer 216 is denoted by chain double-dashed lines in FIG. 11 (a) and FIG. 11 (b). It is also possible to have the back gate carry out other functions than the voltage application gate.

The reaction field cell 205 is constructed by forming a flow channel 218 fitting to the transistor part 203 on a base 217. More specifically, the flow channel 218 is formed in such a way that a sample flowing in the flow channel 218 can come into contact with each transistor part 203. The flow channel 218 is provided in such a way that the flow channel 218 passes one of three transistor parts each from left to right in the figure.

The reaction field cell 205 is usually assumed to be used up (disposable). The reaction field cell 205 may be formed integrally with the integrated detection device 204.

The analytical apparatus 200 and the sensor unit 201 in the present example are constructed as described above. Thus, to use the analytical apparatus 200, first the reaction field cell 205 is mounted to the integrated detection device 204 to prepare the sensor unit 201. Then, an appropriate voltage is applied to the voltage application gate 215 so that the transfer characteristic of the transistor part 203 can be maximized to feed a current through the channel 210. In this state, a sample is caused to flow in the flow channel 218 while measuring characteristic of the transistor part 203 using the measuring circuit 202.

The sample flows in the flow channel 218 and comes into contact with the sensing site 213. If, at this point, the sample contains any detection target that interacts with the specific substance 214 immobilized on the sensing site 213, an interaction occurs. The interaction is detected as the change of the characteristic of the transistor part 203. That is, a change in surface charges on the sensing gate for detection 212 occurs due to the interaction and this change causes a change in the gate voltage, leading to the change of the characteristic of the transistor part 203.

Therefore, the detection target can be detected by measuring the change of the characteristic of the transistor part 203 using the measuring circuit 202. Particularly, since a carbon nano tube is used for the channel 210 in the present example, detection with extremely high sensitivity becomes possible and thus detection targets that have conventionally been difficult to be detected can now be detected. Therefore, the analytical apparatus in the present example can be used for analysis of a wider range of detection targets than that of a conventional analytical apparatus.

With integration of the transistor part 203, advantages of miniaturization of the sensor unit 201, speedy detection, simplification of operations and so on can be obtained.

Further, since detection tests using a flow can be performed with the use of the flow channel 218, advantages of simpler operations can also be obtained.

By immobilizing different specific substances 214 on each of a plurality of sensing gate for detection 212 formed for each of integrated transistor parts 203 or flowing different types of samples in each of the flow channels 218, two or more detection targets can be detected in one measurement (that is, two or more interactions are detected) so that sample analysis can be performed more easily and swiftly. Particularly with integration of the transistor part 203, interactions that occur at the same time can be detected in one measurement to analyze various items on the sample. Conversely, if the same specific substance 214 is immobilized on each transistor part 203, a lot of data can be obtained in one measurement to produce more analysis results of the sample so that reliability of results can be improved.

Further, operations and effects performed by the analytical apparatus 100 and the sensor unit 101 exemplified in the first embodiment can also be obtained from the analytical apparatus 200 and the sensor unit 201 in the present example except those related to the electrode separation of the sensing gate for detection 117 and the connector socket 105 being provided.

However, the analytical apparatus 200 and the sensor unit 201 exemplified here are only an example of the sensor unit in the second embodiment and the above configuration can be arbitrarily modified without departing from the scope of the present invention. Thus, the configuration can be modified like the first embodiment or as described in each component of the sensor unit in the present embodiment.

The sensor unit 101 exemplified in the first embodiment is also an example of the second sensor unit. That is, if a site on the surface of the electrode section 116 where a specific substance is immobilized is recognized as a sensing site, the sensor unit 101 exemplified in the first embodiment is an example of the second sensor unit having the integrated transistor part 103.

### Third Embodiment

A sensor unit according to a third embodiment of the present invention (hereinafter called “third sensor unit” as appropriate) comprises a transistor part having a substrate, a source electrode and a drain electrode provided on the substrate, and a channel forming a current path between the source electrode and the drain electrode, and further a sensing site (interaction sensing site) on which a specific substance capable of selectively interacting with a detection target is immobilized is formed in the channel. In the third sensor unit, two or more transistors are integrated.

Like the first and second sensor units, the transistor part in the third sensor unit is also a part functioning as a transistor and, by detecting a change in output characteristic of the transistor, the sensor unit in the present embodiment detects the detection target. The transistor part can be distinguished between a transistor part functioning as a field-effect transistor and that functioning as a single-electron transistor based on a concrete configuration of a channel thereof, and either type of the transistors may be used in the third sensor unit. In descriptions that follow, the transistor part is simply called “transistor” as appropriate and, in that case, whether the transistor functions as a field-effect transistor or a single-electron transistor is not distinguished if not specifically mentioned.

[I. Transistor Part]

(1. Substrate)

The substrate in the third sensor unit is the same as that described in the first and second embodiments.

(2. Source Electrode/Drain Electrode)

The source electrode and drain electrode in the third sensor unit are the same as those described in the first and second embodiments.

(3. Channel)

The channel in the third sensor unit is the same as that described in the first and second embodiments except that a sensing site is formed on the surface thereof.

Thus, the channel in the third sensor unit has a configuration in which a sensing site (interaction sensing site) is formed on the surface of the channel described in the first and second embodiments. Here, the sensing site is a site on the channel surface where a specific substance is immobilized.

Therefore, the channel in the present embodiment also has a function of the sensing gate for detection in the first and second embodiments.

When an interaction between a specific substance and a detection target occurs at a sensing site of the channel in the third sensor unit, the gate voltage applied to the channel changes and, by detecting the change of the characteristic of the transistor caused by the change of the gate voltage, the detection target can be detected. At this point, since a sensing site is formed on the channel surface, the influence of a charge change caused by the interaction is reflected directly on the channel, promising still higher detection sensitivity.

However, if a sensing site is formed on the channel, from the perspective of preventing a current flowing from the source electrode to the drain electrode from flowing through a sample, it is preferable that the sample can be brought into contact with only a sensing site while avoiding the channel being exposed to the sample coming into contact. There is no restriction on the concrete configuration method for the purpose and, for example, a method can be adopted in which the channel is covered with an insulator and then part of the insulator that needs to be removed is removed to connect a sensing site and the channel (that is, a specific substance is immobilized on the channel to form a sensing site). If, at this point, the size of the insulator to be removed can be made so small to a molecular level, possibilities that the channel and a sample come into contact vastly diminishes and thus those of leakage of a current to the sample can be considered to be extremely small. Any removal method of such an insulator may be used and, for example, nano processing technique using nano technology such as an atomic force microscope can be used.

The same production methods of channel as those in the first and second embodiments can be used. Thus, by forming a channel by any method described in the first and second embodiments and immobilizing a specific substance on the channel, a channel in the present embodiment having an interaction sensing site can be produced.

(4. Voltage Application Gate)

Like the first and second sensor units, the transistor part in the third sensor unit may have a voltage application gate. The voltage application gate provided in the transistor part of the third sensor unit is the same as that provided in the transistor part of the first and second sensor units.

(5. Integration)

In the third sensor unit, the transistor part is integrated. That is, two or more source electrodes, drain electrodes, channels, and as appropriate, voltage application gates are provided on a single substrate, and further, it is preferable to miniaturize them as much as possible. Component members of each transistor may be provided in such a way that they are shared by other transistors as appropriate and, for example, the voltage application gate may be shared by two or more of integrated transistors. Further, one type of transistors may be integrated, or two or more types of transistors may be integrated in any kinds of combination with any percentage each.

By integrating transistors as described above, various kinds of detection targets can be detected by one sensor unit, increasing convenience when performing an analysis as compared with conventional sensor units. Also, at least one of advantages of miniaturization and lower costs of the sensor unit, speedy detection and improvement of detection sensitivity, simplification of operations and so on can be obtained. That is, since many sensing gates for detection can be provided at a time due to integration, for example, a multifunctional sensor unit that can detect many detection targets by one sensor unit can be provided at lower costs. Also, if integration is performed in such a way that many source electrodes and drain electrodes are connected in parallel, for example, detection sensitivity can be enhanced. Further, since the need for separately providing electrodes for comparison to be used for examination of analysis results and the like can be eliminated, for example, it becomes possible to compare results of a transistor with those of another transistor on the same sensor unit.

When integrating transistors, any arrangement of transistors and any kind of specific substance to be immobilized thereon can be used. For example, one transistor may be used to detect one detection target or a plurality of transistors may be used to detect one detection target by electrically connecting the source electrodes and drain electrodes in parallel using an array of the plurality of transistors and detecting the same detection target by each sensing gate for detection.

There is no restriction on the concrete method of integration and any known method may be used, but usually a production method generally used for producing integrated circuits can be used. Recently, a method for incorporating mechanical elements into metals (conductors) and semiconductors called MEMS has been developed and the technique can also be used.

Further, when transistors are integrated, any wiring method may be used and it is usually preferable to devise arrangements and the like to reduce the influence of parasitic capacitance and parasitic resistance as much as possible. More specifically, it is preferable to use, for example, the air bridge technique or wire bonding technique to connect source electrodes and/or drain electrodes or to connect the sensing gates and sensing parts.

[II. Reaction Field Cell]

The third sensor unit may have a reaction field cell. The same reaction field cell as that described in the second embodiment can be used also in the present embodiment.

[III. Detection Targets, Specific Substances and Interactions]

A detection target, a specific substance, and an interaction in the third sensor unit are the same as those described in the first and second embodiments.

As a method for immobilizing a specific substance on the sensing site, a method similar to the method for immobilizing a specific substance on the sensing part described in the first embodiment can be used. However, in this case, a specific substance is assumed to be immobilized on the sensing site instead of the sensing part in the description of the immobilization method in the first embodiment.

Further, concrete detection examples similar to those in the first embodiment can be mentioned.

If a carbon nano tube is used for the channel in the sensor unit in the present embodiment, extremely sensitive detection can be realized. Thus, a diagnosis can be performed at a time by functionality or disease by measuring immune items requiring high detection sensitivity and other items such as electrolytes at a time based on the same principle, realizing POCT. In addition, operations and effects similar to those in the first embodiment can be obtained.

[IV. Examples of Analytical Apparatus]

The configuration of an example of the third sensor unit and an analytical apparatus using the third sensor unit is shown below, but the present invention is not limited to the example shown below and, as mentioned in a description of each component, the configuration may be modified arbitrarily without departing from the scope of the present invention.

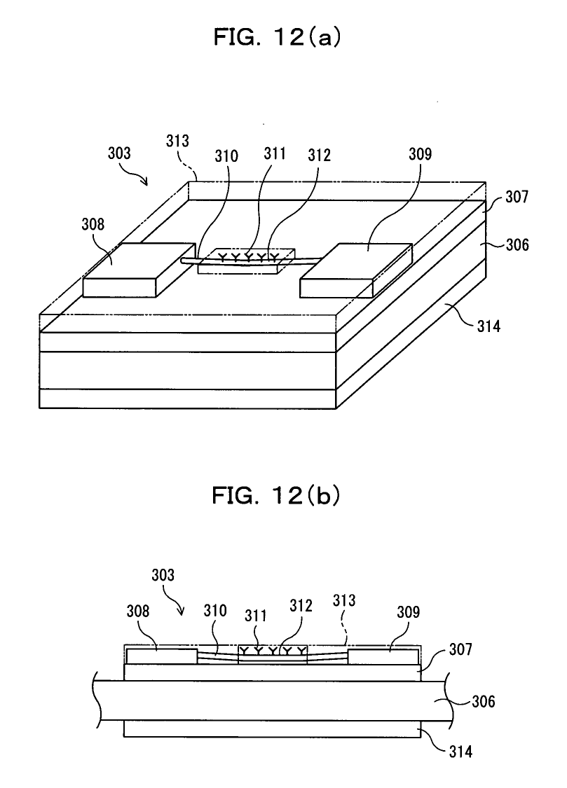

FIG. 9 schematically shows the configuration of main components of an analytical apparatus 300 using the third sensor unit and FIG. 10 shows an exploded perspective view schematically showing the configuration of main components of the third sensor unit. Further, FIG. 12 (a) and FIG. 12 (b) are figures schematically showing main components of a detection device part, and FIG. 12 (a) is a perspective view thereof and FIG. 12 (b) is a side view. In FIG. 9, FIGS. 10, 12 (a) and FIG. 12 (b), components denoted by the same numerals represent the same components.

As shown in FIG. 9, the analytical apparatus 300 comprises a sensor unit 301, instead of the sensor unit 101 in the analytical apparatus 100 described in the first embodiment. That is, the analytical apparatus 300 comprises a sensor unit 301 and a measuring circuit 302, and is constructed to be able to flow a sample by a pump (not shown) as shown by arrows. Here, the measuring circuit 302 is a circuit (transistor characteristic detection part) for detecting any change of the characteristic of the transistor part (See a transistor part 303 in FIG. 10) inside the sensor unit 301 and is constructed, like the measuring circuit 102 in the first embodiment, of any resistor, capacitor, ammeter, voltmeter and the like in accordance with a purpose.

As shown in FIG. 10, the sensor unit 301 comprises an integrated detection device 304 and a reaction field cell 305. Of these components, the integrated detection device 304 is fixed to the analytical apparatus 300. The reaction field cell 305, on the other hand, is mechanically removable from the integrated detection device 304.

The integrated detection device 304 is constructed by integrating a plurality (here 4 units) of the similarly constructed transistor parts 303 in an array on a substrate 306. In the sensor unit 301 in the present example, it is assumed that a total of 12 transistor parts 303, in four columns with three transistor parts 303 in each column, are formed.

As shown in FIG. 12 (a) and FIG. 12 (b), the transistor part 303 integrated on the substrate 306 has a low-permittivity layer 307, a source electrode 308, a drain electrode 309, and a channel 310 formed on the substrate 306 formed of insulating material. These low-permittivity layer 307, source electrode 308, drain electrode 309, and channel 310 are formed in the same manner as the low-permittivity layer 110, source electrode 111, drain electrode 112, and channel 113 described in the first embodiment respectively.

Further, a sensing site 312 on which a specific substance 311 is immobilized is formed on the surface in an intermediate part of the channel 310. Though the specific substance 311 is depicted visually large in FIG. 12 (a) and FIG. 12 (b) for a description, the specific substance 311 is usually minuscule and a specific shape thereof is in most cases not visually recognizable.

An insulator layer 313 is formed all over a surface of the low-permittivity layer 307 where not covered with the source electrode 308 or the drain electrode 309. The insulator layer 313 is formed to cover all over a part of the channel 310 surface where the sensing site 312 is not formed and also the sides and upper surface of the source electrode 308 and drain electrode 309, but not around the sensing site 312. Thus, the sensing site 312 is open to the outside without being covered with the insulator layer 313 so that a sample can come into contact with the sensing site 312 and a current flowing from the source electrode 308 to the drain electrode 309 can be prevented from flowing through the sample without flowing through the channel 310. In FIG. 12 (a) and FIG. 12 (b), the insulator layer 313 is denoted by chain double-dashed lines.

On the underside of the substrate 306 (that is, a surface opposite to the channel 310), a voltage application gate 314 formed of a conductor (for example, gold) is provided as a back gate. The voltage application gate 314 is formed in the same manner as the voltage application gate 118 described in the first embodiment. It is also possible to have the back gate carry out other functions than the voltage application gate.

The reaction field cell 305 is constructed by forming a flow channel 316 fitting to the transistor part 303 on a base 315. More specifically, the flow channel 316 is formed in such a way that a sample flowing in the flow channel 316 can come into contact with the sensing site 312 of each transistor part 303. The flow channel 316 is provided in such a way that the flow channel 316 passes through one of three transistor parts each from left to right in the figure.

The reaction field cell 305 is usually assumed to be used up (disposable). The reaction field cell 305 may be formed integrally with the integrated detection device 304.

The analytical apparatus 300 and the sensor unit 301 in the present example are constructed as described above. Thus, to use the analytical apparatus 300, first the reaction field cell 305 is mounted to the integrated detection device 304 to prepare the sensor unit 301. Then, an appropriate voltage is applied to the voltage application gate 314 so that the transfer characteristic of the transistor part 303 can be maximized to feed a current through the channel 310. In this state, a sample is caused to flow in the flow channel 316 while measuring characteristic of the transistor part 303 using the measuring circuit 302.

The sample flows in the flow channel 316 and comes into contact with the sensing site 312. If, at this point, the sample contains any detection target that interacts with the specific substance 311 immobilized on the sensing site 312, an interaction occurs. The interaction is detected as the change of the characteristic of the transistor part 303. That is, a change in surface charges on the channel 310 occurs due to the interaction and this change causes a change in the gate voltage, leading to the change of the characteristic of the transistor part 303.

Thus, the detection target can be detected by measuring the change of the characteristic of the transistor part 303 using the measuring circuit 302. Particularly, since a carbon nano tube is used for the channel 310 in the present example, detection with extremely high sensitivity becomes possible and thus detection targets that have conventionally been difficult to be detected can now be detected. Further, since the sensing site 312 is formed on the channel 310 surface, the influence of a charge change caused by the interaction is reflected directly on the channel 310, promising still higher detection sensitivity. Therefore, the analytical apparatus in the present example can be used for analysis of a wider range of detection targets than that of a conventional analytical apparatus.

With integration of the transistor part 303, advantages of miniaturization of the sensor unit 301, speedy detection, simplification of operations and so on can be obtained.

Further, since detection tests using a flow can be performed with the use of the flow channel 316, advantages of simpler operations can also be obtained.

By immobilizing different specific substances 311 on each of a plurality of channels 310 formed for each of integrated transistor parts 303 or flowing different types of samples in each of the flow channels 316, two or more detection targets can be detected in one measurement (that is, two or more interactions are detected) so that sample analysis can be performed more easily and swiftly. Particularly with integration of the transistor part 303, interactions that occur at the same time can be detected in one measurement to analyze various items on the sample. Conversely, if the same specific substance 316 is immobilized on each transistor part 303, a lot of data can be obtained in one measurement to produce more analysis results of the sample so that reliability of results can be improved.

Further, operations and effects similar to those of the second embodiment can be obtained from the analytical apparatus 300 and the sensor unit 301. That is, operations and effects performed by the analytical apparatus 100 and the sensor unit 101 exemplified in the first embodiment can also be obtained from the analytical apparatus 300 and the sensor unit 301 in the present example except those related to the electrode separation of the sensing gate for detection 117 and the connector socket 105 being provided.

However, the analytical apparatus 300 and the sensor unit 301 exemplified here are only an example of the sensor unit in the third embodiment and the above configuration can be arbitrarily modified without departing from the scope of the present invention. Thus, the configuration can be modified like the first embodiment or as described in each component of the sensor unit in the present embodiment.

### Fourth Embodiment

A sensor unit according to a fourth embodiment of the present invention (hereinafter called “fourth sensor unit” as appropriate) comprises a transistor part having a substrate, a source electrode and a drain electrode provided on the substrate, a channel forming a current path between the source electrode and the drain electrode, and a sensing gate, and a cell unit mounting part for mounting a reaction field cell unit having a sensing part (interaction sensing part) on which a specific substance capable of selectively interacting with a detection target is immobilized. Further, the sensing part and sensing gate are constructed to be in a conduction state, when the reaction field cell unit is mounted in the cell unit mounting part.

The reaction field cell unit mounted in the fourth sensor unit, on the other hand, is a reaction field cell unit mounted in a cell unit mounting part of a sensor unit comprising a transistor part having a substrate, a source electrode and a drain electrode provided on the substrate, a channel forming a current path between the source electrode and the drain electrode, and a sensing gate, and the cell unit mounting part, and has a sensing part (interaction sensing part) on which a specific substance capable of selectively interacting with a detection target is immobilized. Further, when the reaction field cell unit is mounted in the cell unit mounting part, the sensing part and sensing gate are in a conduction state.

The transistor part is a part functioning as a transistor and, by detecting a change in output characteristic of the transistor, the sensor unit in the present embodiment detects the detection target. The transistor part can be distinguished between a transistor part functioning as a field-effect transistor and that functioning as a single-electron transistor based on a concrete configuration of a channel thereof, and either type of the transistors may be used in the fourth sensor unit. In descriptions that follow, the transistor part is simply called “transistor” as appropriate and, in that case, whether the transistor functions as a field-effect transistor or a single-electron transistor is not distinguished if not specifically mentioned.

Components of the fourth sensor unit and reaction field cell unit will be described below.

[A. Fourth Sensor Unit]

[I. Transistor Part]

(1. Substrate)

The substrate in the fourth sensor unit is the same as that described in the first to third embodiments.

(2. Source Electrode/Drain Electrode)

The source electrode and drain electrode in the fourth sensor unit are the same as those described in the first to third embodiments.

(3. Channel)

The channel in the fourth sensor unit is the same as that described in the first and second embodiments. Thus, a channel having the same configuration as that described in the first and second embodiments can be used and also the same production method as that in the first and second embodiments can be used.

(4. Sensing Gate)

The sensing gate in the fourth sensor unit is the same as that described in the first embodiment. Thus, the sensing gate constitutes a sensing gate for detection together with a sensing part possessed by the reaction field cell unit described later. That is, when an interaction occurs in the sensing part of the reaction field cell unit in the fourth sensor unit, the gate voltage of the sensing gate changes and, by detecting the change of the characteristic of the transistor caused by the change of the gate voltage of the sensing gate, the detection targets can be detected.

(5. Cell Unit Mounting Part)

The cell unit mounting part is a part for mounting a reaction field cell unit described later. Any cell unit mounting part that can mount the reaction field cell unit to the fourth sensor unit can be used, and any shape and dimensions can be selected for the cell unit mounting part.

In addition to mounting the reaction field cell unit directly to the cell unit mounting part, the reaction field cell unit may be mounted via another connecting member such as a connector. That is, how to mount the reaction field cell unit is arbitrary as long as the sensing gate and the sensing part possessed by the reaction field cell unit are set to a conduction state when the reaction field cell unit is mounted.

(6. Voltage Application Gate)

Like the first to third sensor units, the transistor part in the fourth sensor unit may have a voltage application gate. The voltage application gate provided in the transistor part of the fourth sensor unit is the same as that provided in the transistor part of the first to third sensor units.

(7. Integration)

In the fourth sensor unit, it is preferable to integrate the transistor parts. That is, it is preferable that two or more source electrodes, drain electrodes, channels, sensing gates, and as appropriate, voltage application gates are provided on a single substrate, and further, it is more preferable to miniaturize them as much as possible. Component members of each transistor may be provided in such a way that they are shared by other transistors as appropriate and, for example, the voltage application gate may be shared by two or more of integrated transistors. Further, one type of transistors may be integrated, or two or more types of transistors may be integrated in any kinds of combination with any percentage each.

By integrating transistors as described above, at least one of advantages of miniaturization and lower costs of the sensor unit, speedy detection and improvement of detection sensitivity, simplification of operations and so on can be obtained. That is, since many sensing gates for detection can be provided at a time due to integration, for example, a multifunctional sensor unit that can detect many detection targets by one sensor unit can be provided at lower costs. Also, if integration is performed in such a way that many source electrodes and drain electrodes are connected in parallel, for example, detection sensitivity can be enhanced. Further, since the need for separately providing electrodes for comparison to be used for examination of analysis results and the like can be eliminated, for example, it becomes possible to compare results of a transistor with those of another transistor on the same sensor unit.

When integrating transistors, any arrangement of transistors and any kind of specific substance to be immobilized thereon can be used. For example, one transistor may be used to detect one detection target or a plurality of transistors may be used to detect interactions of one detection target by electrically connecting the source electrodes and drain electrodes in parallel using an array of the plurality of transistors and detecting interactions of the same detection target by each sensing gate for detection.

There is no restriction on the concrete method of integration and any known method may be used, but usually a production method generally used for producing integrated circuits can be used. Recently, a method for incorporating mechanical elements into metals (conductors) and semiconductors called MEMS has been developed and the technique can also be used.

Further, when transistors are integrated, any wiring method may be used and it is usually preferable to devise arrangements and the like to reduce the influence of parasitic capacitance and parasitic resistance as much as possible. More specifically, it is preferable to use, for example, the air bridge technique or wire bonding technique to connect source electrodes and/or drain electrodes or to connect the sensing gates and sensing parts.

[II. Electric Connection Switching Part]

If, in the fourth sensor unit, the transistor parts are integrated or the reaction field cell unit mounted to the cell unit mounting part has a plurality of sensing parts, like the first cell unit, the fourth sensor unit preferably has an electric connection switching part for switching conduction between the sensing gate and sensing part. Thereby, miniaturization of the sensor unit, improvement of reliability of detected data, efficient detection and so on will be achieved. If transistors are integrated, the conduction may be switched not only within the same transistor, but also between transistors.

The same electric connection switching part as that possessed by the first sensor unit can be used for the fourth sensor unit.

[B. Reaction Field Cell Unit]

The reaction field cell unit is a member to be mounted to the cell unit mounting part of the fourth sensor unit, and has a sensing part (interaction sensing part) on which a specific substance capable of selectively interacting with a detection target is immobilized. The reaction field cell unit is also a member to bring a sample into contact with the sensing part. Further, when the reaction field cell unit is mounted in the cell unit mounting part, the sensing part and sensing gate are in a conduction state. Meanwhile, the sample is a target to be detected using a sensor unit and if any detection target is contained in the sample, the detection target and a specific substance interact.

Any concrete configuration allowing a reaction field cell unit to bring a sample into contact with the sensing part and, if the sample contains any detection target, to cause the above-mentioned interaction can be used. The reaction field cell unit can be constructed, for example, as a container holding a sample so that the sample comes into contact with the sensing part. If the sample is fluid, however, it is desirable to construct the reaction field cell unit as a member having a flow channel to cause the fluid to flow. By detecting an interaction by causing a sample to flow, advantages of speedy detection, simplification of operations and so on can be obtained.

[I. Sensing part]

The sensing part in the present embodiment is a member formed in the reaction field cell unit separately from the substrate and on which a specific substance capable of selectively interacting with a detection target is immobilized and the same one as that described in the first embodiment. Thus, the material of the sensing part, number of sensing parts, shape, dimensions, means for conducting to the sensing gate are the same as those described in the first embodiment. Further, if two or more sensing parts are provided, it is similarly preferable to provide two or more sensing parts that correspond to one sensing gate.

Since, in the present embodiment, the sensing part is provided in the reaction field cell unit, the sensing part is also mechanically removable from the fourth sensor unit by removing the reaction field cell unit from the fourth sensor unit. When the reaction field cell unit is mounted to the cell unit mounting part, the sensing part is set to an electric conduction state to the sensing gate of the fourth sensor unit.

[II. Flow Channel]

There is no restriction on the shape and dimensions of the flow channel and the number of flow channels, but it is desirable to form an appropriate flow channel in accordance with a detection purpose. The flow channel described in the first embodiment can be mentioned as a concrete example of the flow channel. Further, members forming a flow channel and the method for forming a flow channel are also the same as those described in the first embodiment.

[C. Detection Targets, Specific Substances and Interactions]

A detection target, a specific substance, and an interaction in the fourth sensor unit and reaction field cell unit are the same as those described in the first to third embodiments.

As a method for immobilizing a specific substance on the sensing site, a method similar to the method for immobilizing a specific substance on the sensing part described in the first embodiment can be used.

Further, concrete detection examples similar to those in the first embodiment can be mentioned.

If a carbon nano tube is used for the channel in the sensor unit in the present embodiment, extremely sensitive detection can be realized. Thus, a diagnosis can be performed at a time by functionality or disease by measuring immune items requiring high detection sensitivity and other items such as electrolytes at a time based on the same principle, realizing POCT. In addition, operations and effects similar to those of the first embodiment can be obtained, and also similar modifications can be made.

[D. Examples of Analytical Apparatus]

As an example of the fourth sensor unit and reaction field cell unit, and an analytical apparatus using them, an example similar to one exemplified in the first embodiment can be mentioned. That is, the detection device part 109 comprising the substrate 108, low-permittivity layer 110, source electrode 111, drain electrode 112, channel 113, insulation layer 114, sensing gate 115, voltage application gate 118, and insulator layer 120 in the analytical apparatus 100 exemplified using FIG. 6 to FIG. 8 in the first embodiment functions as a transistor part 401 in the present embodiment, a sensor unit 402 comprising the integrated detection device 104 and the connector socket 105 as the fourth sensor unit, and a reaction field cell unit 403 comprising the separate type integrated electrode 106 and the reaction field cell 107 as the reaction field cell unit in the present embodiment. The mounting part 105B provided on the upper part of the connector socket 105 is a part where the reaction field cell unit 403 is mounted to the sensor unit 402 and functions as a reaction field mounting part 404. Thus, the analytical apparatus 100 having these sensor unit 402 and reaction field cell unit 403 functions as the analytical apparatus 400 in the present embodiment.

Therefore, according to the sensor unit 402, reaction field cell unit 403, and analytical apparatus 400, which is an example of the present embodiment, in addition to being usable for analysis of a wider range of detection targets, advantages of miniaturization of the sensor unit 402, speedy detection, simplification of operations and so on can be obtained due to integration of the transistor part 401 (that is, the detection device part 109).

Since the sensor unit 402 and reaction field cell unit 403 are removably formed as separate pieces, the reaction field cell unit 403 can be used as a disposable type like flow cells, thereby enabling miniaturization of the sensor unit 402 and analytical apparatus 400 to improve usability for users.

Further, since the reaction field cell unit 403 is disengageable and replaceable, the sensor unit 402 and analytical apparatus 400 can be produced at lower prices and further made expendable, and samples can be prevented from being biologically contaminated.

Also, operations and effects similar to those described in the first embodiment can be obtained.

Further, as described in the first embodiment, the above configuration can be arbitrarily modified without departing from the scope of the present invention.

### Fifth Embodiment

A sensor unit according to a fifth embodiment of the present invention (hereinafter called “fifth sensor unit” as appropriate) comprises a transistor part having a substrate, a source electrode and a drain electrode provided on the substrate, a channel forming a current path between the source electrode and the drain electrode, and a sensing gate for detection. Further, in the fifth sensor unit, the sensing gate for detection comprises a gate body fixed to the substrate and a sensing part capable of electrically conducting to the gate body. The fifth sensor unit is also comprised of a reference electrode to which a voltage is applied to detect existence of a detection target as the change of the characteristic of the transistor part.

Also in the fifth sensor unit, like the first to fourth sensor units, the transistor part is a part functioning as a transistor and, by detecting a change in output characteristic of the transistor, the sensor unit in the present embodiment detects the detection targets. The transistor part can be distinguished between a transistor part functioning as a field-effect transistor and that functioning as a single-electron transistor based on a concrete configuration of a channel thereof, and either type of the transistors may be used in the fifth sensor unit. In descriptions that follow, the transistor part is simply called “transistor” as appropriate and, in that case, whether the transistor functions as a field-effect transistor or a single-electron transistor is not distinguished if not specifically mentioned.

[I. Transistor Part]

(1. Substrate)

The substrate in the fifth sensor unit is the same as that described in the first to fourth embodiments.

(2. Source Electrode/Drain Electrode)

The source electrode and drain electrode in the fifth sensor unit are the same as those described in the first to fourth embodiments.

(3. Channel)

The channel in the fifth sensor unit is the same as that described in the first, second, and fourth embodiments. Thus, a channel having the same configuration as that described in the first, second, and fourth embodiments can be used and also the same production method as that in the first, second, and fourth embodiments can be used.

(4. Sensing Gate for Detection)

The sensing gate for detection comprises the sensing gate, which is a gate body, and the sensing part. If the sensing part of the sensing gate for detection in the fifth sensor unit detects any electric change resulting from a detection target, the gate voltage of the sensing gate changes and, by detecting the change of the characteristic of the transistor caused by the change of the gate voltage of the sensing gate, the detection target can be detected.

(4-1. Sensing Gate)

The sensing gate in the fifth sensor unit is the same as that described in the first and fourth embodiments. Thus, the sensing gate constitutes a sensing gate for detection together with a sensing part possessed by the reaction field cell unit described later.

(4-2. Sensing Part)

In the present embodiment, the sensing part is a member that is formed separately from the substrate to which the source electrode and drain electrode are fixed and capable of electrically conducting to the sensing gate. Then, when any electric change resulting from a detection target is detected, the sensing part transmits the electric change as an electric signal to the sensing gate to be able to cause a change in the gate voltage of the sensing gate.

Except for being unnecessary to immobilize a specific substance, the sensing part can be constructed in the same manner as described in the first and fourth embodiments. Thus, the material of the sensing part, number of sensing parts, shape, dimensions, means for conducting to the sensing gate are the same as those described in the first embodiment. Further, if two or more sensing parts are provided, it is similarly preferable to provide two or more sensing parts by associating them with one sensing gate. Meanwhile, the specific substance may be immobilized on the sensing part as long as the function of the sensor unit to detect the detection targets is not impaired.

(5. Reference Electrode)

The reference electrode is an electrode to which a voltage is applied to detect existence of a detection target as the change of the characteristic of the transistor part. More specifically, the reference electrode is an electrode for applying a voltage to the sensing part and the reference electrode may be constructed in such a way that the voltage is applied to the sensing part via a sample. Further, the reference electrode can also be used as a standard electrode or to keep the voltage of a sample constant. Meanwhile, the sample is a target to be detected using a sensor unit and if any detection target is contained in the sample, the detection target will be detected using the sensor unit in the present embodiment.

The placement location of the reference electrode is not restricted as long as a detection target can be detected. The reference electrode may be formed on the substrate, but is usually formed together with the sensing part separately from the substrate. However, it is preferable to arrange the reference electrode and sensing part facing each other and to construct the sensor unit so that a sample is positioned between the reference electrode and sensing part to enhance detection sensitivity. It is also preferable to place the reference electrode so close to the sensing part that a voltage or an electric field can be applied to the sensing part with stability.

Further, the reference electrode is formed as an electrode insulated from the channel, source electrode, and drain electrode, and there is no restriction on the material, dimensions, and shape of the reference electrode. Usually, the reference electrode can be formed using the same material, dimensions, and shape as the voltage application gate those described in the first embodiment.

If two or more sensing parts are provided, the reference electrode may be constructed is such a way that one reference electrode corresponds to two or more sensing parts. The sensor unit can thereby be made smaller.

Here, the mechanism of detection using the reference electrode will be described.

If the sensor unit is constructed so that the reference electrode can apply a voltage or an electric field to the sensing part, a voltage or an electric field is applied to the sensing part while the reference electrode is insulated from the sensing part and a sample is within the electric field generated by the reference electrode. If, at this point, a detection target in the sample undergoes some change (in number, concentration, density, phase, state and so on), a permittivity of the sample changes resulting from the change of the detection target and thus the electric potential of the sensing gate changes. By detecting the change of the characteristic of the transistor caused by the change of the gate voltage, the detection target can be detected.

If the sensor unit is constructed so that a voltage can be applied to the sensing part via a sample, on the other hand, a specific (DC, AC) voltage or electric field is applied to the sensing part via the sample. If, at this point, a detection target in the sample undergoes some change (in number, concentration, density, phase, state and so on), an electric impedance of the sample changes resulting from the change of the detection target and thus the electric potential of the sensing gate changes. By detecting the change of the characteristic of the transistor caused by the change of the gate voltage, the detection target can be detected.

(6. Voltage Application Gate)

The transistor part in the fifth sensor unit may have a voltage application gate. The voltage application gate provided in the transistor part of the fifth sensor unit is the same as that provided in the transistor part of the first to fourth sensor units.

(7. Integration)

The transistors described above are preferably integrated. That is, it is preferable that two or more source electrodes, drain electrodes, channels, sensing gates for detection, and as appropriate, voltage application gates are provided on a single substrate, and further, it is more preferable to miniaturize them as much as possible. However, among components of the sensing gate for detection, the sensing part is usually formed separately from the substrate and thus only the sensing gate (gate body) needs to be integrated on the substrate. Component members of each transistor may be provided in such a way that they are shared by other transistors as appropriate and, for example, the sensing part of the sensing gate for detection, reference electrode, and voltage application gate may be shared by two or more of integrated transistors. Further, one type of transistors may be integrated, or two or more types of transistors may be integrated in any kinds of combination with any percentage each.

By integrating transistors as described above, at least one of advantages of miniaturization and lower costs of the sensor unit, speedy detection and improvement of detection sensitivity, simplification of operations and so on can be obtained. That is, since many sensing gates for detection can be provided at a time due to integration, for example, a multifunctional sensor unit that can detect many detection targets by one sensor unit can be provided at lower costs. Also, if integration is performed in such a way that many source electrodes and drain electrodes are connected in parallel, for example, detection sensitivity can be enhanced. Further, since the need for separately providing electrodes for comparison to be used for examination of analysis results and the like can be eliminated, for example, it becomes possible to compare results of a transistor with those of another transistor on the same sensor unit.

When integrating transistors, any arrangement of transistors and any kind of specific substance to be immobilized thereon, as needed, can be used. For example, one transistor may be used to detect one detection target or a plurality of transistors may be used to detect one detection target by electrically connecting the source electrodes and drain electrodes in parallel using an array of the plurality of transistors and detecting the same detection target by each sensing gate for detection.

There is no restriction on the concrete method of integration and any known method may be used, but usually a production method generally used for producing integrated circuits can be used. Recently, a method for incorporating mechanical elements into metals (conductors) and semiconductors called MEMS has been developed and the technique can also be used.

Further, when transistors are integrated, any wiring method may be used and it is usually preferable to devise arrangements and the like to reduce the influence of parasitic capacitance and parasitic resistance as much as possible. More specifically, it is preferable to use, for example, the air bridge technique or wire bonding technique to connect source electrodes and/or drain electrodes or to connect the sensing gates and sensing parts.

[II. Electric Connection Switching Part]

If, in the fifth sensor unit, the transistor part is integrated or a plurality of sensing parts are provided, that is, two units or more of one or both of the sensing gate and the sensing part are provided, the fifth sensor unit preferably has an electric connection switching part for switching conduction between the sensing gate and sensing part. In this case, the electric connection switching part provided to the fifth sensor unit is the same as that described in the first, second, and fourth embodiments.

[III. Reaction Field Cell Unit]

The fifth sensor unit may be provided with a reaction field cell unit. Any reaction field cell unit that can position a sample at any desired location for detection, that is, the sample can be positioned within an electric field of the reference electrode or the reference electrode can apply a voltage to the sensing part via the sample, can be used.

If the sample is fluid, however, it is desirable to construct the reaction field cell unit as a member having a flow channel to cause the fluid to flow. By detecting an interaction by causing a sample to flow, advantages of speedy detection, simplification of operations and so on can be obtained.

If the reaction field cell unit has a flow channel, there is no restriction on its shape, dimensions, number of the flow channels, material of members forming the flow channel, production method of the flow channel and so on, and usually the same flow channel as that described in the first and fourth embodiments is adopted.

Further, one of the above-mentioned sensing part and reference electrode, or both of them may be formed in the reaction field cell unit. That is, the sensing gate for detection may be constituted by the sensing gate on the substrate and the sensing part and reference electrode in the reaction field cell unit. The sensing part and reference electrode can thereby be removed together with removal of the sensing gate for detection, leading to simplification of operations.

[IV. Detection Targets and Concrete Detection Examples]

(1. Detection Targets)

A detection target is a substance to be detected by the sensor unit in the present embodiment. No restriction is imposed on the detection target of the fifth sensor unit and any substance may be selected as a detection target. Substances that are not pure may also be used as detection target. Concrete examples thereof include those exemplified in the first to fourth embodiments.

(2. Concrete Detection Examples)

Some concrete examples of detection method of a detection target using the sensor unit in the present embodiment will be described.

Using the sensor unit in the present embodiment, for example, like the first embodiment, detection of proteins and the like using interactions between biomolecules, detection of a blood electrolyte, measurement of pH, detection of blood gases, detection of a substrate, detection of enzyme and the like can be performed using specific substances.

Also, using the sensor unit in the present embodiment, for example, a blood electrolyte can be detected as a detection target. In this case, the liquid membrane ion-selective electrode method is usually adopted.

Further, by using the sensor unit in the present embodiment, for example, pH measurement can be made. In the pH measurement, hydrogen ions are detected as a detection target and pH is measured based on the hydrogen ions. The hydrogen ion-selective electrode method is usually adopted.

Also, blood coagulation ability measurement can be made, for example, using a blood as a sample. Main blood coagulation ability measurements include activated partial thromboplastin time (APTT) measurement, prothrombin time (PT) measurement, and activated coagulation time (ACT) measurement. Simply a whole blood coagulation time may also be measured.

In an APTT test, a series of intrinsic enzyme catalyzed reactions and a series of general enzyme catalyzed reactions of blood coagulation can be sensed and evaluated. Thus, APTT is frequently used to monitor intravenous heparin anticoagulation therapy. Particularly, the APTT test can measure a time required for formation of a fibrin clot after adding an activator, calcium, and phospholipid to a citrated blood sample. The citrated blood sample represents a blood sample (including a whole blood and plasma) after anticoagulation treatment is provided. In addition to treatment by citrates, anticoagulation treatment includes heparin treatment, but is not limited to this. Heparin treatment has an effect of inhibiting clot formation.

In a PT test, a series of extrinsic enzyme catalyzed reactions and a series of general enzyme catalyzed reactions of blood coagulation can be sensed and evaluated. Thus, PT is frequently used to monitor oral anticoagulation therapy. Particularly, the PT test can measure a time required for formation of a fibrin clot after adding an activator, calcium, and tissue thromboplastin to a citrated blood sample. The oral anticoagulant Coumadin has an effect of inhibiting prothrombin formation. Therefore, the PT test is based on addition of calcium and tissue thromboplastin to a blood sample.

Further, in an ACT test, a series of intrinsic enzyme catalyzed reactions and a series of general enzyme catalyzed reactions of blood coagulation can be sensed and evaluated. Thus, the ACT test is frequently used to monitor anticoagulations for heparin therapy. The ACT test is based on addition of activators to a series of intrinsic catalyzed reactions to renew a whole blood, to which no extrinsic anticoagulation is added at all.

To examine the blood coagulation abilities of the APTT, PT, ACT and the like, for example, at least one reagent that can promote a permittivity change of the sample (blood) after coming into contact with a blood (including a whole blood and plasma) and the blood are mixed, the mixed solution is put between the reference electrode and gate electrode, and a permittivity change over time caused at this point is directly sensed as a response by an electric capacity change on the sensing gate to measure the coagulation time.

For the measurement of the blood coagulation time, various methods using viscosity, electric conductivity, optical examination of concentration changes and the like have been developed. In the sensor unit in the present embodiment, it is preferable to use a single-electron transistor using a carbon nanotube, which is sensitive to a permittivity change, for the SET channel because, in view of principles of device structure, detection sensitivity will be extremely enhanced. A concrete example of a sensor unit using a carbon nano tube will be described below. However, the present invention is not limited to the following example and can be carried out with various modifications.

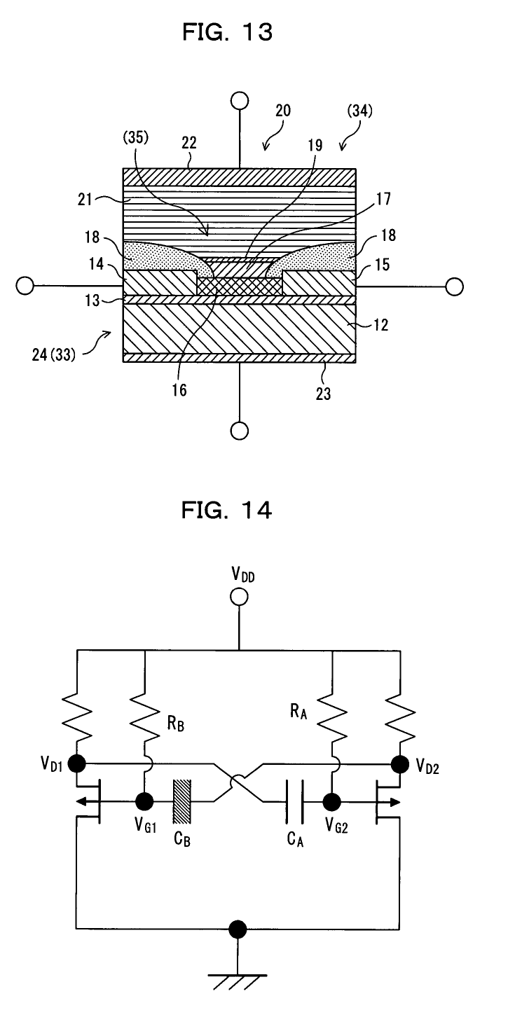

FIG. 13 is a sectional view schematically showing the configuration of main components of an example of a sensor unit used for measurement of a blood coagulation time. As shown in FIG. 13, the sensor unit has an insulation layer 13 of SiO₂ formed on the surface of a substrate 12 formed of Si and a source electrode 14 and a drain electrode 15 formed on the surface of the insulation layer 13. A SET channel 16 formed of a carbon nano tube is formed between the source electrode 14 and drain electrode 15. Further, a sensing gate (gate body) 17 is formed above the SET channel 16. The sensing gate 17 has an insulation layer (not shown) on its underside, thereby insulating the sensing gate 17 and SET channel 16.

Also, an insulation layer 18 is formed all over the top surface of the source electrode 14 and drain electrode 15 and top surfaces at both sides of the SET channel 16, thereby insulating the source electrode 14 and drain electrode 15 from the sensing gate 17.

Further, a sensing part 19 is mechanically removably formed on the upper part of the sensing gate 17. The sensing part 19 is a gate formed of a conductor and is electrically conducting to the sensing gate 17.

Further, a reaction field 21 is formed above the sensing part 19 by a reaction field cell (not shown) and a blood will coagulate within the reaction field 21.

A reference electrode 22 is provided across the reaction field 21 facing the sensing part 19 and a voltage can be applied to the sensing part 19 from the reference electrode 22.

Further, a voltage application gate 23 is formed on the underside (lower side in FIG. 13) of the substrate 12 and a voltage that is applied to the SET channel 16 to detect existence of a detection target as the change of the characteristic of the transistor part 24 can be applied to the voltage application gate 23. The voltage application gate 23 may also be used for any other purposes than to apply a voltage to the SET channel 16 as appropriate.

In this sensor chip, the transistor part 24 is comprised of the substrate 12, insulation layers 13 and 18, source electrode 14, drain electrode 15, SET channel 16, a sensing gate for detection 20 (that is, the sensing gate 17 and sensing part 19), and the voltage application gate 23. Also, wiring is each connected to the source electrode 14, drain electrode 15, reference electrode 22, and voltage application gate 23, and a voltage is applied, and a current, a voltage and the like are measured by external measuring equipment through the wiring.

Using the sensor unit described above, the reaction field 21 is filled with a blood, which is a sample for which treatment has been provided so that a coagulation reaction occurs to cause a coagulation reaction to proceed in a field in which an electric capacity of the reference electrode 22 is formed. If a coagulation reaction proceeds, permittivity of the reaction field 21 changes and the electric capacity of the transistor part 24 changes. Thus, if a voltage (that is, an electric potential V_{G} of the reference electrode 22 or a voltage V_{GS} of the reference electrode 22 with respect to the source electrode 14) simply applied to the reference electrode is constant, since a drain current I_{D} increases when permittivity increases, a reaction rate can be calculated from a time constant based on a change of permittivity by observing the drain current I_{D} in the transistor part 24 to calculate the coagulation time. Further, if an oscillator is constructed from the transistor part 24 and is caused to operate, the pulse time width and frequencies to be oscillated change in accordance with a change in electric capacity of the transistor part 24. If permittivity increases due to coagulation, the pulse time width increases and thus a correlation between the time constant calculated from the increase and the coagulation time can be measured. Since the oscillating frequency decreases if permittivity increases, the oscillating frequency can be measured without particular constraints by incorporating a circuit {such as a Q meter (RCL series oscillator), a C meter, and an AC bridge circuit} that can measure electric capacities.

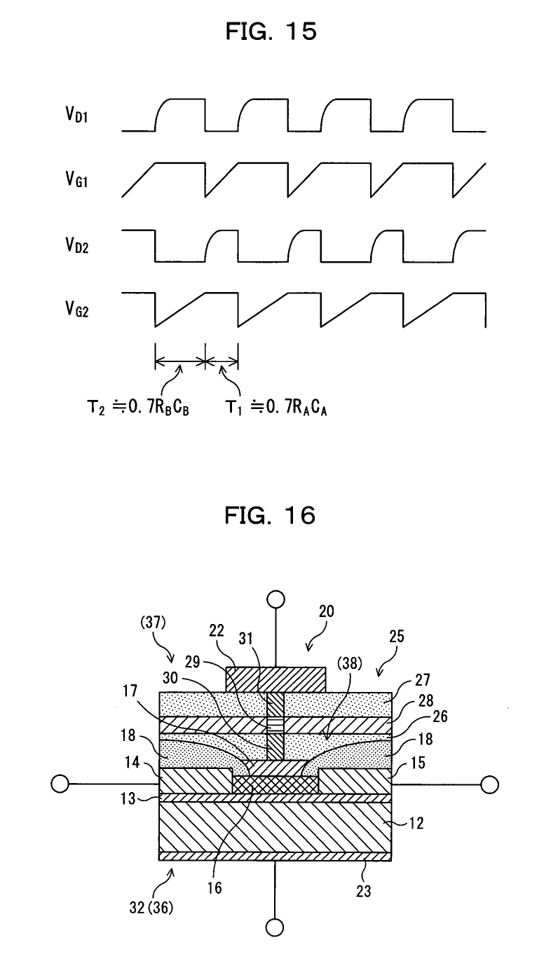

Citing a simple example, by constructing an analytical apparatus (multi-vibrator) having a circuit shown in FIG. 14 and measuring a time constant τ₁ (=R_{A}C_{A}) and a time constant τ₂ (=R_{B}C_{B}) in each part thereof, the correlation with the coagulation time can be measured. That is, if a capacitance C_{B} of a coagulation time detection part (herein, the transistor part 24 of the sensor unit is used) changes, the time constants τ₁ and τ₂ of each part change, for example, as shown in FIG. 15. Thus, by reading these time constants τ₁ and τ₂, the correlation with the coagulation time can be known. FIG. 14 is a figure showing an example of a measuring circuit of the analytical apparatus having the above sensor unit. In FIG. 14, R_{A} and R_{B} each represent resistance of corresponding resistors, V_{D1}, V_{D2}, V_{G1}, and V_{G2} each represent voltages at the corresponding positions, V_{DD} represents DC power source, C_{A} represents a capacity of any capacitor, and C_{B} represents an electric capacity between the reference electrode 22 and the voltage application gate 23. FIG. 15 is a figure for describing a time constant change, which is an example of characteristic changes of a transistor, and T₁ and T₂ each represent a period.

If any element (for example, a temperature change and a pressure change) that affects sensitive common mode input other than desired items in a circuit portion where no measurement of the coagulation time can be made using the transistor part 24 arises, measurements can still be made with sensitivity by constructing the circuit in such a way that such an element is subtracted.

Further, any quantitative liquid sending method of reagents and reaction scheme can be used in the reaction field 21 if reproducibility thereof is good.

Mixing of activators, or calcium and phospholipid, as reagents with a blood to which treatment by citrates has been provided in the APTT test can be mentioned as a concrete example of using a reagent to promote a permittivity change. In the PT test, mixing of calcium and tissue thromboplastin with a blood can be mentioned.

Blood cell count measurement can also be made using, for example, a blood as a sample. Blood cell count measurement is a measurement of, for example, the red blood cell count (RBC), hemoglobin concentration (Hb), hematocrit (Hct), white blood cell count (WBC), platelet count (Plt), mean corpuscular volume (MCV), and mean corpuscular hemoglobin concentration (MCHC). Further, addition of the differential white blood cell count (lymphocyte, granular leukocyte, and monocyte) to the blood cell count measurement is called hematometry.

When blood cell count measurement such as the red blood cell count (RBC), white blood cell count (WBC), and platelet count is made, electric resistance is used for measurement. Blood cell count measurement is made, for example, by causing corpuscles to flow through an aperture and detecting the number of the changes of electric resistance (corpuscular passage signal) or the number of the changes of electric impedance when corpuscles pass through the aperture.

An example of the sensor unit used for whole blood cell count measurement will be described below, but the present invention is not limited to the following example and can be carried out with various modifications.

FIG. 16 is a sectional view schematically showing the configuration of main components of an example of the sensor unit used for measurement of whole blood cell count. In FIG. 16, the same numerals as those in FIG. 13 denote the same components. FIG. 16 shows a state in which a reaction field cell unit 25 is mounted.

As shown in FIG. 16, the sensor unit does not have the sensing part 19 and reaction field 21 of the sensor unit used for measurement of the blood coagulation time shown in FIG. 13 and comprises the reaction field cell unit 25 formed removably. That is, the sensor unit in FIG. 16 comprises the substrate 12, insulation layers 13 and 18, source electrode 14, drain electrode 15, SET channel 16 formed of a carbon nanotube, sensing gate (gate body) 17, reference electrode 22, voltage application gate 23, and reaction field cell unit 25.

The reaction field cell unit 25 has a spacer 28 formed of an insulation material between a pair of upper and lower tabular frames 26 and 27, and a flow channel 29 is formed between the spacer 28 to cause a blood to flow in a direction intersecting the surface of FIG. 16.

A hole through the tabular frame 26 is formed below the flow channel 29 and a sensing part 30 formed of a conductor is provided in the hole. When the reaction field cell unit 25 is mounted as shown in FIG. 16, since the sensing part 30 is formed integrally with the reaction field cell unit 25, the sensing part 30 and sensing gate 17 are in conduction and, when the reaction field cell unit 25 is removed, the sensing part 30 and sensing gate 17 are not in conduction. The sensing part 30 thereby detects the number of the changes of electric resistance (corpuscular passage signal) or the electric impedance variation number when a detection target such as red blood cells passes through a part over the surface (top surface in the figure) on the flow channel side 29 of the sensing part 30 by an electric signal from the sensing part 30 to the sensing gate 17.

Further, a hole through the tabular frame 27 is also formed above the flow channel 29 and an electrode section 31 formed of a conductor is provided in the hole. Since the electrode section 31 is formed so as to be in contact with the reference electrode 22, the electrode section 31 and reference electrode 22 are in electric conduction and thus a voltage applied from the reference electrode 22 can be applied to the sensing part 30 and sensing gate 17 via the electrode section 31 and flow channel 29.

Since the sensing part 30 and electrode section 31 fill up the holes through the tabular frames 26 and 27, there is no possibility that a fluid flowing in the flow channel 29 leaks out of the flow channel 29.

In the sensor chip having the configuration described above, the transistor part 32 comprises the substrate 12, insulation layers 13 and 18, source electrode 14, drain electrode 15, SET channel 16, sensing gate for detection 20 (that is, the sensing gate 17 and sensing part 30), and voltage application gate 23. Also, wiring is each connected to the source electrode 14, drain electrode 15, reference electrode 22, and voltage application gate 23, and a voltage is applied, and a current, a voltage and the like are measured by external measuring equipment through the wiring.

To use a sensor unit described above, a sample blood is caused to flow through the flow channel 29. At this point, the sample is caused to flow through the flow channel 29 while a fixed voltage is applied from the reference electrode 22. If a detection target flows through a part between the sensing part 30 and electrode section 31, an electric impedance of the part between the sensing part 30 and electrode section 31 of the flow channel 29 and thus a drain current flowing through the SET channel 16 changes noticeably each time a detection target flows. Therefore, blood cell count can be measured by counting the number of times of such changes.

Among the blood cell count, the red blood cell count (RBC) and mean corpuscular volume (MCV) are measured in a blood directly or after diluting the blood by the method described above. The platelet count (Plt) is determined by a corpuscular passage signal ratio of platelets/red blood cells when measuring the red blood cell count. Further, the white blood cell count (WBC) is determined by the corpuscular passage signal of the sample by the above method after treating the red blood cells with a hemolyzing agent. The differential white blood cell count is differentiated, identified, and classified based on the electric resistance value of the corpuscular passage signal when measuring the white blood cell count. Further, the hemoglobin concentration is measured immunologically and the hematocrit is measured by the electric conductivity. From these values, the erythrocyte indices (MCV, MCH, and MCHC) are determined.

The configuration of the sensor unit exemplified above can be modified as appropriate as mentioned in a description of each component and, for example, individual sensing parts can be partitioned when measuring a plurality of items to prevent reagents used for one item and reaction products from inhibiting measurements of other items. Also when sending sample and reagents needed for detection to individual sensing parts, they may be sent to the sensing parts after dividing them among flow channels described above.

Further, the above example shows an example in which the SET channel 16 is used, but an FET channel can be used instead and also a channel not formed of the carbon nano tube can be used.

Since, however, using a carbon nano tube for the channel can realize detection with very high detection sensitivity, a diagnosis can be performed at a time by every each disease by measuring immune items requiring high detection sensitivity and other items such as biochemical items at a time based on the same principle, realizing POCT.

[V. Examples of Analytical Apparatus]

The configuration of an example of the fifth sensor unit and an analytical apparatus using the fifth sensor unit is shown below, but the present invention is not limited to the example shown below and, as mentioned in a description of each component, the configuration may be modified arbitrarily without departing from the scope of the present invention.

An outline of the fifth sensor unit and the analytical apparatus using the fifth sensor unit described below has the same configuration as the analytical apparatus described in the first embodiment as an example of the analytical apparatus using the first sensor unit except that no specific substance is used and a reference electrode is newly provided.

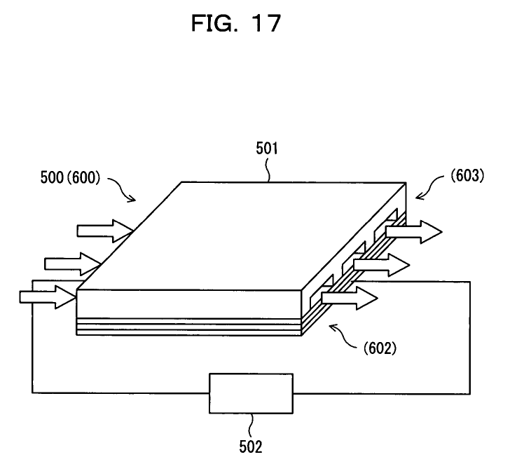

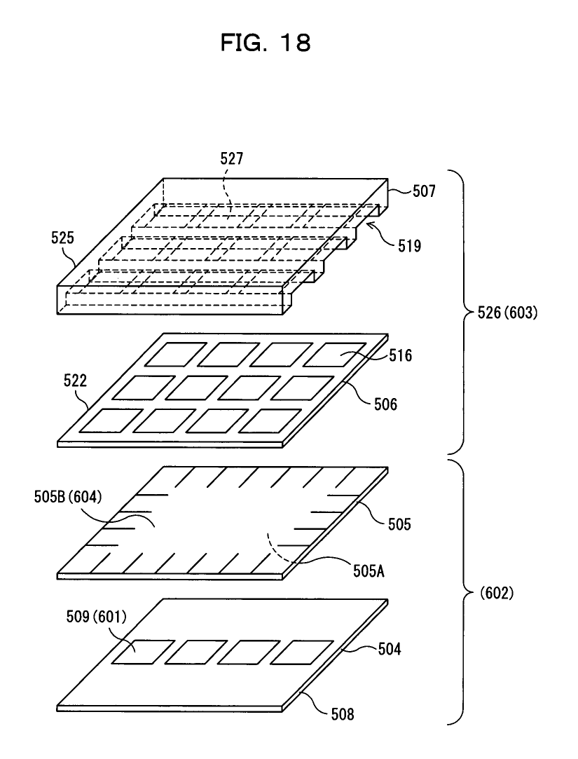

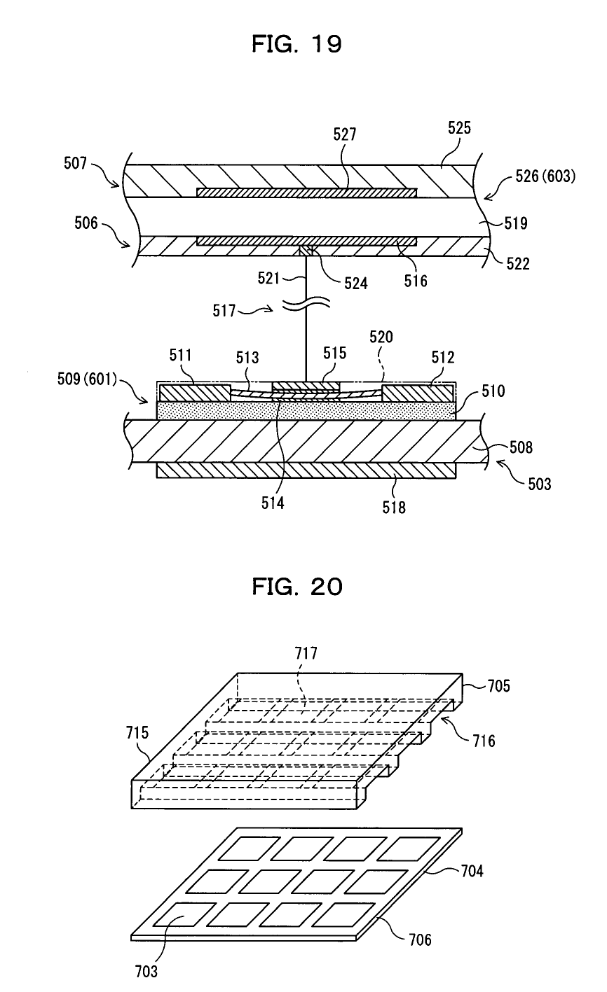

FIG. 17 is a figure schematically showing the configuration of main components of an analytical apparatus 500 using the fifth sensor unit and FIG. 18 is an exploded perspective view schematically showing the configuration of main components of the fifth sensor unit. Further, FIG. 7 (a) and FIG. 7 (b) are figures schematically showing the configurations of main components of a detection device part 509, and FIG. 7 (a) is a perspective view thereof and FIG. 7 (b) is a side view. Further, FIG. 19 is a sectional view schematically showing periphery of an electrode section 516 when a connector socket 505, a separate type integrated electrode 506 and a reaction field cell 507 are mounted in an integrated detection device 504. In FIG. 19, however, the connector socket 505 is shown only as internal wiring 521 thereof for a description. In FIG. 7 (a), FIG. 7 (b), FIG. 17 to FIG. 19, components denoted by the same numerals represent the same components.

As shown in FIG. 17, the analytical apparatus 500 comprises a sensor unit 501 and a measuring circuit 502, and is constructed to be able to flow a sample by a pump (not shown) as shown by arrows. Here, the measuring circuit 502 is a circuit (transistor characteristic detection part) for detecting any change of the characteristic of the transistor part (See a transistor part 503 in FIG. 19) inside the sensor unit 501 while controlling the voltage applied to the reference electrode 527 and is constructed of any resistor, capacitor, ammeter, voltmeter and the like in accordance with a purpose.

As shown in FIG. 18, the sensor unit 501 comprises the integrated detection device 504, connector socket 505, separate type integrated electrode 506 and reaction field cell 507. Of these components, the integrated detection device 504 is fixed to the analytical apparatus 500. The connector socket 505, separate type integrated electrode 506 and reaction field cell 507, on the other hand, are mechanically removable from the integrated detection device 504.

The configurations of the integrated detection device 504 and connector socket 505 are the same as those of the integrated detection device 104 and connector socket 105 in the analytical apparatus 100 described in the first embodiment as an example of the analytical apparatus using the first sensor unit.

That is, as shown in FIG. 18, the integrated detection device 504 is constructed by integrating a plurality (here 4 units) of the similarly constructed detection device parts 509 on a substrate 508, and as shown in FIG. 7 (a) and FIG. 7 (b), each detection device part 509 comprises a low-permittivity layer 510, a source electrode 511, a drain electrode 512, a channel 513, an insulation layer 514, a sensing gate (gate body) 515, a voltage application gate 518, and an insulator layer 520 that are each formed like the low-permittivity layer 110, source electrode 111, drain electrode 112, channel 113, insulation layer 114, sensing gate (gate body) 115, voltage application gate 118, and insulator layer 120 described in the first embodiment. By mounting the separate type integrated electrode 506 and reaction field cell 507 to the integrated detection device 504 via the connector socket 505, the sensing gate 515 constitutes a sensing gate for detection 517 (See FIG. 19) together with the corresponding electrode section 516 of the separate type integrated electrode 506.

The connector socket 505 is a connector located between the integrated detection device 504 and separate type integrated electrode 506 to connect the integrated detection device 504 and separate type integrated electrode 506, and has a mounting part 505A and a mounting part 505B formed in the same manner as the mounting part 105A and mounting part 105B described in the first embodiment and further wiring 521 (See FIG. 19) and a switch (not shown). The first, second, third, and fourth detection device parts 509 from the left in the figure of the integrated detection device 504 and the first, second, third, and fourth columns of the separate type integrated electrode 506 from the left, each column containing three electrode sections 516, are thereby made to correspond and can be brought into conduction respectively, and further conduction between the sensing gate 515 and the corresponding electrode section 516 can be switched. Therefore, the connector socket 505 functions as a conductive member and an electric connection switching part.

The configuration of the separate type integrated electrode 506 is the same as that of the separate type integrated electrode 106 described in the first embodiment except that no specific substance is immobilized on the electrode section (sensing part) 516 (corresponding to the electrode section 116 in FIG. 6). That is, as shown in FIG. 19, the separate type integrated electrode 506 comprises a substrate 522, the electrode section (sensing part) 516, and wiring 524 that are formed in the same manner as the substrate 122, electrode section (sensing part) 116, and wiring 124 described in the first embodiment.

Further the configuration of the reaction field cell 507 is the same as that of the reaction field cell 107 described in the first embodiment except that a reference electrode 527 is formed. That is, the reaction field cell 507 comprises a substrate 525 and a flow channel 519 that are formed in the same manner as the substrate 125 and flow channel 119 described in the first embodiment, and further the reference electrode 527 corresponding to each electrode section 516 is formed facing the top surface of the flow channel 519 opposite to each electrode section 516. A voltage is applied to each reference electrode 527 from a power source (not shown) provided in the analytical apparatus 500, and the voltage of the reference electrode 527 is controlled by the measuring circuit 502.

The reaction field cell 507 is formed integrally with the separate type integrated electrode 506 to constitute a reaction field cell unit 526. Thus, the reaction field cell unit 526 is mounted to the integrated detection device 504 via the connector socket 505 to use the analytical apparatus 500. The reaction field cell unit 526 is usually assumed to be used up (disposable). The reaction field cell 507 may also be formed separately from the separate type integrated detection device 504.

The analytical apparatus 500 and the sensor unit 501 in the present example are constructed as described above. Thus, to use the analytical apparatus 500, first the connector socket 505 and the reaction field cell unit 526 (that is, the separate type integrated electrode 506 and the reaction field cell 507) are mounted to the integrated detection device 504 to prepare the sensor unit 501. Then, an appropriate voltage is applied to the voltage application gate 516 so that the transfer characteristic of the transistor part 503 (that is, the substrate 508, low-permittivity layer 510, source electrode 511, drain electrode 512, channel 513, insulation layer 514, sensing gate for detection 517, and voltage application gate 518) can be maximized to feed a current through the channel 513. In this state, a sample is caused to flow in the flow channel 519 while characteristic of the transistor part 503 is measured using the measuring circuit 502 and applying a fixed voltage from the reference electrode 527.

The sample flows in the flow channel 519 and comes into contact with the electrode section 516. Since, at this point, a reference voltage is applied to the reference electrode 527, a voltage is applied to the electrode section 516 via the sample. If here the sample contains any detection target, an impedance of the sample on the electrode section 516 over which the detection target passes changes when the detection target passes over the electrode section 516 and thus the voltage applied to the electrode section 516 changes. Variations of the voltage are transmitted to the sensing gate 515 from the electrode section 516 via the wiring 524 and 521 as an electric signal and the gate voltage changes due to the electric signal in the sensing gate 515, leading to the change of the characteristic of the transistor part 503.

Thus, the detection target can be detected by measuring the change of the characteristic of the transistor part 503 using the measuring circuit 502. Particularly, since a carbon nano tube is used for the channel 513 in the present example, detection with extremely high sensitivity becomes possible and thus detection targets that have conventionally been difficult to be detected can now be detected. Therefore, the analytical apparatus 500 in the present example can be used for analysis of a wider range of detection targets than that of a conventional analytical apparatus.

According to the analytical apparatus 500 in the present example, operations and effects similar to those of the analytical apparatus 100 described in the first embodiment can be obtained except for those related to using specific substances.

However, the analytical apparatus 500 and the sensor unit 501 exemplified here are only an example of the sensor unit in the fifth embodiment and the above configuration can be arbitrarily modified without departing from the scope of the present invention. The configuration can be modified as described for each component of the sensor unit in the present embodiment, but among them, the configuration can be modified as shown below.

Instead of sensing a change of impedance caused by a flow of a detection target in the flow channel 519, for example, the analytical apparatus 500 and the sensor unit 501 may be constructed to sense a change of permittivity in the flow channel 519 caused by a flow of a detection target in the flow channel 519.

Also, an appropriate specific substance may be immobilized on a portion or all of the electrode section 516 as long as the function of the sensor unit 501 to detect the detection target is not impaired. Further, in this case, interactions between a specific substance and a detection target may be sensed, in addition to changes of the impedance and permittivity.

Further, the above configuration may be modified arbitrarily without departing from the scope of the present invention, as described in the first embodiment.

If the channel is formed of a carbon nano tube, the sensing gate and sensing part may be formed integrally with the substrate to which the source electrode and drain electrode are fixed. That is, the sensor unit may be comprised of a transistor part having a substrate, a source electrode and a drain electrode provided on the substrate, a channel formed of a carbon nano tube forming a current path between the source electrode and drain electrode, and gate fixed to the substrate (gate in which the sensing gate and sensing part are integrally formed: sensing gate for detection), and a reference electrode to which a voltage is applied to detect existence of detection targets by the change of the characteristic of the transistor part. By using a channel using a carbon nano tube, the transistor part in the above configuration can be made extremely sensitive to a change of permittivity and electric impedance. Therefore, with the above configuration, a sensor unit with detection sensitivity vastly superior to that of a conventional sensor unit can be obtained.

### Sixth Embodiment

A sensor unit according to a sixth embodiment of the present invention (hereinafter called “sixth sensor unit” as appropriate) comprises a transistor part having a substrate, a source electrode and a drain electrode provided on the substrate, a channel forming a current path between the source electrode and the drain electrode, and a sensing gate, and a cell unit mounting part for mounting a reaction field cell unit having a sensing part and a reference electrode to which a voltage is applied to detect existence of a detection target by the change of the characteristic of the transistor part. Further, when the reaction field cell unit is mounted in the cell unit mounting part, the sensing part and sensing gate are constructed to be in a conduction state.

The reaction field cell unit mounted in the sixth sensor unit, on the other hand, is a reaction field cell unit mounted in a cell unit mounting part of a sensor unit comprising a transistor part having a substrate, a source electrode and a drain electrode provided on the substrate, a channel forming a current path between the source electrode and the drain electrode, and a sensing gate, and the cell unit mounting part, and has a sensing part and a reference electrode to which a voltage is applied to detect existence of a detection target by the change of the characteristic of the transistor part. Further, when the reaction field cell unit is mounted in the cell unit mounting part, the sensing part and sensing gate are in a conduction state.

The transistor part is a part functioning as a transistor and, by detecting a change in output characteristic of the transistor, the sensor unit in the present embodiment detects the detection target. The transistor part can be distinguished between a transistor part functioning as a field-effect transistor and that functioning as a single-electron transistor based on a concrete configuration of a channel thereof, and either type of the transistors may be used in the sixth sensor unit. In descriptions that follow, the transistor part is simply called “transistor” as appropriate and, in that case, whether the transistor functions as a field-effect transistor or a single-electron transistor is not distinguished if not specifically mentioned.

Components of the sixth sensor unit and reaction field cell unit will be described below.

[A. Sixth Sensor Unit]

[I. Transistor Part]

(1. Substrate)

The substrate in the sixth sensor unit is the same as that described in the first to fifth embodiments.

(2. Source Electrode/Drain Electrode)

The source electrode and drain electrode in the sixth sensor unit are the same as those described in the first to fifth embodiments.

(3. Channel)

The channel in the sixth sensor unit is the same as that described in the first, second, fourth, and fifth embodiments. Thus, a channel having the same configuration as that described in the first, second, fourth, and fifth embodiments can be used and also the same production method as that in the first, second, fourth, and fifth embodiments can be used.

(4. Sensing Gate)

The sensing gate in the sixth sensor unit is the same as that described in the first, fourth, and fifth embodiments. Thus, the sensing gate constitutes a sensing gate for detection together with a sensing part possessed by the reaction field cell unit described later. That is, when some electric change resulting from a detection target is sensed by the sensing part of the reaction field cell unit in the sixth sensor unit, the electric change is transmitted to the sensing gate as an electric signal to change the gate potential of the sensing gate and, by detecting the change of the characteristic of the transistor caused by the gate voltage of the sensing gate, the detection target can be detected.

(5. Cell Unit Mounting Part)

The cell unit mounting part is a part for mounting a reaction field cell unit described later. Any cell unit mounting part that can mount a reaction field cell unit to the sixth sensor unit can be used, and any shape and dimensions can be selected for the cell unit mounting part.

In addition to mounting a reaction field cell unit directly to the cell unit mounting part, the reaction field cell unit may be mounted via another connecting member such as a connector. That is, how to mount a reaction field cell unit is arbitrary as long as the sensing gate and the sensing part possessed by the reaction field cell unit are set to a conduction state when the reaction field cell unit is mounted.

(6. Voltage Application Gate)

Like the first to fifth sensor units, the transistor part in the sixth sensor unit may have a voltage application gate. The voltage application gate provided in the transistor part of the sixth sensor unit is the same as that provided in the transistor part of the first to fifth sensor units.

(7. Integration)

The transistor described above is preferably integrated. That is, it is preferable that two or more source electrodes, drain electrodes, channels, sensing gates, and as appropriate, voltage application gates are provided on a single substrate, and further, it is more preferable to miniaturize them as much as possible. Component members of each transistor may be provided in such a way that they are shared by other transistors as appropriate and, for example, the sensing part of the sensing gate for detection and the voltage application gate may be shared by two or more of integrated transistors. Further, one type of transistors may be integrated, or two or more types of transistors may be integrated in any kinds of combination with any percentage each.

By integrating transistors as described above, at least one of advantages of miniaturization and lower costs of the sensor unit, speedy detection and improvement of detection sensitivity, simplification of operations and so on can be obtained. That is, since many sensing gates for detection can be provided at a time due to integration, for example, a multifunctional sensor unit that can detect many detection targets by one sensor unit can be provided at lower costs. Also, if integration is performed in such a way that many source electrodes and drain electrodes are connected in parallel, for example, detection sensitivity can be enhanced. Further, since the need for separately providing electrodes for comparison to be used for examination of analysis results and the like can be eliminated, for example, it becomes possible to compare results of a transistor with those of another transistor on the same sensor unit.

When integrating transistors, any arrangement of transistors and any kind of specific substance to be immobilized thereon, as needed, can be used. For example, one transistor may be used to detect one detection target or a plurality of transistors may be used to detect one detection target by electrically connecting the source electrodes and drain electrodes in parallel using an array of the plurality of transistors and detecting the same detection target by each sensing gate for detection.

There is no restriction on the concrete method of integration and any known method may be used, but usually a production method generally used for producing integrated circuits can be used. Recently, a method for incorporating mechanical elements into metals (conductors) and semiconductors called MEMS has been developed and the technique can also be used.

Further, when transistors are integrated, any wiring method may be used and it is usually preferable to devise arrangements and the like to reduce the influence of parasitic capacitance and parasitic resistance as much as possible. More specifically, it is preferable to use, for example, the air bridge technique or wire bonding technique to connect source electrodes and/or drain electrodes or to connect the sensing gates and sensing parts.

[II. Electric Connection Switching Part]

If, in the sixth sensor unit, the transistor parts are integrated or the reaction field cell unit mounted to the cell unit mounting part has a plurality of sensing parts, like the first, fourth, and fifth cell units, the sixth sensor unit preferably has an electric connection switching part for switching conduction between the sensing gate and sensing part. Miniaturization of the sensor unit, improvement of reliability of detected data, efficient detection and soon will there by be achieved. If transistors are integrated, the conduction may be switched not only within the same transistor, but also between transistors.

The same electric connection switching part as that possessed by the first, fourth, and fifth cell units can be used for the sixth sensor unit.

[B. Reaction Field Cell Unit]

The reaction field cell unit is a member to be mounted to the cell unit mounting part of the sixth sensor unit, and has a sensing part and a reference electrode. The reaction field cell unit is also a member to position a sample at a desired location for detection. Further, when the reaction field cell unit is mounted in the cell unit mounting part, the sensing part and sensing gate are in a conduction state. Meanwhile, the sample is a target to be detected using a sensor unit and if any detection target is contained in the sample, the detection target is detected using the sensor unit in the present embodiment.

If the reaction field cell unit can position a sample at a desired location for detection, there is no restriction on its concrete configuration. That is, if a sample can be positioned within an electric field of the reference electrode for detection or a voltage can be applied to the sensing part by the reference electrode via a sample, there is no restriction on its concrete configuration. The reaction field cell unit can be constructed, for example, as a container holding a sample at a desired location. If the sample is fluid, however, it is desirable to construct the reaction field cell unit as a member having a flow channel to cause the fluid to flow. By detecting an interaction by causing a sample to flow, advantages of speedy detection, simplification of operations and so on can be obtained.

(I. Sensing Part)

The sensing part in the present embodiment is a member that is formed separately from the substrate to which the source electrode and drain electrode are fixed and formed in the reaction field cell unit separately from the substrate, and the same as that described in the fifth embodiment. That is, the sensing part can be constructed as the same sensing part as that described in the first and fourth embodiments except that no specific substance needs to be immobilized on the sensing part. Thus, the material of the sensing part, number of sensing parts, shape, dimensions, means for conducting to the sensing gate are the same as those described in the first, fourth, and fifth embodiments. Further, if two or more sensing parts are provided, it is similarly preferable to provide two or more sensing parts by associating them with one sensing gate. Meanwhile, a specific substance may be immobilized on the sensing part as long as the function of the sensor unit to detect the detection targets is not impaired.

Since, in the present embodiment, the sensing part is provided in the reaction field cell unit, the sensing part is also mechanically removable from the sixth sensor unit by removing the reaction field cell unit from the sixth sensor unit. When the reaction field cell unit is mounted to the cell unit mounting part, the sensing part is set to an electric conduction state to the sensing gate of the sixth sensor unit.

(II. Reference Electrode)

The reference electrode in the present embodiment is an electrode to which a voltage is applied to detect existence of a detection target by the change of the characteristic of the transistor part. More specifically, the reference electrode is an electrode for applying a voltage to the sensing part and the reference electrode may be constructed in such a way that a voltage or an electric field is applied to the sensing part via a sample.

There is no restriction on the arrangement position of the reference electrode and may be formed at any position in the reaction field cell unit as long as detection of detection targets is not significantly affected. In order to enhance detection sensitivity, it is preferable to arrange the reference electrode and sensing part facing each other so that a sample is positioned between the reference electrode and sensing part. It is also preferable to place the reference electrode so close to the sensing part that a voltage can be applied to the sensing part with stability.

The reference electrode in the present embodiment can be formed using the same material, dimensions, and shape as those of the reference electrode described in the fifth embodiment. If the two or more sensing parts are provided, a reference electrode may similarly be constructed by associating the reference electrode with two or more sensing parts.

Further, the same mechanism for detection using the reference electrode as that described in the fifth embodiment can be used.

(III. Flow Channel)

There is no restriction on the shape and dimensions of the flow channel, and the number of flow channels, and it is desirable to form an appropriate flow channel in accordance with its purpose. Example of the flow channel described in the first embodiment can be mentioned as concrete examples of the flow channel. Further, the members forming a flow channel and the method for forming a flow channel are also the same as those described in the first embodiment.

[C. Detection Targets and Concrete Detection Examples]

A detection target is a substance to be detected by the sensor unit in the present embodiment. Like the fifth embodiment, no restriction is imposed on the detection targets of the sensor unit in the sixth embodiment and any substance may be selected as a detection target. Substances that are not pure may also be used as a detection target. Concrete examples thereof include those exemplified in the first to fifth embodiments.

Further, examples in the fifth embodiment can be mentioned as concrete detection examples.

If a carbon nano tube is used for the channel in the sensor unit in the present embodiment, extremely sensitive detection can be realized. Thus, a diagnosis can be performed at a time by functionality or disease by measuring immune items requiring high detection sensitivity and other items such as electrolytes at a time based on the same principle, realizing POCT. In addition, operations and effects similar to those of the fifth embodiment can be obtained.

In the present embodiment, for an example of the sensor unit used for measurement of the blood coagulation time described using FIG. 13, a transistor part 33 is comprised of the substrate 12, insulation layers 13 and 18, source electrode 14, drain electrode 15, SET channel 16, sensing gate 17, and voltage application gate 23, and a reaction field cell unit 34 is comprised of the sensing part 19, reaction field 21, and reference electrode 22. Further, a cell unit mounting part 35 for mounting the reaction field cell unit 34 is comprised of upper parts of the sensing gate 17 and insulation layer 18 and the reaction field cell unit 34 is mounted in the cell unit mounting part 35.

Also in the present embodiment, for an example of the sensor unit used for whole blood cell count measurement described using FIG. 16, a transistor part 36 is comprised of the substrate 12, insulation layers 13 and 18, source electrode 14, drain electrode 15, SET channel 16, sensing gate 17, and voltage application gate 23, and a reaction field cell unit 37 is comprised of the pair of upper and lower tabular frames 26 and 27, spacer 28, flow channel 29, sensing part 30, reference electrode 22, and wiring 31. Further, a cell unit mounting part 38 for mounting the reaction field cell unit 37 is comprised of upper parts of the sensing gate 17 and insulation layer 18 and the reaction field cell unit 37 is mounted in the cell unit mounting part 38.

[D. Examples of Analytical Apparatus]

As an example of the sixth sensor unit and reaction field cell unit, and an analytical apparatus using them, an example similar to one exemplified in the fifth embodiment can be mentioned. That is, the detection device part 509 comprising the substrate 508, low-permittivity layer 510, source electrode 511, drain electrode 512, channel 513, insulation layer 514, sensing gate 515, voltage application gate 518, and insulator layer 520 in the analytical apparatus 500 exemplified using FIG. 17 to FIG. 19 in the fifth embodiment functions as a transistor part 601 in the present embodiment, a sensor unit 602 comprising the integrated detection device 504 and the connector socket 505 functions as the sixth sensor unit, and a reaction field cell unit 526 comprising the separate type integrated electrode 506 and the reaction field cell 507 functions as a reaction field cell unit 603 in the present embodiment. The mounting part 505B provided on the upper part of the connector socket 505 is a part where the reaction field cell unit 603 is mounted to the sensor unit 602 and functions as a reaction field mounting part 604. Thus, the analytical apparatus 600 having these sensor unit 602 and reaction field cell unit 603 function as an analytical apparatus in the present embodiment.

Therefore, according to the sensor unit 602 and reaction field cell unit 603, and analytical apparatus 600, which is an example of the present embodiment, in addition to being usable for analysis of a wider range of detection targets, advantages of miniaturization of the sensor unit 602, speedy detection, simplification of operations and so on can be obtained due to integration of the transistor part 601 (that is, the detection device part 509).

Since the sensor unit 602 and reaction field cell unit 603 are removably formed as separate pieces, the reaction field cell unit 603 can be used as a disposable type like flow cells, thereby enabling miniaturization of the sensor unit 602 and analytical apparatus 600 to improve usability for users.

Further, since the reaction field cell unit 603 is disengageable and replaceable, the sensor unit 602 and analytical apparatus 600 can be produced at lower prices and further made expendable, and samples can be prevented from being biologically contaminated.

Also, operations and effects similar to those of the fifth embodiment can be obtained.

Further, as described in the fifth embodiment, the above configuration can be arbitrarily modified without departing from the scope of the present invention.

### Seventh Embodiment

A sensor unit according to a seventh embodiment of the present invention (hereinafter called “seventh sensor unit” as appropriate) comprises a transistor part having a substrate, a source electrode and a drain electrode provided on the substrate, a channel forming a current path between the source electrode and the drain electrode, and a sensing gate for detection and is a sensor unit for detecting the detection target. In the seventh sensor unit, two or more transistor parts are integrated and a reference electrode to which a voltage is applied to detect existence of a detection target as the change of the characteristic of the transistor parts.

Also in the seventh sensor unit, like the first to sixth sensor units, the transistor part is a part functioning as a transistor and, by detecting a change in output characteristic of the transistor, the sensor unit in the present embodiment detects the detection target. The transistor part can be distinguished between a transistor part functioning as a field-effect transistor and that functioning as a single-electron transistor based on a concrete configuration of a channel thereof, and either type of the transistors may be used in the seventh sensor unit. In descriptions that follow, the transistor part is simply called “transistor” as appropriate and, in that case, whether the transistor functions as a field-effect transistor or a single-electron transistor is not distinguished if not specifically mentioned.

[I. Transistor Part]

(1. Substrate)

The substrate in the seventh sensor unit is the same as that described in the first to sixth embodiments.

(2. Source Electrode/Drain Electrode)

The source electrode and drain electrode in the seventh sensor unit are the same as those described in the first to sixth embodiments.

(3. Channel)

The channel in the seventh sensor unit is the same as that described in the first, second, and fourth to sixth embodiments. Thus, a channel having the same configuration as that described in the first, second, and fourth to sixth embodiments can be used and also the same production method as that in the first, second, and fourth to sixth embodiments can be used.

(4. Sensing Gate for Detection)

The sensing gate for detection in the seventh sensor unit can be constructed like that in the fifth sensor unit.

Also, the seventh sensor unit may be constructed like the sensing gate of the fifth sensor unit. In this case, the seventh sensor unit is constructed so that the sensing gate itself can sense some electric change resulting from a detection target, thereby causing the gate voltage to change. Meanwhile, like the fifth embodiment, a specific substance may be immobilized on the sensing part as long as the function of the sensor unit to detect the detection target is not impaired.

(5. Voltage Application Gate)

Like the first to sixth sensor units, the transistor part in the seventh sensor unit may have a voltage application gate. The voltage application gate provided in the transistor part of the seventh sensor unit is the same as that provided in the transistor part of the first to sixth sensor units.

(6. Integration)

In the seventh sensor unit, the transistor parts are integrated. That is, two or more source electrodes, drain electrodes, channels, sensing gates for detection, and as appropriate, voltage application gates are provided on a single substrate, and further, it is more preferable to miniaturize them as much as possible. Component members of each transistor may be provided in such a way that they are shared by other transistors as appropriate and, for example, the sensing part of the sensing gate for detection and the voltage application gate may be shared by two or more of integrated transistors. Further, one type of transistors may be integrated, or two or more types of transistors may be integrated in any kinds of combination with any percentage each.

By integrating transistors as described above, various kinds of detection targets can be detected by one sensor unit, improving convenience when performing an analysis as compared with conventional sensor units. Also, at least one of advantages of miniaturization and lower costs of the sensor unit, speedy detection and improvement of detection sensitivity, simplification of operations and so on can be obtained. That is, since many sensing gates for detection can be provided at a time due to integration, for example, a multifunctional sensor unit that can detect many detection targets by one sensor unit can be provided at lower costs. Also, if integration is performed in such a way that many source electrodes and drain electrodes are connected in parallel, for example, detection sensitivity can be enhanced. Further, since the need for separately providing electrodes for comparison to be used for examination of analysis results and the like can be eliminated, for example, it becomes possible to compare results of a transistor with those of another transistor on the same sensor unit.

When integrating transistors, any arrangement of transistors and any kind of specific substance to be immobilized thereon, as needed, can be used. For example, one transistor may be used to detect one detection target or a plurality of transistors may be used to detect one detection target by electrically connecting the source electrodes and drain electrodes in parallel using an array of the plurality of transistors and detecting the same detection target by each sensing gate for detection.

There is no restriction on the concrete method of integration and any known method may be used, but usually a production method generally used for producing integrated circuits can be used. Recently, a method for incorporating mechanical elements into metals (conductors) and semiconductors called MEMS has been developed and the technique can also be used.

Further, when transistors are integrated, any wiring method may be used and it is usually preferable to devise arrangements and the like to reduce the influence of parasitic capacitance and parasitic resistance as much as possible. More specifically, it is preferable to use, for example, the air bridge technique or wire bonding technique to connect source electrodes and/or drain electrodes or to connect the sensing gates and sensing parts.

[II. Reference Electrode]

The reference electrode is an electrode to which a voltage is applied to detect existence of a detection target as the change of the characteristic of the transistor part. More specifically, the reference electrode is an electrode for applying a voltage to the sensing gate for detection and the reference electrode may be constructed in such a way that the voltage or an electric field is applied to the sensing gate for detection via a sample. Further, the reference electrode can also be used as a standard electrode or to keep the voltage of a sample constant.

The arrangement location of the reference electrode is not restricted as long as detection targets can be detected. The reference electrode may be formed on the substrate, but is usually formed separately from the substrate. However, it is preferable to arrange the reference electrode and sensing gate for detection facing each other and to construct the sensor unit so that a sample is positioned between the reference electrode and sensing gate for detection to enhance detection sensitivity. It is also preferable to place the reference electrode so close to the sensing gate for detection that a voltage or an electric field can be applied to the sensing gate for detection with stability.

Further, the reference electrode is formed as an electrode insulated from the channel, source electrode, and drain electrode, and there is no restriction on the material, dimensions, and shape of the reference electrode. Usually, the reference electrode can be formed, like the reference electrode in the fifth embodiment, using the same material, dimensions, and shape as those described in the voltage application gate in the first embodiment.

In the seventh sensor unit, transistor parts provided are integrated. A plurality of reference electrodes may be provided for each sensing gate for detection, but the reference electrode may be constructed in such a way that one reference electrode corresponds to two or more sensing gates for detection. The sensor unit can thereby be made smaller.

[III. Electric Connection Switching Part]

If the sensing gate for detection in the seventh sensor unit is constructed like the fifth sensor unit, an electric connection switching part may be provided in the seventh sensor unit like the fifth sensor unit. In this case, the electric connection switching part provided to the seventh sensor unit is the same as that described in the fifth embodiment.

[IV. Reaction Field Cell]

The seventh sensor unit may have a reaction field cell. Any reaction field cell that can position a sample at any desired location for detection, that is, the sample can be positioned within an electric field of the reference electrode or the reference electrode can apply a voltage to the sensing gate for detection via the sample, can be used.

If the sample is fluid, however, it is desirable to construct the reaction field cell as a member having a flow channel to cause the fluid to flow. By detecting an interaction by causing a sample to flow, advantages of speedy detection, simplification of operations and so on can be obtained.

If the reaction field cell has a flow channel, there is no restriction on its shape, dimensions, number of flow channels, material of members forming the flow channel, production method of the flow channel and so on, and usually the same flow channel as that described in the first and fourth to sixth embodiments is used.

Further, the reference electrode may be formed in the reaction field cell. The reference electrode can thereby be removed together with removal of the reaction field cell, leading to simplification of operations.

[V. Detection Targets and Concrete Detection Examples]

A detection target is a substance to be detected by the sensor unit in the present embodiment. No restriction is imposed on the detection targets of the sensor unit in the seventh embodiment and any substance may be selected as a detection target. Substances that are not pure may also be used as a detection target. Concrete examples thereof include those exemplified in the first to sixth embodiments.

Further, examples in the fifth embodiment can be mentioned as concrete detection examples.

If a carbon nano tube is used for the channel in the sensor unit in the present embodiment, extremely sensitive detection can be realized. Thus, a diagnosis can be performed at a time by functionality or disease by measuring immune items requiring high detection sensitivity and other items such as electrolytes at a time based on the same principle, realizing POCT. In addition, operations and effects similar to those in the fifth and sixth embodiments can be obtained.

The seventh sensor unit has two or more integrated transistor parts. Thus, for an example of the sensor unit used for measurement of the blood coagulation time described using FIG. 13, integration of the transistor part 24 comprised of the substrate 12, insulation layers 13 and 18, source electrode 14, drain electrode 15, SET channel 16, sensing gate for detection 20 (that is, the sensing gate 17 and sensing part 19), and voltage application gate 23 corresponds to an example of the seventh sensor unit. For an example of the sensor unit used for whole blood cell count measurement described using FIG. 16, integration of the transistor part 32 comprised of the substrate 12, insulation layers 13 and 18, source electrode 14, drain electrode 15, SET channel 16, sensing gate for detection 20 (that is, the sensing gate 17 and sensing part 19), and voltage application gate 23 corresponds to an example of the seventh sensor unit.

[VI. Examples of Analytical Apparatus]

The configuration of an example of the seventh sensor unit and an analytical apparatus using the seventh sensor unit is shown below, but the present invention is not limited to the example shown below and, as mentioned in a description of each component, the configuration may be modified arbitrarily without departing from the scope of the present invention.

FIG. 9 is a figure schematically showing the configuration of main components of an analytical apparatus 700 using the seventh sensor unit and FIG. 20 is an exploded perspective view schematically showing the configuration of main components of the seventh sensor unit. Further, FIG. 7 (a) and FIG. 7 (b) are figures schematically showing main components of a detection device part, and FIG. 7 (a) is a perspective view thereof and FIG. 7 (b) is a side view. In FIG. 7, FIG. 9, and FIG. 20, components denoted by the same numerals represent the same components.

As shown in FIG. 9, the analytical apparatus 700 comprises a sensor unit 701 instead of the sensor unit 501 of the analytical apparatus 500 described in the fifth embodiment. That is, the analytical apparatus 700 comprises the sensor unit 701 and a measuring circuit 702, and is constructed to be able to flow a sample by a pump (not shown) as shown by arrows. Here, the measuring circuit 702 is a circuit (transistor characteristic detection part) for detecting any change of the characteristic of the transistor part (See a transistor part 703 in FIG. 20) inside the sensor unit 701 while controlling a voltage applied to a reference voltage 717 and is constructed, like the measuring circuit 502 in the fifth embodiment, of any resistor, capacitor, ammeter, voltmeter and the like in accordance with a purpose.

As shown in FIG. 20, the sensor unit 701 comprises the integrated detection device 704 and reaction field cell 705. Of these components, the integrated detection device 704 is fixed to the analytical apparatus 700. The reaction field cell 705, on the other hand, is mechanically removable from the integrated detection device 704.

The integrated detection device 704 is constructed by integrating a plurality (here 4 units) of the similarly constructed transistor parts 703 in an array on a substrate 706. In the sensor unit 701 in the present example, it is assumed that a total of 12 transistor parts 703, in four columns with three transistor parts 703 in each column, are formed.

As shown in FIG. 7 (a) and FIG. 7 (b), the transistor parts 703 integrated on the substrate 706 has a low-permittivity layer 707, a source electrode 708, a drain electrode 709, a channel 710, and an insulation layer 711 formed on the substrate 706. These low-permittivity layer 707, source electrode 708, drain electrode 709, channel 710, and insulation layer 711 are formed in the same manner as the low-permittivity layer 110, source electrode 111, drain electrode 112, channel 113, and insulation layer 114 described in the first embodiment.

Further, a sensing gate for detection 712 formed of a conductor (for example, gold) is formed on the upper surface of the insulation layer 711 as a top gate. That is, the sensing gate for detection 712 is formed on the low-permittivity layer 707 via the insulation layer 711.

On the underside of the substrate 706 (that is, a surface opposite to the channel 710), a voltage application gate 713 formed of a conductor (for example, gold) is provided as a back gate. Further, an insulator layer 714 is formed on the surface of the low-permittivity layer 707. The voltage application gate 713 and the insulation layer 714 are formed in the same manner as the voltage application gate 118 and the insulator layer 120 described in the first embodiment respectively. Thus, the surface of the sensing gate for detection 712 is open to the outside, instead of being covered with the insulator layer 714. The insulator layer 714 is denoted by chain double-dashed lines in FIG. 7 (a) and FIG. 7 (b). It is also possible to have the back gate carry out other functions than the voltage application gate.

The reaction field cell 705 is constructed by forming a flow channel 716 fitting to the transistor part 703 on a base 715. More specifically, the flow channel 716 formed in such a way that a sample flowing in the flow channel 716 can come into contact with each transistor part 703. The flow channel 716 is provided in such a way that the flow channel 716 passes one of three transistor parts each from left to right in the figure.

Further, in the reaction field cell 705, the reference electrode 717 corresponding to each transistor part 703 is formed facing the top surface of the flow channel 716 opposite to each transistor part 703. A voltage is applied to each reference electrode 717 from a power source (not shown) provided in the analytical apparatus 700, and the voltage of the reference electrode 717 is controlled by the measuring circuit 702.

The analytical apparatus 700 and the sensor unit 701 in the present example are constructed as described above. Thus, to use the analytical apparatus 700, first the reaction field cell unit 705 is mounted to the integrated detection device 704 to prepare the sensor unit 701. Then, an appropriate voltage is applied to the voltage application gate 713 so that the transfer characteristic of the transistor part 703 can be maximized to feed a current through the channel 710. In this state, a sample is caused to flow in the flow channel 716 while measuring characteristic of the transistor part 703 using the measuring circuit 702.

The sample flows in the flow channel 716 and comes into contact with the sensing gate for detection 712. Since, at this point, a reference voltage is applied to the reference electrode 717, a voltage is applied to the sensing gate for detection 712 via the sample. If here the sample contains any detection target, an impedance of the sample on the sensing gate for detection 712 over which the detection target passes changes when the detection target passes over the sensing gate for detection 712 and thus the voltage applied to the sensing gate for detection 712 changes. Variations of the voltage cause changes of the gate voltage, leading to the change of the characteristic of the transistor part 703.

Thus, the detection target can be detected by measuring the change of the characteristic of the transistor part 703 using the measuring circuit 702. Particularly, since a carbon nano tube is used for the channel 710 in the present example, detection with extremely high sensitivity becomes possible and thus detection targets that have conventionally been difficult to be detected can now be detected. Therefore, the analytical apparatus 700 in the present example can be used for analysis of a wider range of detection targets than that of a conventional analytical apparatus.

Further, with integration of the transistor part 703, advantages of miniaturization of the sensor unit 701, speedy detection, simplification of operations and so on can be obtained.

According to the analytical apparatus 700 in the present example, operations and effects similar to those of the analytical apparatus 200 described in the second embodiment can be obtained.

However, the analytical apparatus 700 and the sensor unit 701 exemplified here are only an example of the sensor unit in the seventh embodiment and the above configuration can be arbitrarily modified without departing from the scope of the present invention. Thus, the configuration can be modified as the second or fifth embodiment, or as described for each component of the sensor unit in the present embodiment.

Also the sensor unit 501 exemplified in the fifth embodiment is an example of the seventh sensor unit. That is, the sensor unit 501 exemplified in the fifth embodiment is an example of the seventh sensor unit that detects a detection target using a change in impedance between the reference electrode 527 and sensing gate for detection 517.

[Application Field]

The sensor units and reaction field cell units of the present invention, and analytical apparatuses using them can be used in any field. For example, they can be used for analysis of almost all fluid samples including blood (whole blood, plasma, and serum), lymph, saliva, urine, stool, sweat, mucus, tears, cerebrospinal fluid, nasal secretion, cervical or vaginal secretion, semen, pleural fluid, amniotic fluid, ascites, tympanic fluid, joint fluid, gastric aspirate, and bio fluids such as extracts and fragmentation fluid of tissues, cells and the like. The present invention can be used in the following fields, for example.

If the sensor unit of the present invention is used as a biosensor including clinical laboratory tests of fluid samples including blood (whole blood, plasma, and serum), lymph, saliva, urine, stool, sweat, mucus, tears, cerebrospinal fluid, nasal secretion, cervical or vaginal secretion, semen, pleural fluid, amniotic fluid, ascites, tympanic fluid, joint fluid, gastric aspirate, and bio fluids such as extracts and fragmentation fluid of tissues, cells and the like, a measurement can be made by measuring the sensing part or sensing site where one or more measurement items from pH, electrolytes, dissolved gases, organic substance, hormones, allergen, pigments, drugs, antibiotics, enzyme activity, proteins, peptides, mutagens, microbial cells, blood cells, blood group, blood coagulation ability, and gene analysis are integrated by disease or functionality at two or more gates at the same time or sequentially. Anion sensor, an enzyme sensor, a microbial sensor, an immune sensor, an enzyme immuno sensor, a luminescence immunosensor, a microbe counting sensor, blood coagulation electrochemical sensing, and electrochemical sensors using various electrochemical reactions can be considered as individual measurement principles at the integrated sensing part or sensing site respectively, and all principles that can eventually extract an electric signal are included {reference: Shuichi Suzuki, Biosensor Kodansha (1984); Karube et al., Development and practical application of sensors, Vol. 30, No. 1, Bessatsu Kagaku Kogyo (1986)}.

Screening inspection when a liver disease is suspected can be mentioned as a method of using the biosensor by making measurements by disease. When a liver disease is suspected, factors include hypertrophic fatty liver, alcoholic liver injury, viral hepatitis, and other subclinical liver diseases (primary biliary cirrhosis, autoimmune hepatitis, chronic heart failure, and inborn errors of metabolism). An ALT increase is present for a diagnosis of hypertrophic fatty liver and γGTP increases most sensitively for detection of alcoholic liver injury. A hepatitis virus marker test such as an HBs antigen and HCV antibody is indispensable for a diagnosis of viral hepatitis because not a few normal cases of ALT exist. For detection of subclinical liver diseases, ALT, AST and γGTP are combined. That is, for screening inspection of liver diseases, biochemical items examining enzyme activity of ALT, AST and γGTP, and immune items of the HBsAg and anti-HCV requiring high sensitivity are measured at the same time.

Further, if the sensor unit, reaction field cell unit, and analytical apparatus are made more sensitive by, for example, adopting a carbon nano tube, measurement items that conventionally required a lot of time and effort using a plurality of measuring apparatuses can be analyzed by the sensor unit described above.

For example, chemical reaction measurement and immunological reaction measurement can be made to be analyzable by the sensor unit described above.

For example, it is possible to make measurements of at least one measurement group selected from measurement groups consisting of an electrolytic concentration measurement group, a biochemical item measurement group using chemical reactions such as an enzyme reaction, a blood gases concentration measurement group, a blood cell count measurement group, a blood coagulation ability measurement group, an immunological reaction measurement group, a nucleic acid-nucleic acid hybridization reaction measurement group, a nucleic acid-protein interaction measurement group, and a receptor-ligand interaction measurement group analyzable by the sensor unit described above.

For example, it is also possible to make detection of two or more detection targets selected from a group consisting of at least one detection target selected from the electrolytic concentration measurement group, at least one detection target selected from the biochemical item measurement group, at least one detection target selected from the blood gases concentration measurement group, at least one detection target selected from the blood cell count measurement group, at least one detection target selected from the blood coagulation ability measurement group, at least one detection target selected from the nucleic acid-nucleic acid hybridization reaction measurement group, at least one detection target selected from the nucleic acid-protein interaction measurement group, at least one detection target selected from the receptor-ligand interaction measurement group, and at least one detection target selected from the immunological reaction measurement group analyzable by the sensor unit. That is, two or more detection targets in the same measurement group may be detected or two or more detection targets in different measurement groups may be detected.

Further, it is possible to make measurements of at least one measurement group selected from groups consisting of the electrolytic concentration measurement group, biochemical item measurement group using chemical reactions such as an enzyme reaction, blood gases concentration measurement group, blood cell count measurement group, and blood coagulation ability measurement group, and at least one measurement group selected from groups consisting of the nucleic acid-nucleic acid hybridization reaction measurement group, nucleic acid-protein interaction measurement group, receptor-ligand interaction measurement group, and immunological reaction measurement group analyzable by the sensor unit. It was conventionally difficult to detect detection targets contained in measurement groups such as the nucleic acid-nucleic acid hybridization reaction measurement group, nucleic acid-protein interaction measurement group, receptor-ligand interaction measurement group, and immunological reaction measurement group because extremely high sensitivity is required. Thus, such measurement groups could not be measured together with other measurement groups using the same sensor unit. However, according to the sensor unit in the present invention, high sensitivity can be provided by using a carbon nano tube or the like for the channel and two or more detection targets can be detected by the same sensor unit due to integration. Thus, a sensor unit and an analytical apparatus that can detect even detection targets contained in measurement groups that are difficult to be analyzed by the same sensor unit according to a conventional technique can be provided. However, it is desirable to detect detection targets that require extremely high sensitivity among the biochemical item measurement group and the like considered to be measurable without using a carbon nano tube by a transistor part using a carbon nano tube or the like, for the channel when detecting such detection targets requiring such high sensitivity.

It is also possible to make two or more detection targets selected for discriminating a specific disease or function detectable. When discriminating liver diseases, for example, GOT, GPT, γ-GTP, ALP, total bilirubin, direct reacting bilirubin, ChE, and total cholesterol in the biochemical item group and the coagulation time (PT, APTT) in the blood coagulation ability measurement group are measured, and also hepatitis virus related markers (such as anti-HAVIgM, HBsAg, anti-HBs, anti-HBc, and anti-HCV) in the immunological reaction measurement group are measured.

However, many items including those that will be newly discovered in the future exist in the biochemical item group and the like, and measurement items appropriate for each disease (such as renal/urinary tract disorders, hematologic/hematopoietic organ disorders, endocrime disorders, collagen disease/autoimmune disease, cardiovascular disorders, and infectious disease) should be selected. Items to be selected for each of these diseases include items well-known as clinical laboratory test items, as described in “Jissen, Rinsho Kensa (Inc.) Jihou, issued in 2001” and “Nippon Rinsho Vol. 53, Suppl 1995, Comprehensive Manual for Biochemical and Immunological Aspects of Clinical Pathology”. If the disease cannot be diagnosed, measurement items can still be selected based on symptoms such as fever and convulsion, as described in “Kenji Taki: How to conduct differential diagnosis based on symptoms helpful for emergency outpatient service, Yodosha.”

When actually preparing an analytical apparatus using a sensor unit in the present invention, any channel may be used as a channel in a transistor part used for detection of detection targets that do not require high detection sensitivity, but it is preferable to use a carbon nano tube for a channel of the transistor part used for detection of detection targets that require high detection sensitivity. High detection sensitivity can be realized with a transistor part using a channel of a nano tube structure such as a carbon nano tube, as described above, and particularly a transistor part using a carbon nano tube channel can reliably achieve high sensitivity.

When using an analytical apparatus in the present invention in fields such as medical care, there are times when detection targets included in the measurement group requiring high detection sensitivity (hereinafter called “high-sensitivity measurement group” as appropriate) such as the nucleic acid-nucleic acid hybridization reaction measurement group, nucleic acid-protein interaction measurement group, receptor-ligand interaction measurement group, and immunological reaction measurement group, and those included in the measurement group not requiring high detection sensitivity (hereinafter called “low-sensitivity measurement group” as appropriate) such as the electrolytic concentration measurement group, biochemical item measurement group, blood gases concentration measurement group, blood cell count measurement group, and blood coagulation ability measurement group should be detected in a series of operations.

The analytical apparatus to be used in such cases preferably has a sensor chip having a transistor part (first transistor part) adapted for the high-sensitivity measurement group and a transistor part (second transistor part) adapted for the low-sensitivity measurement group.

Citing a concrete example of such an analytical apparatus, if a carbon nano tube is used for the channels 113, 210, 310, 513, and 710 of the transistor parts 103, 203, 303, 401, 503, 601, and 703 corresponding to part of the flow channels (for example, the first flow channel from the front side in the figure) among the flow channels 119, 218, 316, 519, and 716 in the analytical apparatuses 100 to 700, the detection target contained in the high-sensitivity measurement group can be detected by using the transistor parts 103, 203, 303, 401, 503, 601, and 703 corresponding to the part of the flow channels of the sensor units 101, 201, 301, 402, 501, 602, and 701 as the first transistor part. At this point, the source electrodes 111, 208, 308, 511, and 708, the drain electrodes 112, 209, 309, 512, and 709, and the channels 113, 210, 310, 513, and 710 constituting the first transistor parts 103, 203, 303, 401, 503, 601, and 703 function as the first source electrode, the first drain electrode, and the first channel respectively.

If the transistor parts 103, 203, 303, 401, 503, 601, and 703 corresponding to other flow channels (for example, the second and third flow channels from the front side in the figure) in the analytical apparatuses 100 to 700 are used as the second transistor part to detect the detection target contained in the low-sensitivity measurement group, an analytical apparatus that can measure both the high-sensitivity measurement group and low-sensitivity measurement group using the same sensor units 101, 201, 301, 402, 501, 602, and 701 can be realized. At this point, however, the source electrodes 111, 208, 308, 511, and 708, the drain electrodes 112, 209, 309, 512, and 709, and the channels 113, 210, 310, 513, and 710 constituting the second transistor parts 103, 203, 303, 401, 503, 601, and 703 corresponding to the other flow channels function as the second source electrode, the second drain electrode, and the second channel respectively. The second channel may be formed of a carbon nano structure such as a carbon nano tube or any other materials.

[About POCT]

Since improvement of convenience and miniaturization of the sensor unit and analytical apparatus can now be realized, as described above, advantages can also be obtained from the perspective of POCT (point of care test).

That is, trends of POCT (miniaturization/speedup) of clinical laboratory tests are considered to accelerate when viewed from the perspective of performing tests near the patient in the clinical diagnostic field and various kinds of equipment are being developed.

Measurement targets in the clinical diagnostic field include various measurement groups described above such as the electrolytes/blood gases, blood coagulation ability, blood cell count, biochemical items and immune items. According to a conventional technique, different measuring methods are used for different items and thus different apparatuses are used, and it is impossible to measure all test items for each disease at a time based on the same principle and a real POCT has yet to be realized.

If a liver disease is suspected, for example, biochemical items such as AST (aspartate aminotransferase), ALT (alanine aminotransferase), and γ-GTP are measured by a colorimetric method and the viral hepatitis item is measured by a highly sensitive detection method such as chemiluminescence. As described above, individual methods have been combined for a specific diagnosis for measurement. This is because there are technical limitations to detection sensitivity of immune items using an antigen-antibody reaction requiring extremely high detection sensitivity and measurements cannot be made together with other electrolytes/blood gases, blood coagulation ability, blood cell count, and biochemical items at a time using the same principle.

In contrast, if a carbon nano tube is used for a channel in the sensor unit in the present invention, extremely highly sensitive detection can be realized. Thus, by performing a diagnosis at a time by functionality or disease using the same principle for the immune items requiring high detection sensitivity and other items such as electrolytes, POCT can be realized.

That is, by adopting a single-electron transistor (CNT-SET) using a carbon nano tube or a field-effect transistor (CNT-FET) using a carbon nano tube for detection of immune items using an antigen-antibody reaction requiring extremely high detection sensitivity, the CNT-SET, CNT-FET, a field-effect transistor (FET) described in Japanese Patent No. 3137612 that has been used, or an electrode method for the other electrolytes/blood gases, blood coagulation ability, blood cell count, and biochemical items, and further combining integration of the transistor parts, that is, integration of the CNT-SET, CNT-FET, other transistors, and amperometric electrodes method, separation of a reaction field cell or a reaction field cell unit containing integrated transistor parts, and processing technique to realize micro-flow for supplying reagents to each reaction field cell, a plurality of different measurement items including detection of items requiring high detection sensitivity can be measured at a time.

It is preferable to measure all detection targets using the CNT-FET or CNT-SET in light of detection with high accuracy, but if the CNT-FET or CNT-SET is used at least for detection of detection targets such as immune items requiring high sensitivity, and for other detection targets, another method such as a conventionally well-known amperometric electrode method may be used or the CNT-FET or CNT-SET not using a carbon nano tube may be used.

Particularly, regarding a clinical laboratory test field where immunological measurement is applied, methods described in “Igaku-Shoin Rinsho Kensa 2003 Vol. 47 No. 13” can be mentioned as conventional methods. Main conventional technologies in the clinical laboratory test field include: quantitation methods such as nephelometry, and latex agglutination for optically detecting light scattering, and a method for measuring a marker such as radio immunoassay (RIA), enzyme immunoassay (EIA), luminescence enzyme immunoassay, corpuscular enzyme immunoassay, time-resolved fluoro immunoassay, fluorescent polarization immunoassay, evanescent wave fluorescent immunoassay, chemiluminescence immunoassay, electrochemical luminescence immunoassay, immunochromatography.

Unfortunately, these conventional methods have disadvantages such as unsatisfactory detection sensitivity, requiring a relatively large quantity of samples or reagents, higher costs because a special detection component is required due to detection of feeble light, and a size of the apparatus which is too large to easily carry. Though immunochromatography has advantages such as usability and lower costs, but cannot be used for measurement of quantitative detection with high accuracy.

As compared with this, according to a technique in the present invention, the above problems in the clinical laboratory test field can be solved. That is, since integration and miniaturization can be realized due to transistor construction, the transistor itself works as an amplifier, and also small flow channels can be formed, analysis can be performed with a smaller quantity of samples and reagents.

### EXAMPLES

Examples of the present invention will be described below in more detail by showing some examples, but the present invention is not limited to the following examples and can be modified arbitrarily without departing from the scope of the present invention. Drawings are used for a description of the following examples and numerals in portions of the drawings are shown in the description below with parentheses (< and >).

### First Example

### 1. Sensor Production

(Preparation of a Substrate)

After oxidizing the surface of an n-type Si (100) substrate by soaking in an acid obtained by mixing sulfuric acid and hydrogen peroxide in a volume ratio of 1:4 for 5 min., the substrate is rinsed with running water for 5 min. and then an oxide film is removed by an acid obtained by mixing hydrofluoric acid and deionized water in a volume ratio of 4:1 before the surface of the Si substrate is rinsed with running water for 5 min. The surface of the rinsed Si substrate is thermally oxidized using an oxidization furnace at 1100° C. for 30 min. with flow rate 3 L/min. to form a film of SiO₂ with thickness of about 100 nm as an insulation layer.

(Formation of a Channel)

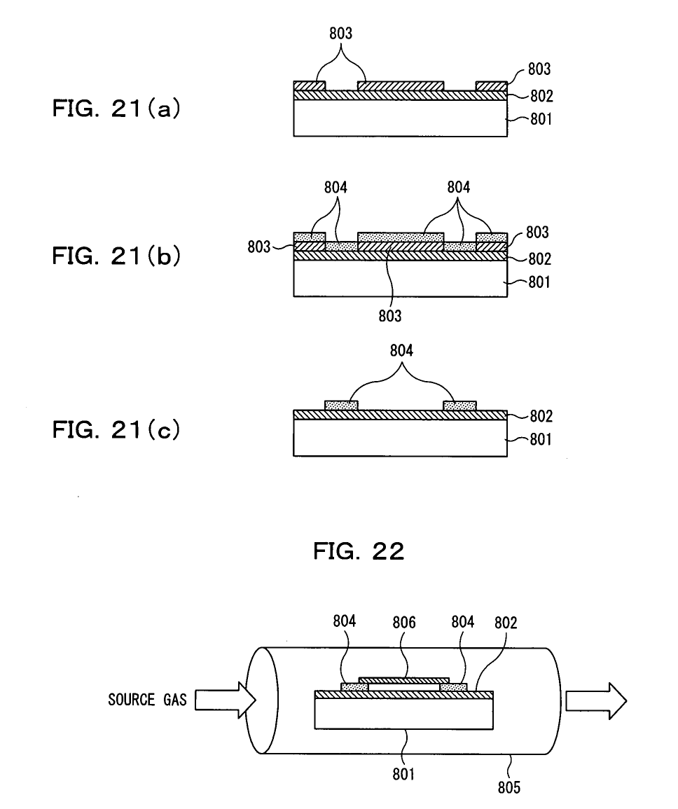

Subsequently, a channel was formed on the surface of the insulation layer as shown below. FIG. 21 (a) to FIG. 21 (c) are schematic sectional views for illustrating a formation method of a channel in the present example. A numeral 801 denotes a substrate and a numeral 802 denotes an insulation layer.

First, as shown in FIG. 21 (a), a photo resist <803> was patterned on the surface of the insulation layer <802> by photolithography to form a carbon nano tube growth catalyst. That is, the insulation layer <802> was spin-coated with hexamethyldisilazane (HMDS) at 500 rpm for 10 sec. and at 4000 rpm for 30 sec. and thereupon, a photo resist (microposit S1818 manufactured by Shipley Far East Co.) <803> was spin-coated under the same conditions.

After spin-coating, the Si substrate <801> was put on a hot plate to bake the substrate at 90° C. for 1 min. After baking, the Si substrate <801> coated with the photo resist <803> was soaked in monochlorobenzene for 5 min., and after drying by nitrogen blowing, the Si substrate <801> was put into an oven to bake at 85° C. for 5 min. After baking, a catalyst pattern was exposed to light using an aligner to develop in a developer (AZ300MIF developer (2.38%) manufactured by Clariant Co.) for 4 min. before being rinsed with running water for 3 min. and dried by nitrogen blowing.

Next, as shown in FIG. 21 (b), Si, Mo, and Fe catalysts <804> were evaporated onto the Si substrate <801> on which the photo resist <803> is patterned as described above using an EB vacuum evaporator so that thickness of each is given as Si/Mo/Fe=100 Å/100 Å/30 Å(1 Å=10⁻¹⁰ m).

After evaporating, as shown in FIG. 21 (c), the Si substrate <801> was lifted off while boiling acetone and the sample was washed by acetone, ethanol, and running water in this order each for 3 min. before being dried by nitrogen blowing.

FIG. 22 is a figure illustrating the process of forming a carbon nano tube <806> in the present example. As shown in FIG. 22, the Si substrate <801> with patterning of the catalyst <804> was placed into a CVD furnace <805> to grow the carbon nano tube <806> to become a channel at 900° C. for 20 min. while flowing ethanol bubbled using Ar at 750 cc/min. and hydrogen at 500 cc/min. At this point, temperature was raised and lowered under flowing Ar at 1000 cc/min. In a description that follows, a channel formed of a carbon nano tube will be denoted by the same numeral <806> as the carbon nano tube.

(Formation of a Source Electrode, a Drain Electrode, and a Side Gate Electrode)

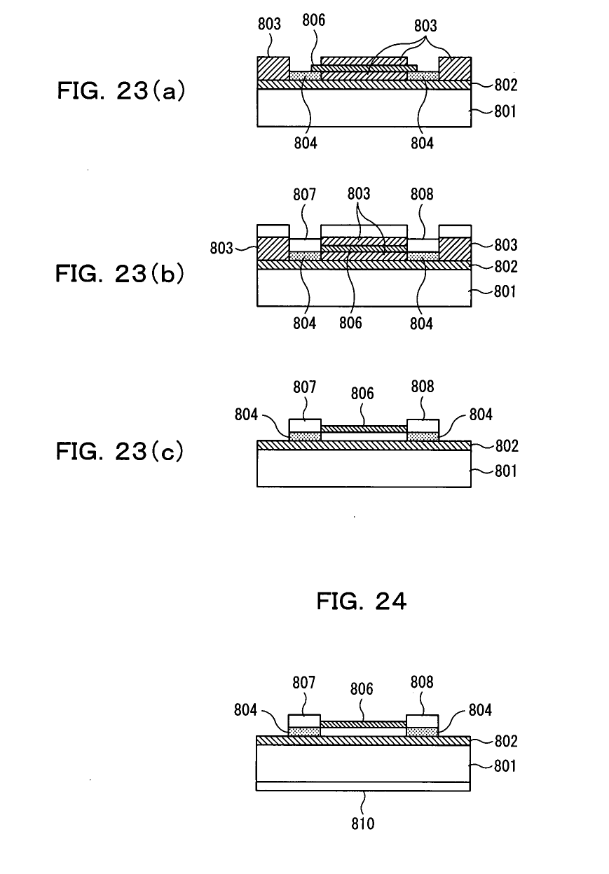

FIG. 23 (a) to FIG. 23 (c) are schematic sectional views for illustrating a formation method of a detection device part (transistor part) in the present example. As shown in FIG. 23 (a), after growing the carbon nano tube <806>, the photo resist <803> was patterned again on the Si substrate <801> by the photolithography to produce a source electrode <807>, a drain electrode <808>, and a side gate electrode <809> (See FIG. 26).

After patterning, as shown in FIG. 23 (b), the source electrode <807>, drain electrode <808>, and side gate electrode <809> were evaporated onto the Si substrate <801> (See FIG. 26) by EB evaporation in order of Ti and Au with Ti/Au=300 Å/3000 Å, Ti evaporation rate 0.5 Å/sec. and Au evaporation rate 5 Å/sec.

After evaporating, as shown in FIG. 23 (c), like the preceding step, the Si substrate <801> was lifted off while boiling acetone and the sample was washed by acetone, ethanol, and running water each for 3 min. before being dried by nitrogen blowing.

After patterning of the source electrode <807>, drain electrode <808>, and side gate electrode <809>, the surface of the Si substrate <801> was spin-coated with HMDS at 500 rpm for 10 sec. and 4000 rpm for 30 sec. to protect the elements and thereupon, the photo resist <803> was spin-coated under the same conditions. Then, the photoresist was baked in an oven at 110° C. for 30 min. to form an element protective layer (not shown).

(Production of a Back Gate Electrode)

An SiO₂ film <802> (not shown) unintentionally attached to the underside of the Si substrate <801> was removed by dry etching using a RIE (reactive ion etching) device. An etchant used at this point was SF₆ and etching was performed for 6 min. in a plasma of RF output 100 W. After removing the SiO₂ film <802> on the underside, a back gate electrode <810> was evaporated onto the Si substrate <801> by EB evaporation in order of Pt and Au with Pt/Au=300 Å/2000 Å, Pt evaporation rate 0.5 Å/min. and Au evaporation rate 5 Å/min. The result is shown in FIG. 24. FIG. 24 is a schematic sectional view for illustrating the substrate <801> on which the back gate <810>, which is a sensing gate for detection (sensing gate) in the present example, is formed.

(Formation of a Channel Protective Layer)

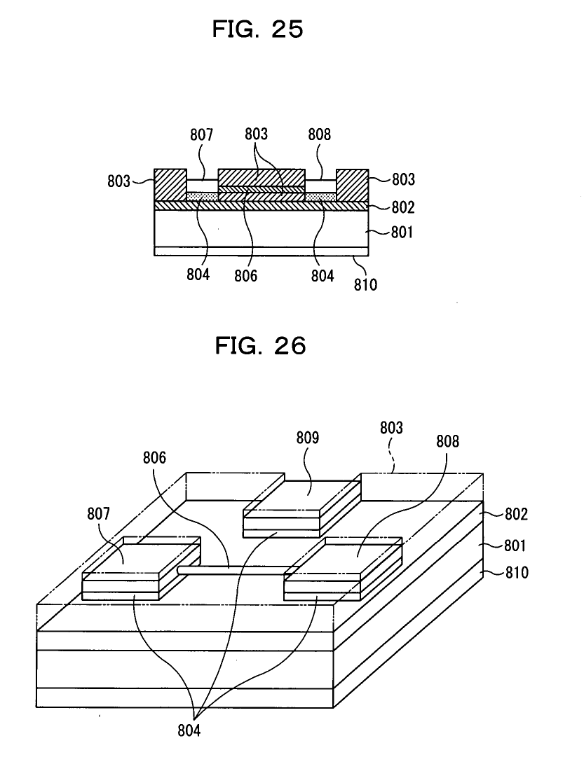

Next, the element protective layer formed on the Si substrate <801> was washed by the boiling acetone, acetone, ethanol, and running water in this order each for 3 min. Next, like the photolithography for patterning the source electrode <807>, drain electrode <808>, and side gate electrode <809>, the photo resist <803> was patterned on portions of the element surface excluding the source electrode <807>, drain electrode <808>, and side gate electrode <809> to produce the channel protective layer <803> in order to protect the carbon nano tube <806>. FIG. 25 shows a schematic sectional view of a carbon nano tube field-effective transistor (hereinafter called “CNT-FET” as appropriate) completed by following the above process, and FIG. 26 shows a schematic view thereof. In FIG. 26, the channel protective layer <803> is denoted by double-dashed chain lines.

[2. Characteristic Measurement Using a Sensor]

### Characteristic Measurement Example 1

Using the CNT-FET produced in [1. Sensor production], characteristic measurements were made before and after immobilizing an antibody by a technique shown below.

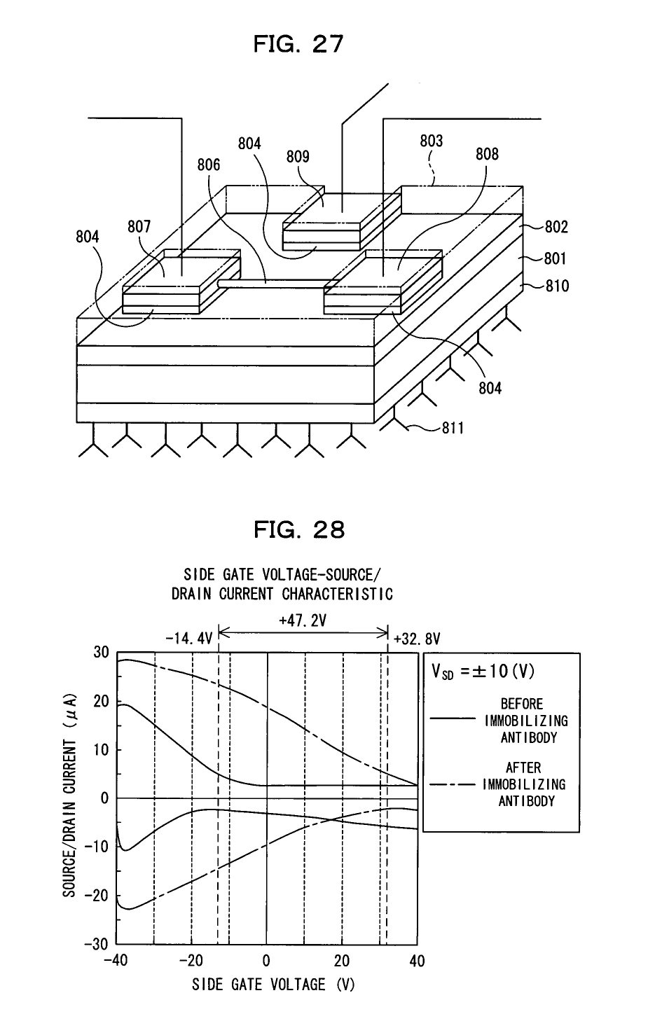

50 μL of a mouse IgG antibody (specific substance) of concentration 100 [μg/mL] diluted by an acetic acid buffer solution was instilled onto the back gate <810>, and made to react in a wet box at humidity 90% for about 15 min., and the surface of the back gate <810> was washed by deionized water to immobilize the antibody. As a result of immobilizing the antibody, as shown in FIG. 27, the IgG antibody <811> was immobilized as a specific substance on the back gate <810>. FIG. 27 is a figure schematically showing an outline of the CNT-FET in the present example when the IgG antibody <811>, which is a specific substance, is immobilized, and the channel protective layer <803> is denoted by double-dashed chain lines. The IgG antibody <811> is actually very minuscule and visually invisible, but is shown here for a description.

Electric characteristic of the CNT-FET were evaluated by using a 4156C semiconductor parameter analyzer manufactured by Agilent Co. Transfer characteristic (V_{SG}−I_{SD} characteristic), which are a type of electric characteristic, were measured before and after immobilizing the antibody to compare measured values before and after immobilizing the antibody. FIG. 28 shows measurement results thereof. At this point, a sweep was performed at the side gate voltage V_{SG}=−40 to 40 V (0.8 V step) and a current (source drain current) I_{SD} (μA) that flowed between the source electrode and drain electrode when the source voltage V_{S}=0 V and the drain voltage V_{D}=−1 to 1 V (0.02 V step) were swept at each point thereof. In FIG. 28, the graph in an area where the source drain current is negative shows measurement results when V_{SD}=−1.0 V and that in an area where the source drain current is positive shows measurement results when V_{SD}=+1.0 V

Focusing on a portion where the source drain current is 5 μA in FIG. 28, the side gate voltage after immobilizing the antibody changed dramatically by +47 V compared with that before immobilizing the antibody. This measurement result showed that transfer characteristic of the CNT-FET change dramatically before and after immobilizing the antibody and interactions due to immobilization of antibody occurring near the back gate surface can be directly measured. This shows that the sensor according to the present invention has detection capabilities of chemical substance with extremely high sensitivity and it is anticipated that the sensor can be used for detection of interactions between detection targets and specific substances.

### Characteristic Measurement Example 2

Using CNT-FET produced like [1. Sensor production], an antigen-antibody reaction was sensed. For this purpose, source-drain current voltage characteristic and transfer characteristic were adopted as transistor characteristic and the antigen-antibody reaction was sensed by comparing the transistor characteristic before and after the antigen-antibody reaction.

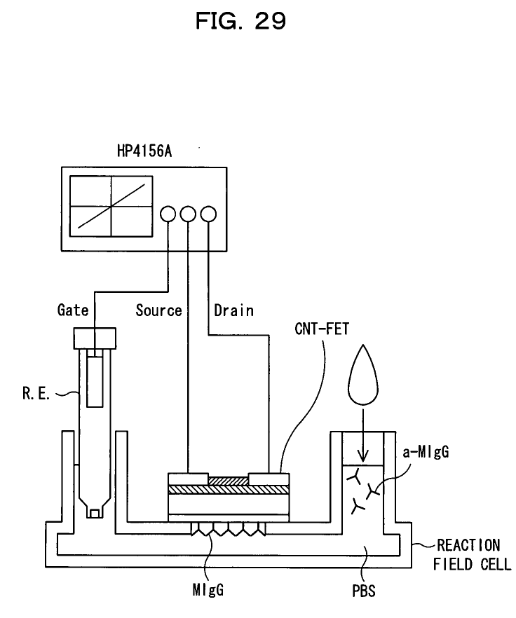

FIG. 29 is a schematic view showing the configuration of main components of a measuring system (analytical apparatus) used for a characteristic measurement example 2. “a-MIgG” and “MIgG” shown in FIG. 29 are actually very minuscule and visually invisible, but are shown here for a description. As shown in FIG. 29, a mouse IgG antibody (MIgG) was immobilized on the back gate (sensing gate for detection) of the produced CNT-FET as a specific substance. Next, the back gate of the CNT-FET was soaked in a reaction field cell in which 400 μL of a phosphate buffer solution (PBS) of pH 7.4 is filled to measure the source-drain current voltage characteristic and transfer characteristic.

Subsequently, the reference electrode (voltage application gate: RE) consisting of Ag/AgCl/saturated KCl is used to control the voltage of the back gate.

Next, 400 μL of an anti-mouse IgG antibody (a-MIgG) of concentration 500 μg/mL was instilled into the reaction field cell. After 50 min. of instillation, the source-drain current voltage characteristic and transfer characteristic were again measured.

Conditions during measurement were temperature 25° C. and humidity 30%, and the semiconductor parameter analyzer (HP4156; Agilent Co.) was used for application of the gate voltage and measurements of source-drain current voltage characteristic and transfer characteristic.

FIG. 30 shows changes of the source-drain current voltage characteristic before and after instillation of the anti-mouse IgG antibody. The voltage (V_{D}) applied to the back gate was 0 V. In FIG. 30, I_{SD} (μA) shows current flowing between the source electrode and drain electrode of the CNT-FET, and V_{SD} (V) shows the magnitude of voltage difference between the source electrode and drain electrode of the CNT-FET. As is evident from a portion encircled by an ellipse in FIG. 30, an absolute value of current after instillation increases as shown by an arrow.

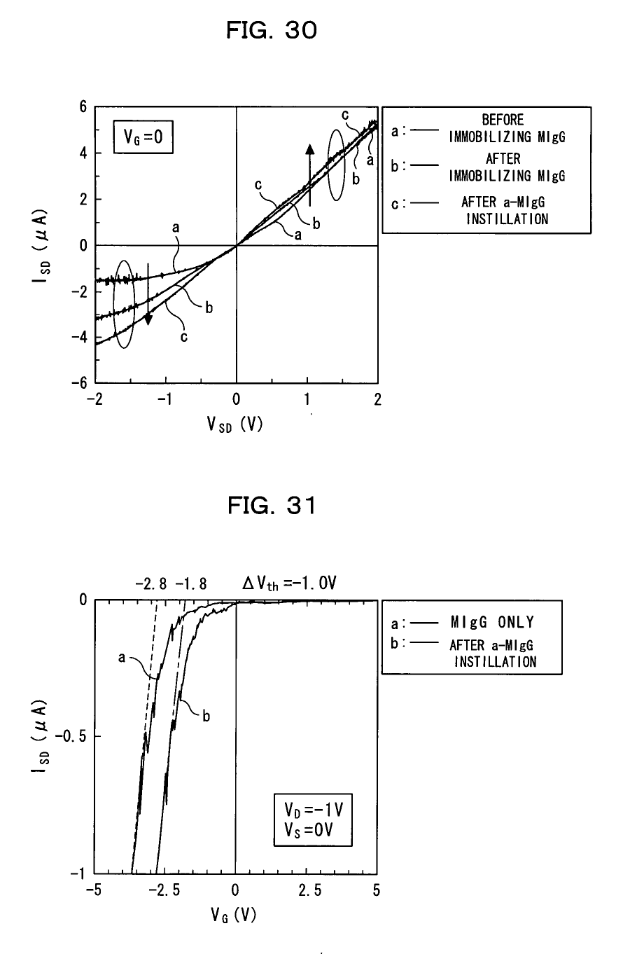

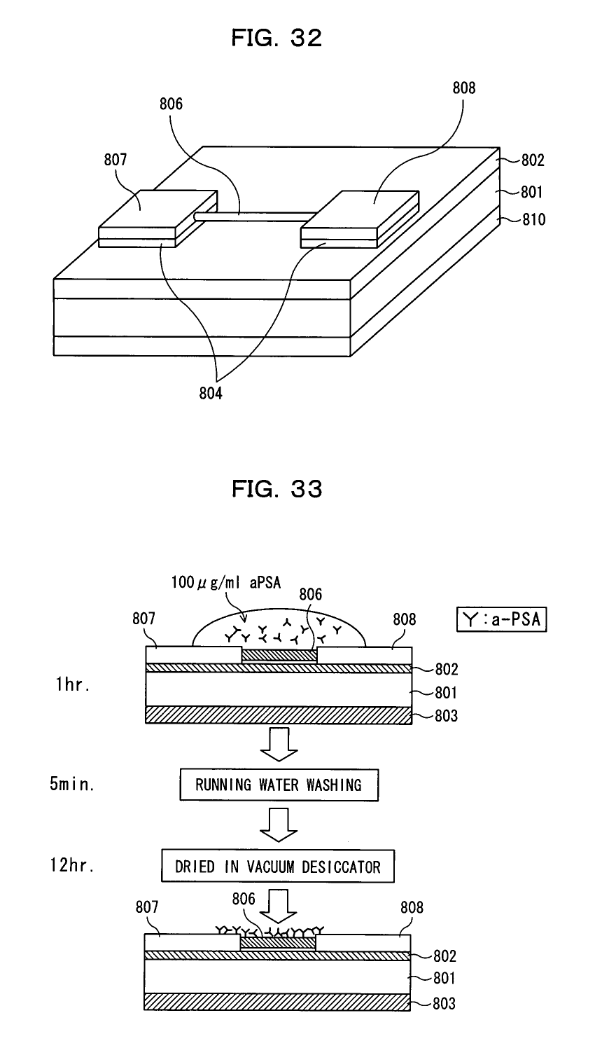

FIG. 31 shows changes of the transger characteristic before and after instillation. Measurements were made by setting the voltage (V_{D}) of the drain electrode to −1 V and the voltage (V_{S}) of the source electrode to 0 V. In FIG. 31, I_{SD} (μA) shows the magnitude of current flowing between the source electrode and drain electrode of the CNT-FET and V_{G} (V) shows the magnitude of voltage applied to the back gate from the electrode (RE). It is evident from FIG. 31 that a threshold voltage (a value of V_{G} where I_{SD} abruptly changes, which indicates a voltage at which channel switching occurs. Here, V_{G} when I_{SD}=0.5 μA) noticeably changes to the positive side by +1 V after instillation of the anti-mouse IgG. This is presumably because the anti-mouse IgG having negative charges in a solution within the reaction field cell has specifically been bound to the mouse IgG immobilized on the back gate (sensing gate for detection). This shows that the sensor unit using the CNT-FET in the present example has detection capabilities of chemical substance with extremely high sensitivity and it is anticipated that the sensor unit can be used for detection of interactions between other detection targets and specific substances.

### SECOND EXAMPLE

### 1. Sensor Production

CNT-FET was produced in the same manner as the first example except that the time for thermal oxidization performed in the process of “(Preparation of the substrate)” was 5 hours, the thickness of the insulation layer of SiO₂ formed as a result was about 300 nm, Cr was used instead of Ti in the process of “(Formation of the source electrode, drain electrode, and side gate electrode)”, the Au evaporation rate was 2 Å/sec., Ti was used instead of Pt in the process of “(Production of the back gate electrode)”, and neither channel protective layer <803> nor side gate electrode <809> was formed. FIG. 32 shows a schematic view of the produced CNT-FET. The same numerals in FIG. 32 denote the same components as those in FIG. 27.

Using the CNT-FET produced in [1. Sensor production], characteristic measurements were made before and after immobilizing an antibody by a technique shown below.

An anti-PSA (hereinafter called “a-PSA” as appropriate) was used as an antibody (specific substance). Further, a-PSA was immobilized by a method described below. FIG. 33 is a schematic view showing an immobilization method of the a-PSA. As shown in FIG. 33, about 60 μL of an a-PSA solution of concentration 100 μg/mL was put on a channel part including the source electrode <807>, drain electrode <808>, and carbon nano tube <806> to hold the solution there for 1 hour in a humid atmosphere. Thereafter, the channel part was washed by ultrapure water for 5 minor longer. Next, moisture content was removed from the channel part by nitrogen blowing before being dried in a vacuum desiccator overnight. As a result, the a-PSA was immobilized on a portion where the a-PSA had been put and thereby, the whole surface of the carbon nano tube <806> became a sensing part where the specific substance a-PSA is immobilized. “a-PSA” shown in FIG. 33 is actually very minuscule and visually invisible, but is shown here for a description.

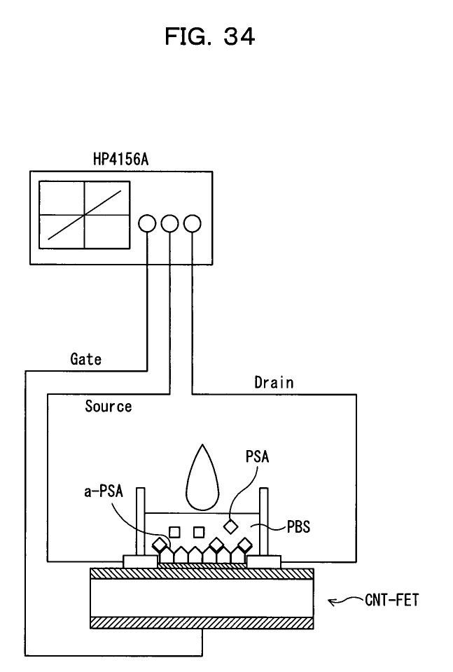

Electric characteristic of the CNT-FET were evaluated by using the 4156C semiconductor parameter analyzer manufactured by Agilent Co. A measuring system (analytical apparatus) shown in FIG. 34 was constructed and measurement operations were performed as shown below. As shown in FIG. 34, a silicone well was produced in the channel part of the CNT-FET where the antibody was immobilized to soak the channel part in a phosphate buffer solution (hereinafter called “PBS” as appropriate) of 0.01 M. For measurement of the electric characteristic, the source electrode was set to 0 V, and 0.1 V was applied to the drain electrode and 0 V was applied to the back gate electrode continuously to measure the source-drain current I_{SD} as a function of time. Further, porcine serum albumin (hereinafter called PSA) was used as an antigen, which is a detection target, and a PSA solution of predetermined concentration was suitably instilled into the well to detect the detection target by measuring the source-drain current I_{SD} after installation. “a-PSA” and “PSA” shown in FIG. 34 are actually very minuscule and visually invisible, but are shown here for a description.

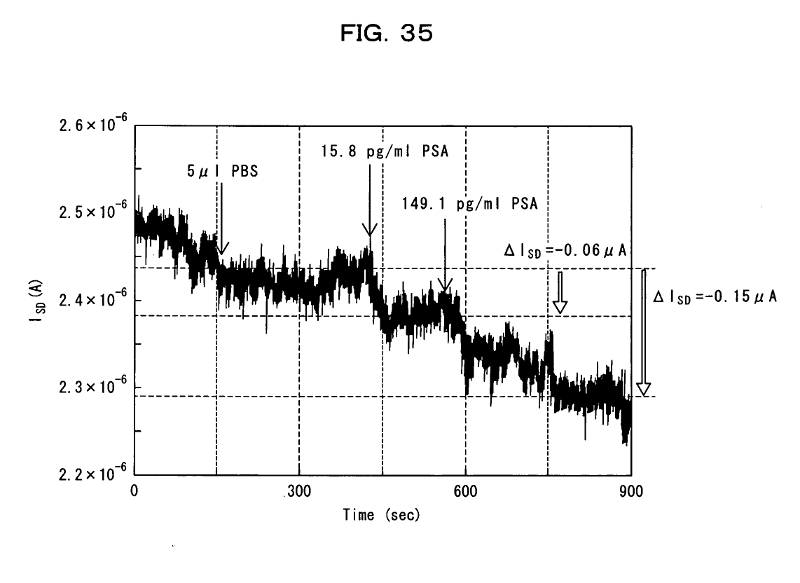

FIG. 35 shows changes over time of I_{SD} when the PSA antigen was instilled.

5 μL of 0.01 M PBS solution was instilled 160 sec. after starting the measurement, but no noticeable change in I_{SD} was observed.

When the PSA solution was instilled 425 sec. after starting the measurement so that the PSA concentration in the well became 15.8 pg/mL, I_{SD} decreased by about 0.06 μA.

Further, when the PSA solution was instilled 570 sec. after starting the measurement so that the PSA concentration in the well became 149.1 pg/mL, I_{SD} decreased by about 0.15 μA compared with immediately after instillation of the PBS solution.

The decrease of I_{SD} observed here after instillation of the PSA solution presumably occurred because characteristic of the CNT-FET changed after the CNT channel <806> sensed an interaction between PSA, which is a detection target, and a-PSA, which is a specific substance. This verifies that, by using an analytical apparatus in the present example, PSA of extremely low concentration of 15.8 pg/mL can be detected with high sensitivity.

### Third example

### Formation of a Flow Channel

An example of the method of forming a reaction field cell is shown below and a concrete method of forming a flow channel is described, but the method of forming a flow channel is not limited to the method shown below and any method can be adopted.

After spin-coating a 4-inch silicon wafer (manufactured by Furuuchi Chemical Co.) with a photo resist NanoXP SU-8 (50) (manufactured by MicroChem Corporation), a heating solvent was removed for 30 min. and the wafer was cooled to room temperature, and then the wafer was exposed to ultraviolet light via a photo film mask (manufactured by Falcom Co.). A flow channel pattern of a reaction field cell is formed on the photo film mask used so that the pattern is transferred to the silicon wafer. The pattern is formed so that the flow channel is separated into internal flow channels on a slit of width of 0.5 mm.

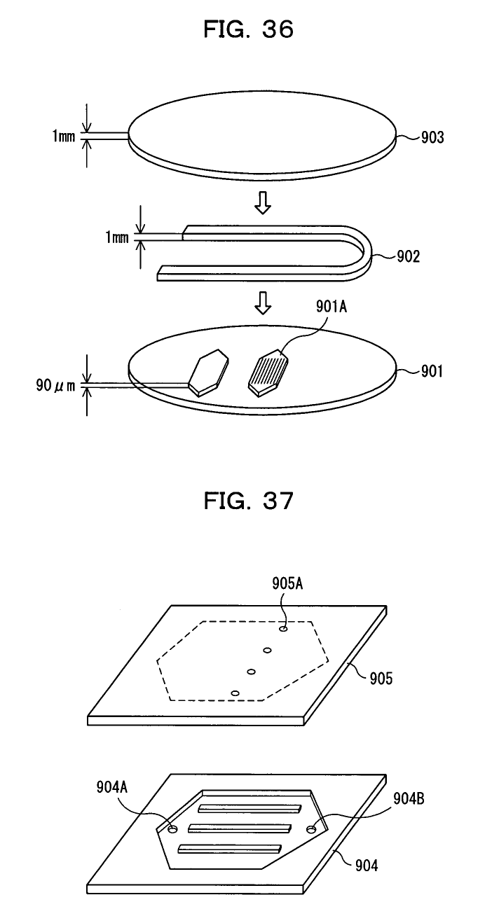

The wafer was after-baked for 30 min. after exposure and then developed by a developer (Nano XP SU-8 Developer, manufactured by MicroChem Corporation) for 15 min. before being washed by isopropyl alcohol and water. A flow channel pattern (See a pattern <901A> in FIG. 36) was thereby formed on the silicon wafer as a photo resist layer of thickness 90 μm.

Further, after stirring a silicone elastomer PDMS (polydimethylsiloxane) Sylgard 184 kit manufactured by Dow Corning Toray and a hardener in a ratio of 10:1, vacuum degassing was performed at −630 Torr for 15 min.

FIG. 36 is a schematic perspective view for illustrating processes of the formation method of a flow channel. As shown in FIG. 36, a U-shaped mold <902> manufactured by PMMA with thickness 1 mm and a resin flat plate <903> with thickness 1 mm were put on the silicon wafer <901> having the flow channel pattern on its surface to form a packing portion of elastomer and, after packing the elastomer from an opening part of the packing portion, the packing portion was hardened at 80° C. for 3 hours. After hardening, the elastomer was peeled off from the silicon wafer <901> and the U-shaped mold <902>. An elastomer substrate on which crevices (These crevices become a flow channel later) formed by fitting to the pattern shape are formed is thereby obtained.

Subsequently, a portion corresponding to crevices where the pattern was formed was cut off as sheet flow channel part. A reaction field cell in which a flow channel (crevices) was formed on an elastomer substrate was thereby obtained (See a reaction field cell <904> in FIG. 37).

FIG. 37 is a schematic exploded perspective view of the reaction field cell unit. As shown in FIG. 37, by combining the cut reaction field cell <904> and a substrate <905> having a sensing part <905A>, a reaction field cell unit on which the pattern having a slit structure was formed was completed. Since depth of the pattern <901A> of the flow channel was 90 μm, the flow channel of the obtained reaction field cell unit was also formed with depth 90 μm.

Next, a liquid sending system will be described. As shown in FIG. 37, the formed reaction field cell unit has a flow channel so that a hole (inlet) <904A> is formed at an edge upstream of the flow channel and another hole (outlet) <904B> at an edge downstream of the covering device. Then, a liquid sending pump (for example, a syringe pump) was connected to the inlet <904A> via a connector and a tube and a waste liquid tank was connected to the outlet <904B> via a connector and a tube.

If a fluid sample was caused to be injected into the flow channel from the inlet by operating the liquid sending pump in such a liquid sending system, the sample could be discharged from the outlet.

### Fourth Example

### 1. Sensor Production

(Preparation of a Substrate)

After performing ultrasonic cleaning by soaking a sapphire substrate of R surface in acetone and ethanol in this order each for 3 min., the sapphire substrate was rinsed with running pure water for 3 min. and dried by nitrogen blowing. Subsequently, the sapphire substrate was baked in an oven at 110° C. for 15 min. to remove moisture content.

(Formation of a Channel)

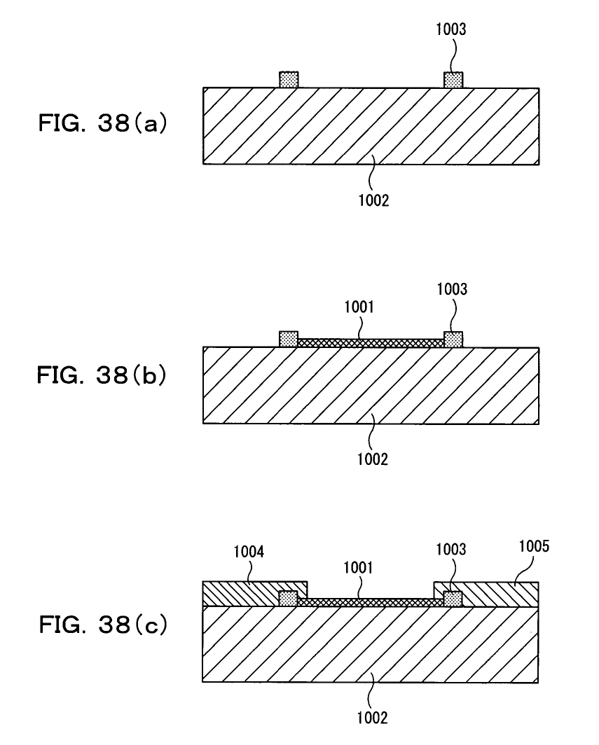

Subsequently, a growth catalyst of CNT was produced on the surface of the sapphire substrate by a method shown below. FIG. 38 (a) to FIG. 38 (c) are each a schematic sectional view illustrating a formation method of a channel in the present example.

First, a photo resist was patterned by photolithography where a CNT <1001> (See FIG. 38 (b)) should be bridged. The photolithography was carried out as described below.

First a sapphire substrate <1002> (See FIG. 38 (a)) was spin-coated with hexamethyldisilazane at 500 rpm for 10 sec. and at 4000 rpm for 30 sec. and thereupon, the photo resist (microposit S1818 manufactured by Shipley Far East Co.) was spin-coated under the same conditions.

After spin-coating, the sapphire substrate <1002> was put on a hot plate to bake the substrate at 90° C. for 1 min. After baking, the sapphire substrate <1002> coated with the photo resist was soaked in monochlorobenzene for 5 min., and after drying by nitrogen blowing, the sapphire substrate <1002> was put into an oven to bake at 85° C. for 5 min. After baking, a catalyst pattern was exposed to light using an aligner to develop in a developer (AZ300MIF developer (2.38% by volume) manufactured by Clariant Co.) for 3 min. before being rinsed with running water for 3 min. and dried by nitrogen blowing.

Layers of silicon, molybdenum, and iron with thickness 10 nm, 10 nm, and 30 nm respectively were formed in this order on the sapphire substrate <1002> having a patterned photo resist using the electronic beam (EB) vacuum evaporation method to produce a catalyst.

Next, the sapphire substrate <1002> was soaked in boiling acetone and lifted off.

Next, after performing ultrasonic cleaning by soaking the sapphire substrate <1002> after lift-off in acetone and ethanol in this order each for 3 min., the substrate was rinsed with running pure water for 3 min. and dried by nitrogen blowing to pattern a catalyst <1003> (See FIG. 38 (a)).

The sapphire substrate <1002> having the patterned catalyst <1003> was placed into a furnace to grow the CNT <1001> between the catalyst <1003> by the chemical vapor deposition (CVD) method at 900° C. for 10 min. while flowing ethanol bubbled using Ar at 750 mL/min. and hydrogen at 500 mL/min. (See FIG. 38 (b)). Meanwhile, temperature was raised and lowered under flowing Ar at 1000 mL/min.

(Production of a Source Electrode and a Drain Electrode)

Next, the photo resist was patterned by the photolithography to produce a source electrode <1004> and a drain electrode <1005> at both ends of the CNT <1001>.

After patterning, layers of titan and platinum in this order with thickness 10 nm and 90 nm respectively were formed by the EB vacuum evaporation method. The photo resist was lifted off while soaking the sample in boiling acetone and, next, the sample after lift-off was soaked in acetone and ethanol in this order to perform ultrasonic cleaning each for 3 min. and rinsed with running pure water for 3 min. before being dried by nitrogen blowing to produce the source electrode <1004> and the drain electrode <1005> (See FIG. 38 (c)). The shortest distance between the source electrode <1004> and drain electrode <1005> was 4 μm. Though not shown in FIG. 38 (c), the source electrode <1004> and the drain electrode <1005> are each derived from the channel <1001> of the CNT and each has a pad for contact. The pad for contact is a square electrode (pad) of side length 150 μm to come into contact with a probe at the tip of electrode wiring.

(Formation of an Insulation Layer of Silicon Nitride)

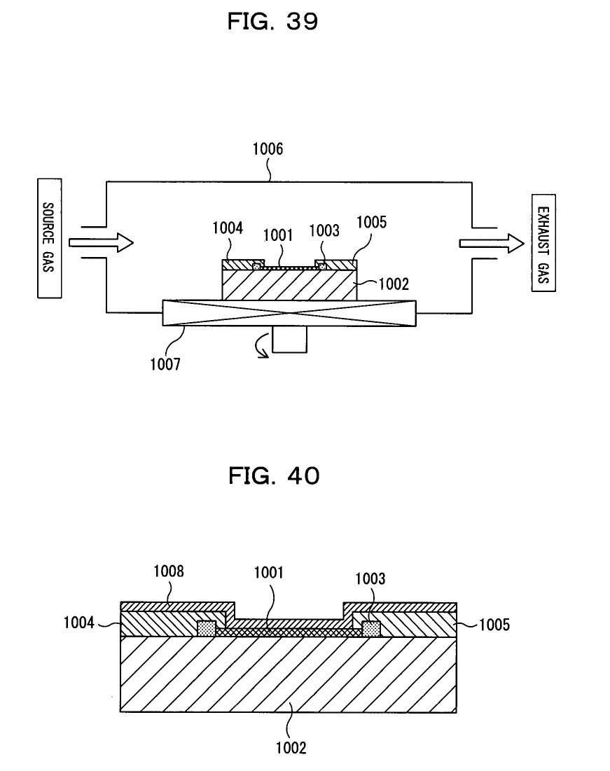

FIG. 39 schematically shows the configuration of main components of an apparatus used for forming a silicon nitride insulation layer. As shown in FIG. 39, a layer of silicon nitride, which is a nitrogenous substance, was formed by placing the sapphire substrate <1002> into a quartz furnace <1006> and using the thermal CVD method. The sapphire substrate <1002> was placed on a rotating type stage <1007> equipped with a resistance heater. The layer was formed on the rotating stage <1007> at 800° C. under atmospheric pressure for 5 min. while flowing a 0.3% by volume mono silane gas diluted by Ar at 50 mL/min, an ammonia gas at 1000 mL/min., and a nitrogen gas at 2000 mL/min. Temperature was raised and lowered under flowing a nitrogen gas at 2000 mL/min. The thickness of an obtained silicon nitride insulation layer <1008> was 40 nm. FIG. 40 is a schematic sectional view of the sapphire substrate <1002> on which the silicon nitride insulation layer <1008> is formed.

(Production of a Top Gate Electrode)

Next, a top gate <1009> was produced on the surface of the silicon nitride insulation layer <1008> immediately above the channel <1001> of the sapphire substrate <1002> by the following method.

The photo resist applied to the surface of the silicon nitride insulation layer <1008> was patterned in the same manner as the photolithography described above. Next, layers of titan and gold with thickness 10 nm and 100 nm respectively were formed by the EB vacuum evaporation method. The resist was lifted off while soaking the sapphire substrate <1002> in boiling acetone and, next, the sapphire substrate <1002> after lift-off was soaked in acetone and ethanol in this order to perform ultrasonic cleaning each for 3 min. and rinsed with running pure water for 3 min. before being dried by nitrogen blowing to produce the top gate electrode <1009>. Like the source electrode <1004> and drain electrode <1005>, the top gate <1009> is derived from the channel <1001> and has a pad for contact. However, since the silicon nitride insulation layer <1008> exists between the top gate electrode <1009> and channel <1001>, the channel <1001> and top gate electrode <1009> are insulated from each other.

(Production of a Hole for Contact)

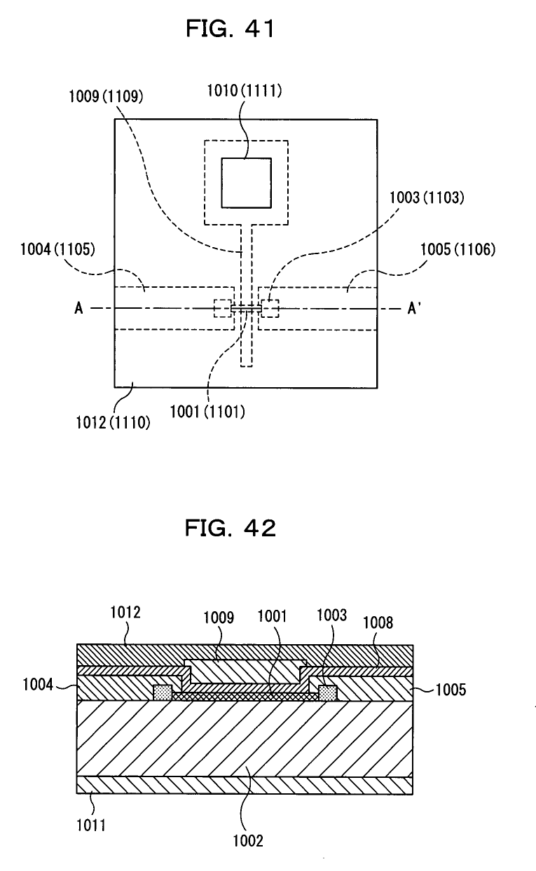

Next, to produce a square hole <1010> (See FIG. 41) for contact (for wiring connection) of side length 100 μm in the silicon nitride insulation layer <1008> on the contact pads of the derived source electrode <1004> and drain electrode <1005>, the photolithography described above was used to pattern the hole <1010> for contact by a resist on the surface of the silicon nitride insulation layer <1008>. More specifically, the surface of the silicon nitride insulation layer <1008> was spin-coated with a photo resist and, next, a resist of a portion where the hole <1010> would be produced was removed by patterning. Then, the photo resist was baked in an oven at 110° C. for 30 min. A reactive ion etching (RIE) equipment was used for dry etching to remove the silicon nitride insulation layer <1008> of the portion where the resist had been removed. The etchant used at this point was a SF₆ gas and etching was performed for 5 min. in a plasma of RF output 100 W with a chamber internal pressure 4.5 Pa.

(Production of a Back Gate Electrode)

After producing the contact hole <1010>, layers of titan and gold with thickness 10 nm and 100 nm respectively were formed on the underside of the sapphire substrate <1002> by the EB vacuum evaporation method to produce a back gate electrode <1011>.

Subsequently, the sapphire substrate <1002> was soaked in boiling acetone for 5 min., further in acetone and ethanol in this order to perform ultrasonic cleaning each for 3 min. and rinsed with running pure water for 3 min. before being dried by nitrogen blowing to remove a photo resist layer having a pattern of the hole <1010> for contact.

(Production of a Resist Protective Layer)

For the purpose of protecting the element surface of portions of the top gate electrode <1009>, source electrode <1004>, and drain electrode <1005> excluding the contact pads, a resist <1012> was patterned using the photolithography in the same manner as before. Holes (other holes than the hole <1010> are not shown) were formed in this manner each on the contact pad of the top gate electrode <1009>, on the contact pad of the source gate <1004>, and on the contact pad of the drain gate <1005> to protect the surface of other elements with a resist. Next, the photo resist was baked in an oven at 120° C. for 1 hour to harden the photo resist.

FIG. 41 shows a schematic top view of a top-gate type CNT-FET sensor having the silicon nitride gate insulation layer <1008> produced according to the process described above. FIG. 42 shows a schematic sectional view obtained after cutting the top-gate type CNT-FET sensor by an A-A′ surface in FIG. 41. FIG. 41 shows the CNT-FET sensor on a scale different from that of FIG. 38 (a) to FIG. 40 and FIG. 42 for a description.

### 2. Characteristic Measurement

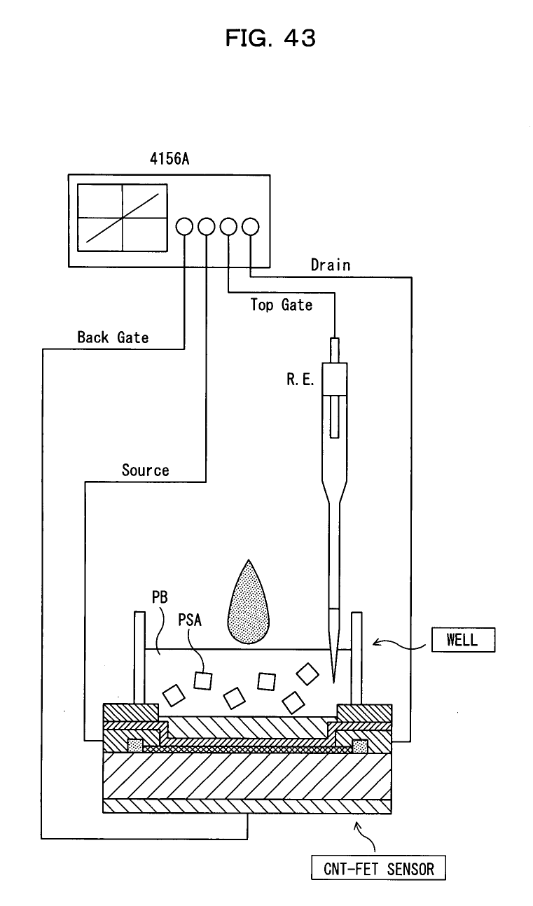

FIG. 43 shows a schematic diagram showing the configuration of main components of a measuring system (analytical apparatus) used for characteristic measurement of the present example. PSA shown in FIG. 43 is actually very minuscule and visually invisible, but is shown here for a description. The CNT-FET sensor is shown in FIG. 43 on a scale different from that of FIG. 38 to FIG. 42 for a description.

As shown in FIG. 43, a silicone well was produced on the above-described top-gate type CNT-FET sensor protected with a resist and the surface of the top gate electrode was soaked in a phosphate buffer solution (PB) of 10 mM of pH 7.4 through the contact hole of the top gate electrode to make measurements. As electric characteristic, the current (I_{DS}) flowing between the source electrode and drain electrode was measured as a time function by setting a potential difference (V_{DS}) between the source electrode and drain electrode to 0.1 V and the voltage (V_{BGS}) of the back gate to 0 V, and applying a fixed voltage of 0 V as the top gate voltage (V_{TGS}) to the top gate electrode via PB by using silver/silver chloride reference electrodes (R. E.). The 4156A semiconductor parameter analyzer manufactured by Agilent Co. was used for application and measurement of each voltage.

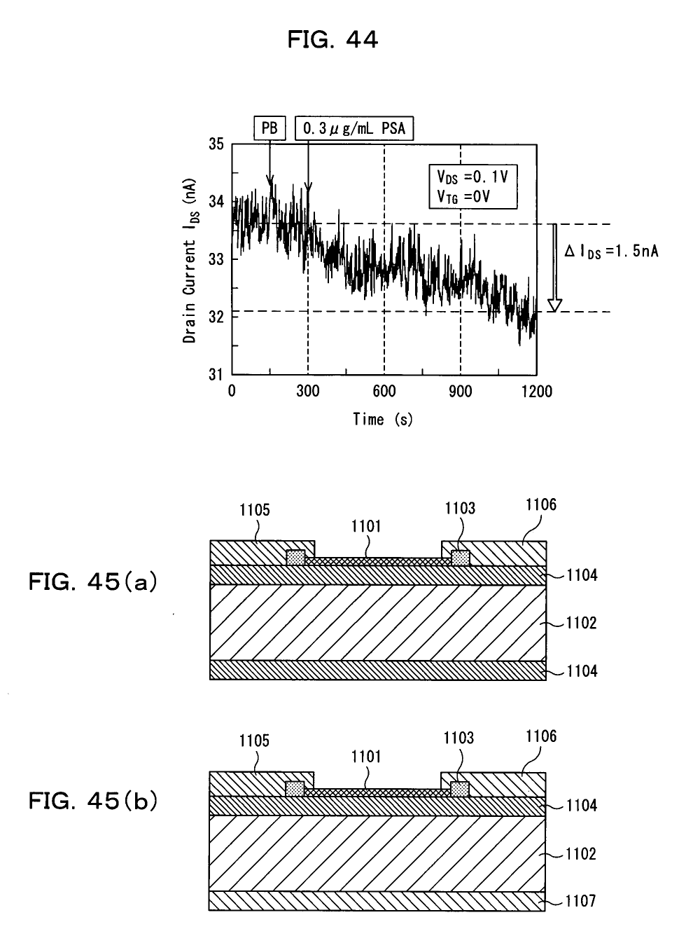

Pig serum albumin (PSA), which is a kind of protein, was used and a PB solution of PSA was suitably instilled into the well. FIG. 44 shows changes over time of I_{DS} when PSA is instilled.

10 μL of PB of the same concentration was instilled at time 180 s, but there was no noticeable change in I_{DS}.

When PSA was instilled at time 300 s so that the PSA concentration in the well would become 0.3 μg/mL, I_{DS} decreased by about 1.5 nA at time 1200 s.

Since I_{DS} did not change even if PB was instilled and decreased after PSA was instilled, the decrease of I_{DS} was presumably caused by adsorption of PSA, which has negative charges at pH 7.4, on the top gate electrode. This result showed that the sensor produced in the present example has detection capabilities of chemical substance with high sensitivity.

### Fifth Example

### 1. Sensor Production

(Preparation of a Substance)

Silicon oxide was formed on the surface of an n-type silicon single crystal (100) substrate as an insulation layer by performing the same operation as that in “(Preparation of a substance)” of the first example.

(Formation of a Channel)

A channel of CNT was formed on the substrate by performing the same operations as those of “(Preparation of a substance)” of the first example except that thickness of silicon, molybdenum, and iron formed as a catalyst was set to 10 nm, 10 nm, and 30 nm respectively, a cleaning operation of the substrate after lift-off of the photo resist was performed by soaking the substrate in acetone and ethanol in this order to perform ultrasonic cleaning each for 3 min. and then the substrate was rinsed with running pure water for 3 min., and the growth time of CNT by the CVD method was set to 10 min.

(Production of a Source Electrode and a Drain Electrode)

Next, the photo resist was patterned by the photolithography to produce a source electrode and a drain electrode at both ends of the CNT.

After patterning, layers of chrome and gold in this order with thickness 20 nm and 200 nm respectively were formed by the EB vacuum evaporation method.

FIG. 45 (a) and FIG. 45 (b) are each a schematic sectional view for illustrating how an electrode is produced in the present example. In FIG. 45 (a) and FIG. 45 (b), numeral 1101 denotes a CNT channel, numeral 1102 denotes a substrate, numeral 1003 denotes a catalyst, and numeral 1104 denotes an insulation layer of silicon oxide.

The photoresist was lifted off while soaking the substrate <1102> in boiling acetone and, next, the substrate <1102> after lift-off was soaked in acetone and ethanol in this order to perform ultrasonic cleaning each for 3 min. and rinsed with running pure water for 3 min. before being dried by nitrogen blowing to produce a source electrode <1105> and a drain electrode <1106> (See FIG. 45 (a)). The shortest distance between the source electrode <1105> and drain electrode <1106> was 4 μm. Though not shown in FIG. 45 (a), the source electrode <1105> and the drain electrode <1106> are each derived from the channel <1101> of the CNT and each has a pad for contact. The pad for contact used in the present example was the same as that used in the fourth example.

After patterning of the source electrode <1105> and drain electrode <1106>, the surface of the substrate <1102> was spin-coated with hexamethyldisilazane at 500 rpm for 10 sec. and 4000 rpm for 30 sec. to protect the elements and thereupon, the photo resist was spin-coated under the same conditions. Then, the photo resist was baked in an oven at 110° C. for 30 min. to form a layer (provisional protective layer) for element protection.

(Production of a Back Gate Electrode)

A reactive ion etching (RIE) equipment was used for dry etching to remove the silicon nitride insulation layer <1104> on the underside of the substrate <1102>. The etchant used at this point was a SF₆ gas and etching was performed for 6 min. in a plasma of RF output 100 W with a chamber internal pressure 4.5 Pa.

After removing the silicon nitride insulation layer <1104> on the underside, layers of titan and gold with thickness 10 nm and 100 nm respectively were formed on the underside of the substrate <1102> by the EB vacuum evaporation method to produce a back gate electrode <1107>.

Next, after removing the provisional protective layer formed on the element surface by soaking the substrate <1102> in boiling acetone for 5 min., further in acetone and ethanol in this order to perform ultrasonic cleaning each for 3 min., the substrate <1102> was rinsed with running pure water for 3 min. and dried by nitrogen blowing (FIG. 45(b)).

(Formation of a Silicon Nitride Layer)

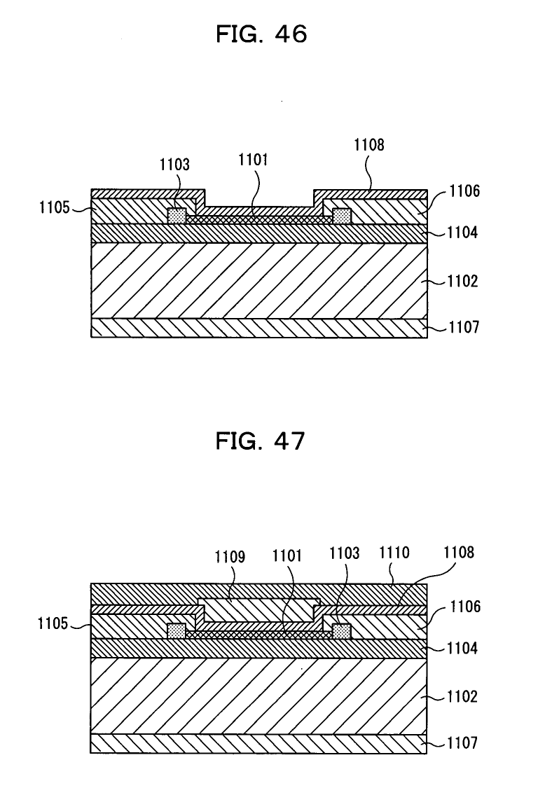

A silicon nitride layer <1108> was formed on the above-described substrate <1102> in the same manner as “(Formation of a silicon nitride layer)” in the fourth example except that the concentration of the mono silane gas used for layer formation was 3% by volume and the flow rate there of was 20 mL/min. The thickness of the formed silicon nitride was 270 nm. FIG. 46 shows a schematic sectional view of the substrate <1102> on which the silicon nitride insulation layer was formed.

(Production of a Hole for Contact)

Next, to produce a hole for contact (for wiring connection) in the silicon nitride insulation layer <1108> on the contact pads of the source electrode <1105> and drain electrode <1106> described above, the photolithography was used to pattern a square hole for contact (not shown) of side length 100 μm by a photo resist on the surface of the silicon nitride protective layer <1108>. More specifically, the surface of the silicon nitride protective layer <1108> was spin-coated with a photo resist and, next, a resist of a portion where the hole would be produced was removed by patterning. Then, the photo resist was baked in an oven at 110° C. for 30 min. Subsequently, etching was performed on the silicon nitride protective layer <1108> on the source electrode <1105> and the drain electrode <1106> to produce a hole for contact (not shown) in the same manner as “((4) Production of a back gate).”

(Production of a Top Gate Electrode)

Next, a top gate electrode <1109> was produced on the surface of the silicon nitride insulation layer <1108> immediately above the channel <1101> of the above-described substrate <1102> in the same manner as “Production of a top gate electrode” of the fourth example. Like the source electrode <1105> and drain electrode <1106>, the top gate electrode <1109> is derived from the channel <1101> and has a pad for contact. However, since the silicon nitride insulation layer <1008> exists between the top gate electrode <1009> and channel <1001>, the channel <1001> and top gate electrode <1009> are insulated from each other.

(Production of a Resist Protective Layer)

A resist protective layer <1110> was formed in portions excluding portions above the contact pads of the top gate electrode <1109>, source electrode <1105> and drain electrode <1106> in the same manner as “(Production of a resist protective layer)” of the fourth example.

FIG. 41 shows a schematic top view of a top-gate type CNT-FET sensor having the silicon nitride gate insulation layer <1108> produced according to the process described above. In FIG. 41, a hole provided on the top gate electrode <1109> is denoted by numeral 1111. Holes for contact formed on the pads for contact of the source electrode <1105> and drain electrode <1106> are not shown. Further, FIG. 47 shows a schematic sectional view after cutting the top-gate type CNT-FET sensor in the present example by the A-A′ surface in FIG. 41.

### 2. Characteristic Measurement

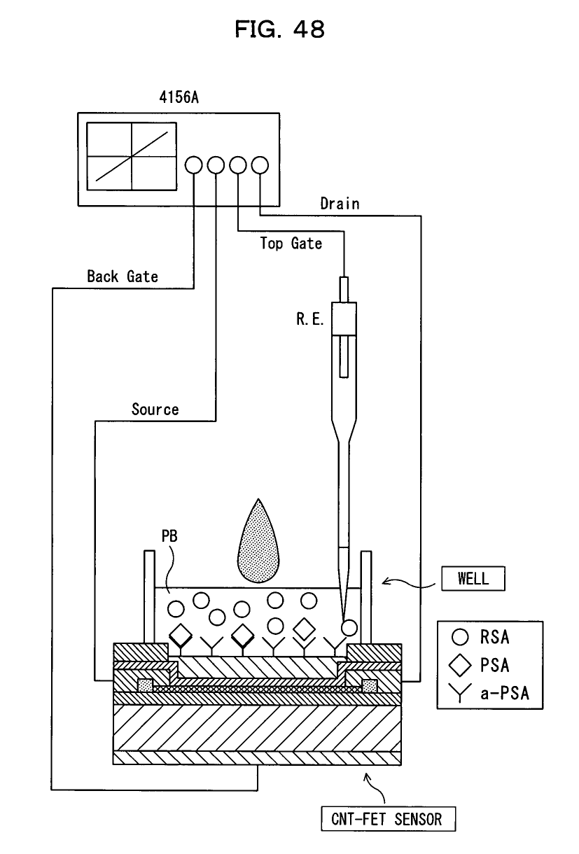

FIG. 48 shows a schematic diagram showing the configuration of main components of a measuring system (analytical apparatus) used for characteristic measurement of the present example. RSA, PSA, and a-PSA shown in FIG. 48 are actually very minuscule and visually invisible, but are shown here for a description. The CNT-FET sensor is shown in FIG. 48 on a scale different from that of FIG. 45 to FIG. 47 for a description.

As shown in FIG. 48, a silicone well was produced on the above-described CNT-FET sensor and the surface of the top gate electrode was soaked in a phosphate buffer solution (PB) of 10 mM of pH 7.4 through the contact hole of the top gate electrode to make measurements. As electric characteristic, the current (I_{DS}) flowing between the source electrode and drain electrode was measured as a time function by setting a potential difference (V_{DS}) between the source electrode and drain electrode to 0.5 V and the voltage (V_{BGS}) of the back gate to 0 V, and applying a fixed voltage of 0 V as the top gate voltage (V_{TGS}) to the top gate electrode via PB by using silver/silver chloride reference electrodes (R.E.). The 4156A semiconductor parameter analyzer manufactured by Agilent Co. was used for application and measurement of each voltage.

Pig serum albumin (PSA) acting as an antigen, anti-pig serum albumin (anti-PSA, a-PSA) acting as an antibody interacting with PSA, and rabbit serum albumin (RSA) not interacting with a-PSA were used as proteins. All proteins were provided as a solution using PB as a solvent.

After instilling an a-PSA solution of concentration 1 mg/mL onto the top gate electrode, the top gate electrode was cured in a wet box for 1 hour and then, washed by deionized water. “a-PSA” was thereby immobilized on the top gate electrode by physisorption.

Subsequently, a protein solution of PSA and that of RSA were suitably instilled into the well using a pipet.

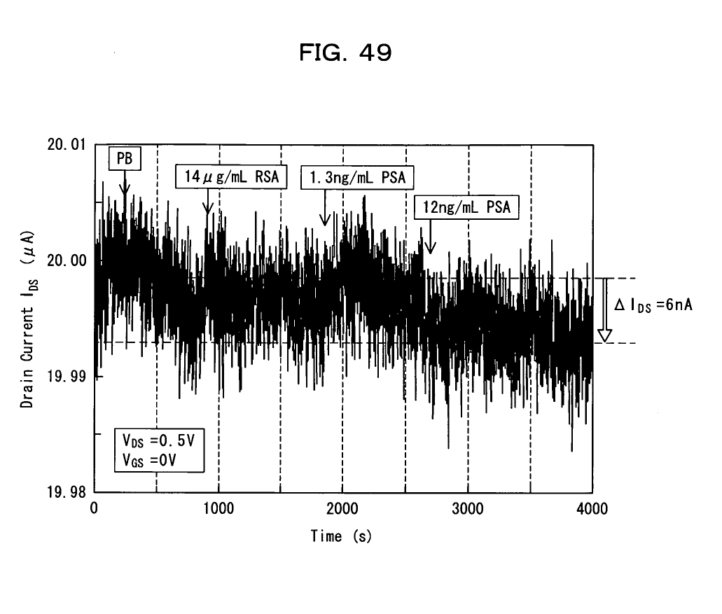

FIG. 49 shows changes over time of I_{DS}.

10 μL of PB of the same concentration was instilled at time 250 s, but there was no noticeable change in I_{DS}.

When a RSA solution was instilled at time 900 s so that the RSA concentration in the well would become 14 μg/mL, there was no noticeable change in I_{DS}.

When a PSA solution was instilled at time 1800 s so that the PSA concentration in the well would become 1.3 ng/mL, I_{DS} began to decrease.

When a PSA solution was instilled at time 2700 s so that the PSA concentration in the well would become 12 ng/mL, I_{DS} decreased by 6 nA between times 1800 s and 4000 s.

Since I_{DS} did not change noticeably even if PB and RSA were instilled and decreased after a PSA solution was instilled, the decrease of I_{DS} was presumably a result of interactions of PSA, which has negative charges at pH 7.4, with a-PSA. This result showed that the sensor produced in the present example has detection capabilities of chemical substance with high sensitivity.

[Examination of the Fourth and Fifth Examples]

As a result of intensive investigation by the present inventors, the fourth and fifth examples above have succeeded in causing adjacent metals and the like to function as a top gate electrode not only by being able to form an insulation layer that has been generally difficult to be formed by coating CNT, but also by enabling placement of metals or material having conductivity equivalent to that of metals extremely close to CNT.

This leads to advantages of being able to produce sensing parts with extreme stability while maintaining high detection sensitivity over an element structure in which a sample such as an antibody is brought into direct contact with CNT. Further, an element structure is possible in which a sensing part is produced independently of CNT and then the sensing part and CNT are electrically connected by a conductive material. Therefore, using the present technique, a novel element structure in which a sensing part is constructed independently of FET can advantageously be realized and also an element structure in which many sensing parts are integrated can easily be realized.

### INDUSTRIAL APPLICABILITY

The present invention can be used in a wide range of industrial fields in any way and, for example, can be used widely in fields such as medical service, resource development, biological analysis, chemical analysis, the environment, and food analysis.

The detailed description above sets forth numerous specific aspects to provide a thorough understanding of the present invention, but it is apparent to those skilled in the art that the present invention can be modified in various kinds of ways without departing from the scope of the present invention.

The present application is based on the Japanese patent application (Japanese Patent Application No. 2004-257698) filed on Sep. 3, 2004 and the entire contents of which are hereby incorporated by reference.

1-36. (canceled)

37: A sensor unit for detecting a detection target, comprising:
a transistor part including a substrate, a source electrode and a drain electrode provided on said substrate, a channel forming a current path between said source electrode and said drain electrode, and a sensing gate for detection,
wherein said sensing gate for detection, comprises:
a gate body fixed to said substrate; and
a sensing part on which a specific substance capable of selectively interacting with the detection target is immobilized, and said sensing part being mechanically removable from said gate body and, when mounted on said gate body, being in a conduction state of said gate body.

38: A sensor unit as defined in claim 37,
wherein the sensor unit including two or more of said sensing parts.

39: A sensor unit as defined in claim 38,
wherein one said gate body is configured to conduct to two or more of said sensing parts.

40: A sensor unit as defined in claim 39, further comprising:
an electric connection switching part for switching conduction between said gate body and said sensing parts.

41: A sensor unit as defined in claim 37,
wherein two or more of said transistor parts are integrated.

42: A sensor unit as defined in claim 37,
wherein said channel is formed with a nano tube structure.

43: A sensor unit as defined in claim 42,
wherein said nano tube structure is selected from a group consisting of a carbon nano tube, a boron nitride nano tube, and a titania nano tube.

44: A sensor unit as defined in claim 42,
wherein defects are introduced in said nano tube structure.

45: A sensor unit as defined in claim 42,
wherein an electric characteristic of said nano tube structure has a property like metals.

46: A sensor unit as defined in claim 37, further comprising:
a reaction field cell unit including a flow channel causing a sample to flow therethrough,
wherein said sensing part is provided in said flow channel.

47: A sensor unit as defined in claim 37,
wherein said transistor part comprises a voltage application gate applying a voltage or an electric field to said channel.

48: A sensor unit for detecting a detection target, comprising:
a transistor part including a substrate, a source electrode and a drain electrode provided on said substrate, a channel forming a current path between said source electrode and said drain electrode, and a sensing gate for detection,
wherein said sensing gate for detection comprises:
a gate body fixed to said substrate; and a sensing part which is mechanically removable from said gate body and, when mounted on said gate body, is in a conduction state to said gate body; and
the sensor unit comprises a reference electrode to which a voltage is applied so as to detect existence of the detection target by a change of the characteristic of said transistor part.

49: A sensor unit as defined in claim 48,
wherein the sensor unit includes two or more of said sensing parts.

50: A sensor unit as defined in claim 49,
wherein one said gate body is configured to conduct to two or more of said sensing parts.

51: A sensor unit as defined in claim 50, further comprising:
an electric connection switching part for switching conduction between said gate body and said sensing parts.

52: A sensor unit as defined in claim 48,
wherein two or more of said transistor parts are integrated.

53: A sensor unit as defined in claim 48,
wherein said channel is formed with a nano tube structure.

54: A sensor unit as defined in claim 53,
wherein said nano tube structure is selected from a group consisting of a carbon nano tube, a boron nitride nano tube, and a titania nano tube.

55: A sensor unit as defined in claim 53,
wherein detects are introduced in said nano tube structure.

56: A sensor unit as defined in claim 53,
wherein an electric characteristic of said nano tube structure has a property like metals.

57: A sensor unit as defined in claim 48, further comprising:
a reaction field cell unit including a flow channel causing a sample to flow therethrough,
wherein said sensing part is provided in said flow channel.

58: A sensor unit for detecting a detection target, comprising:
a transistor part including a substrate, a source electrode and a drain electrode provided on said substrate, and a channel formed of a nano tube structure forming a current path between said source electrode and said drain electrode,
wherein a sensing site on which a specific substance capable of selectively interacting with the detection target is immobilized is formed on said channel, and
two or more of said transistor parts are integrated.

59: A sensor unit comprising:
a transistor part including a substrate, a source electrode and a drain electrode provided on aid substrate, a channel forming a current path between said source electrode and said drain electrode, and a sensing gate; and
a cell unit mounting part for mounting a reaction field cell unit including a sensing part on which a specific substance capable of selectively interacting with a detection target is immobilized,
wherein, when said reaction field cell unit is mounted in said cell unit mounting part, said sensing part and said sensing gate are brought into conduction.

60: A sensor unit comprising:
a transistor part including a substrate, a source electrode and a drain electrode provided on said substrate, a channel forming a current path between aid source electrode and said drain electrode, and a sensing gate; and
a cell unit mounting part for mounting a reaction field cell unit including a sensing part and a reference electrode to which a voltage is applied so as to detect existence of a detection target by a change of characteristic of said transistor part,
wherein, when said reaction field cell unit is mounted in said cell unit mounting part, said sensing part and said sensing gate are brought into conduction.

61: A reaction field cell unit mounted in a cell unit mounting part of a sensor unit comprising:
a transistor part including a substrate, a source electrode and a drain electrode provided on said substrate, a channel forming a current path between said source electrode and said drain electrode, and a sensing gate, and said cell unit mounting part, the reaction field cell unit comprising:
a sensing part on which a specific substance capable of selectively interacting with a detection target is immobilized,
wherein, when mounted in said cell unit mounting part, said sensing part and said sensing gate are in a conduction state.

62: A reaction field cell unit mounted in a cell unit mounting part of a sensor unit comprising:
a transistor part including a substrate, a source electrode and a drain electrode provided on said substrate, a channel forming a current path between said source electrode and said drain electrode, and a sensing gate, and said cell unit mounting part, the reaction field cell unit comprising:
a sensing part and a reference electrode to which a voltage is applied so as to detect existence of a detection target by a change of characteristic of said transistor part,
wherein, when mounted in said cell unit mounting part, said sensing part and said sensing gate are in a conduction state.

63: An analytical apparatus, comprising:
a sensor unit as defined in claim 37.

64: An analytical apparatus as defined in claim 63,
wherein chemical reaction and immunological reaction can be analyzed by said sensor unit.

65: An analytical apparatus as defined in claim 63,
wherein measurements of at least one measurement group selected from groups consisting of an electrolytic concentration measurement group, a biochemical item measurement group, a blood gases concentration measurement group, a blood cell count measurement group, a blood coagulation ability measurement group, an immunological reaction measurement group, a nucleic acid-nucleic acid hybridization reaction measurement group, a nucleic acid-protein interaction measurement group, and a receptor-ligand interaction measurement group can be analyzed by said sensor unit.

66: An analytical apparatus as defined in claim 63,
wherein detection of two or more detection targets selected from a group consisting of at least one detection target selected from an electrolytic concentration measurement group, at least one detection target selected from a biochemical item measurement group, at least one detection target selected from a blood gases concentration measurement group, at least one detection target selected from a blood cell count measurement group, at least one detection target selected from a blood coagulation ability measurement group, at least one detection target selected from a nucleic acid-nucleic acid hybridization reaction measurement group, at least one detection target selected from a nucleic acid-protein interaction measurement group, at least one detection target selected from a receptor-ligand interaction measurement group, and at least one detection target selected from an immunological reaction measurement group can be analyzed by said sensor unit.

67: A analytical apparatus as defined in claim 63,
wherein measurements of at least one measurement group selected from groups consisting of an electrolytic concentration measurement group, a biochemical item measurement group, a blood gases concentration measurement group, a blood cell count measurement group, and a blood coagulation ability measurement group, and at least one measurement group selected from groups consisting of a nucleic acid-nucleic acid hybridization reaction measurement group, a nucleic acid-protein interaction measurement group, a receptor-ligand interaction measurement group, and an immunological reaction measurement group can be analyzed by said sensor unit.

68: An analytical apparatus as defined in claim 63,
wherein two or more detection targets selected for determining a specific disease or function can be detected.

69: An analytical apparatus, comprising:
a sensor unit as defined in claim 48.

70: An analytical apparatus, comprising:
a sensor unit as defined in claim 58.

71: An analytical apparatus, comprising:
a sensor unit as defined in claim 59.

72: An analytical apparatus, comprising:
a sensor unit as defined in claim 60.

73: An analytical apparatus, comprising:
a sensor unit, comprising:
a substrate;
a first transistor part including a first source electrode and a first drain electrode provided on said substrate, and a first channel formed of a carbon nano tube forming a current path between said first source electrode and said first drain electrode; and
a second transistor part including a second source electrode and a second drain electrode provided on said substrate, and a second channel forming a current path between said second source electrode and said second drain electrode;
wherein at least one detection target selected from at least one measurement group selected from groups consisting of a nucleic acid-nucleic acid hybridization reaction measurement group, a nucleic acid-protein interaction measurement group, a receptor-ligand interaction measurement group, and an immunological reaction measurement group is detected as the change of the characteristic of the first transistor part and
at least one detection target selected from at least one measurement group selected from groups consisting of an electrolytic concentration measurement group, a biochemical item measurement group, a blood gases concentration measurement group, a blood cell count measurement group, and a blood coagulation ability measurement group is detected as the change of the characteristic of the second transistor part.

74: An analytical apparatus as defined in claim 73,
wherein a sensing site on which a specific substance capable of selectively interacting with the detection target is immobilized is formed in said first channel.
